(19) United States
(12) Patent Application Publication
(10) Pub. No.: US 2007/0222718 A1
(43) Pub. Date: Sep. 27, 2007

(54) EL DISPLAY DEVICE AND DRIVING METHOD OF SAME

(75) Inventor: Hiroshi Takahara, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/676,822

(22) Filed: Feb. 20, 2007

(30) Foreign Application Priority Data
Feb. 20, 2006 (JP) 2006-042700

(51) Int. Cl. G09G 3/30

(52) U.S. Cl. 345/76

(57) ABSTRACT

A driving method of an electroluminescent (EL) display device for driving the EL display device having EL elements placed in a matrix state thereon, has when a pixel line selected to write a video signal matches with a pixel line selected to supply a current to the EL elements, deselecting at least one of the pixel line selected to write the video signal and the pixel line selected to supply a current to the EL elements.

### BACKGROUND OF THE INVENTION

1. Field of the Invention

The present invention relates to an EL display device using a self-luminous display panel (display device) such as an EL display panel (display device) using an organic or inorganic electroluminescent (EL) element and the like, and a driving method thereof.

2. Related Art of the Invention

An active-matrix image display device using an organic electroluminescent (EL) material or an inorganic EL material as an electro-optic conversion substance changes its emission luminance according to a current written to a pixel. An EL display device is a self-luminous device which has a light-emitting element on each individual pixel. In comparison with a liquid crystal display panel, the EL display device has advantages that visibility of an image is high, luminous efficiency is high, no backlight is necessary, response speed is fast, and the like.

According to the present invention, a period or a cycle for rewriting 1 screen is called 1 frame. It is also called an operation frame rate. However, there are the cases where the frame or the operation frame rate is used as a meaning of frames per predetermined period (1 second) or used as a meaning of a speed of 1 cycle, an image rewriting speed or a selected speed of a pixel line.

FIG. 1 is a block diagram of a pixel 16 of the EL display device. The pixels are formed like a matrix on a display screen 22 shown in FIG. 2 described later. The pixel 16 has 4 transistors (TFT) 11 formed therein.

A gate terminal of a driving transistor 11a is connected to a source terminal of a switch transistor 11b. Gate terminals of the switch transistor 11b and a switch transistor 11c are connected to a gate signal line 17a.

A drain terminal of the switch transistor 11b is connected to a drain terminal of the switch transistor 11c and a source terminal of a switch transistor 11d. A source terminal of the switch transistor 11c is connected to a source signal line 18.

A gate terminal of a switch transistor 11d is connected to a gate signal line 17b. A drain terminal of the switch transistor 11d is connected to an anode terminal of an EL element 15. A cathode terminal of the EL element 15 is connected to the cathode terminal (Vss). A source terminal of the driving transistor 11a is connected to the anode terminal (Vdd).

The switch transistors 11b, 11c are controlled to be on (closed) and off (open) by an on/off control signal applied to the gate signal line 17a. A gate terminal of the switch transistor 11d is connected to the gate signal line 17b. The switch transistor 11d is controlled to be on (closed) and off (open) by an on/off control signal applied to the gate signal line 17b.

As shown in FIG. 2, a gate driver circuit 12a is formed or placed at a left end of the display screen 22, and a gate driver circuit 12b is formed or placed at a right end thereof. The gate driver circuit 12a controls the gate signal line 17a, and the gate driver circuit 12b controls the gate signal line 17b. The gate driver circuits 12a, 12b are supplied with an on voltage (VGL) of the gate signal lines 17 and an off voltage (VGH) of the gate signal lines 17.

In a pixel configuration of the organic EL display device shown in FIGS. 1 and 2, the switch transistors 11b, 11c function as switches for selecting a pixel (line) for applying a video signal outputted by a source driver circuit 14. The switch transistor 11d functions as a switch for supplying a current to an EL element 15. To be more specific, the switch transistor 11d operates as a switch for selecting a pixel (line) to emit light. The gate driver circuits 12 have a clock signal (CLK), start signals (ST1, ST2) and an up down signal (UP) applied thereto.

The clock signal (CLK) is a signal for sequentially moving a pixel line to be selected. A start pulse signal (ST) is a signal for specifying the pixel line to be selected. The start pulse signal (ST) is moved in a shift register circuit of the gate driver circuits 12 by the clock signal (CLK). The up down signal is a flip vertical switching signal of the screen.

A state of selecting the pixel for applying a video signal is the state of FIG. 3A. The switch transistor 11d is in an open state, and the switch transistors 11b, 11c are in a closed state.

A state of emitting light from the EL element 15 is the state of FIG. 3B. The switch transistor 11d is in a closed state, and the switch transistors 11b, 11c are in an open state.

FIGS. 4A and 4B show the above operation when displayed on the display screen 22. Reference numeral 41 of FIG. 4A denotes a pixel line (write pixel line) selected to program a current or a voltage. The write pixel line 41 is non-lighted (nondisplay pixel line). To render it non-lighted, the gate driver circuit 12b should be controlled to put the switch transistor 11d of the pixel 16 in an open state. To render the switch transistor 11d open, an off-voltage (VGH) should be applied to the gate signal line 17b. A position at which the gate driver circuits 12 apply off-voltage (VGH) to the gate signal line 17b is shifted in synchronization with a horizontal synchronizing signal (HD). The HD is normally a clock signal (CLK).

A non-lighted (nondisplay) state means a state in which a current is not flowing through the EL element 15. Or else, it means a state in which a small current within a certain range is flowing. To be more specific, it is a dark display state. A nondisplay (non-lighted) range of the display screen 22 is called a nondisplay area 45. A display (lighted) range of the display screen 22 is called a display (lighted) area 46. The switch transistor 11d of the pixel 16 in the display area 46 is closed, and the current is flowing through the EL element 15. However, it is natural that no current flows through the EL element 15 in image display in black. An area in which the switch transistor 11d is open becomes the nondisplay area 45.

FIG. 5 shows a timing diagram. The pixel 16 of the selected pixel line has the off-voltage (VGH) applied to the gate signal line 17b when the on-voltage (VGL) is applied to the gate signal line 17a (refer to FIG. 3A). In this period, no current is flowing through the EL element 15 of the selected pixel line (non-lighted state).

As for a pixel line which has no on-voltage applied (is not selected) to the gate signal line 17a and is in a lighted state, the on-voltage (VGL) is applied to the gate signal line 17b. The current is flowing through the EL element 15 of this pixel line, and the EL element 15 is emitting light. In the third timing diagram from the top of FIG. 5 showing emission luminance, this emission luminance is referred to as luminance B (nt).

As for a pixel line which has no on-voltage applied (is not selected) to the gate signal line 17a and is in a non-lighted state, the off-voltage (VGH) is applied to the gate signal line 17b. No current is flowing through the EL element 15 of this pixel line, and the EL element 15 is in a non-light-emitting state.

A state in which the lighted area 46 of a pixel line N1 is generated is shown in FIGS. 4A, 4B, the first timing diagram of the gate signal line 17a from the top of FIG. 5, the second timing diagram of the gate signal line 17b from the top of FIG. 5 and the third timing diagram from the top of FIG. 5 showing the emission luminance. A rewriting cycle of the display screen 22 depends on an operation frame rate (frame frequency). Normally, the operation frame rate of NTSC is 60 Hz (60 images per second, and time for rewriting one screen is 1/60 seconds), and that of PAL is 50 Hz (50 images per second). As for MPEG, it is 30 frames (30 images per second, and time for rewriting one screen is 1/30 seconds) or 15 frames (15 images per second, and time for rewriting one screen is 1/15 seconds).

A start pulse (ST1) is applied to the gate driver circuit 12a in synchronization with the frame frequency. As for a start pulse (ST2), an input pattern of a frame rate frequency is generated and applied to the gate driver circuit 12b. As shown in FIGS. 6A, 6B, the gate driver circuit 12a and the gate driver circuit 12b have the same clock frequency (CLK). To make it easier to understand, the frame frequency is set at 60 Hz in FIGS. 6A, 6B.

As shown in FIGS. 6A, 6B, in a pixel 16a having a video signal written thereto, control is exerted so that the on-voltage (VGL) is not simultaneously applied to the gate signal lines 17a, 17b which are connected to the pixel 16. To be more specific, as shown in FIG. 6B, the off-voltage (VGH) is applied to the gate signal line 17b when the on-voltage (VGL) is applied to the gate signal line 17a which is connected to the pixel 16a. If the on-voltage (VGL) is simultaneously applied to the gate signal line 17a and the gate signal line 17b of the pixel 16a, a part of a program current Iw which originally flows to the source driver circuit 14 becomes a current Ie which flows to the EL element 15. It is because a set voltage is held by a capacitor 19 to pass an abnormal current through the EL element 15 for that reason.

### SUMMARY OF THE INVENTION

In the case of a conventional EL display device, the gate driver circuit 12a and the gate driver circuit 12b have the same operating frequency as shown in FIGS. 6A, 6B. To be more specific, the gate driver circuit 12a and the gate driver circuit 12b have the same clock (CLK) applied thereto. In the case of FIGS. 6A, 6B, it is easy not to have the same pixel line selected by the gate signal line 17a for selecting the write pixel line 41 and the gate signal line 17b for specifying lighting of the EL element 15. It is because a position of the gate signal line 17a selected by the gate driver circuit 12a and a position of the gate signal line 17b selected by the gate driver circuit 12b are sequentially moved by the same clock signal (CLK). It is because start pulse signals (ST) to be inputted to the gate driver circuit 12a and the gate driver circuit 12b can be inputted so as not to coincide between the gate driver circuit 12a and the gate driver circuit 12b.

An image display signal of a cell-phone and the like is 30 frames/second (30 frame rate=30 frames/second). As shown in FIGS. 7A, 7B, a signal for operating the gate driver circuit 12a is 30 Hz (30 frames/second) corresponding to 30 frame rate. A clock signal (CLK1) is the clock signal corresponding to 30 Hz, and a start pulse signal (ST1) is also generated 30 times a second correspondingly to 30 frames per second. As for an image display signal of MPEG or the like, there are the cases of 15 frames per second (15 frame rate=15 frames/second). In this case, the start pulse signal (ST1) is also generated 15 times a second correspondingly to 15 frames per second. To be more specific, it rewrites the image 15 frames per second.

Even if operation of the gate driver circuit 12a is an image rewriting operation of 15 frames per second, the gate driver circuit 12b needs to be operated at an operation frame rate of 60 Hz (a cycle for an arbitrary pixel to be elected is 60 times a second). It is because flicker becomes visible if the cycle for the pixel to be selected is slow. It is presumed that the flicker is generated by a leak of a capacitor 19 of the pixel 16.

In the case of a driving method of FIGS. 7A, 7B, the operating frequency of the gate driver circuit 12a is slower than that of the gate driver circuit 12b. For that reason, there arise the cases where the same pixel 16 is selected by the gate signal line 17a selected by the gate driver circuit 12a and the gate signal line 17b selected by the gate driver circuit 12b. To be more specific, there arise the cases where the switch transistor 11b and the switch transistor 11d simultaneously become on as shown in FIG. 7B. If the switch transistor 11b and the switch transistor 11d simultaneously become on, a normal voltage is not held by the capacitor 19.

As described above, it has been not possible, according to the conventional configuration, to operate the gate driver circuit 12a at 30 frame rate and operate the gate driver circuit 12b at a different frame rate from the gate driver circuit 12a as shown in FIGS. 7A, 7B.

Therefore, according to the conventional configuration, the gate driver circuit 12a and the gate driver circuit 12b have been operated at the same frame rate. In the case where the image rewriting cycle is smaller than the operation frame rate of the gate driver circuit 12b (such as the case where the operation frame rate of the gate driver circuit 12a is 30 Hz and the operation frame rate of the gate driver circuit 12b is 60 Hz), the conventional configuration requires image data to be held in a frame memory. To be more specific, according to the conventional configuration, an image of 30 frames per second is held in the frame memory so as to convert the image held in the frame memory to a frame rate of 60 frames per second and output it to the source driver circuit 14. The frame memory is a cause of high cost of the display device.

To be more specific, there is a problem that the conventional EL display device cannot operate driving of the gate signal line for selecting the write pixel line and driving of the gate signal line for specifying lighting of the EL element at different frame rates.

There is also a problem that the conventional EL display device requires the frame memory to be provided in the case where the image rewriting cycle is different from the operation frame rate of the gate driver circuit, which results in high cost.

The present invention has been made in view of the problems, and an object thereof is to provide a driving method of an EL display device of which display quality is not degraded even in the case of operating driving of the gate signal line for selecting the write pixel line and driving of the gate signal line for specifying lighting of the EL element at different frame rates, and the EL display device.

In view of the problems, another object of the present invention is to provide a driving method of an EL display device which requires no frame memory even in the case where the image rewriting cycle is different from the operation frame rate of the gate driver circuit so as not to result in high cost, and the EL display device.

To solve the above problems, the 1st aspect of the present invention is a driving method of an EL display device for driving the EL display device having EL elements placed in a matrix state thereon, wherein:

when a pixel line selected to write a video signal matches with a pixel line selected to supply a current to said EL elements,

at least one of the pixel line selected to write said video signal and the pixel line selected to supply a current to said EL elements is rendered non-selected.

The 2nd aspect of the present invention is a driving method of an EL display device for driving the EL display device having EL elements placed in a matrix state thereon, comprising operations of:

when a pixel line selected to write a video signal matches with a pixel line selected to supply a current to the EL elements, stopping supplying a current to the EL elements of said pixel line in said matching period; and

applying correction data to correct luminance reduced by the operation of stopping supplying a current to said EL elements of the pixel line in a frame in which said operation occurs or a frame before said frame or a frame after said frame.

The 3rd aspect of the present invention is a driving method of an EL display device for driving the EL display device having EL elements placed in a matrix state thereon, wherein:

a first operation frame rate for selecting a pixel line for writing a video signal is different from a second operation frame rate for selecting a pixel line for supplying a current to said EL elements.

The 4th aspect of the present invention is the driving method of an EL display device according to the 1st aspect of the present invention, wherein:

control for writing said video signal is exerted in a first gate driver circuit;

control for supplying a current to said EL elements is exerted in a second gate driver circuit;

a first operation frame rate of said first gate driver circuit is different from a second operation frame rate of said second gate driver circuit; and

said second operation frame rate is faster than said first operation frame rate.

The 5th aspect of the present invention is the driving method of an EL display device according to the 2nd aspect of the present invention, wherein:

control for writing said video signal is exerted in a first gate driver circuit;

control for supplying a current to said EL elements is exerted in a second gate driver circuit;

a first operation frame rate of said first gate driver circuit is different from a second operation frame rate of said second gate driver circuit; and

the second operation frame rate is faster than the first operation frame rate.

The 6th aspect of the present invention is the driving method of an EL display device according to the 3rd aspect of the present invention, wherein:

control for writing said video signal is exerted in a first gate driver circuit;

control for supplying a current to said EL elements is exerted in a second gate driver circuit;

a first operation frame rate of said first gate driver circuit is different from a second operation frame rate of said second gate driver circuit; and

said second operation frame rate is faster than said first operation frame rate.

The 7th aspect of the present invention is an EL display device having EL elements placed like a matrix thereon, comprising:

a first selection portion for selecting a pixel line for writing a video signal;

a second selection portion for selecting a pixel line for lighting EL elements; and

a selection control portion for rendering the pixel line selected by at least one of said first selection portion and said second selection portion non-selected when the pixel line selected by said first selection portion matches with the pixel line selected by said second selection portion.

The 8th aspect of the present invention is an EL display device having EL elements placed in a matrix state thereon, comprising:

a first gate driver circuit for selecting a pixel line for writing a video signal;

a second gate driver circuit for selecting a pixel line for lighting EL elements; and

a selection control circuit of which inputs are a first gate signal line connected to said first gate driver circuit and a second gate signal line connected to said second gate driver circuit.

The 9th aspect of the present invention is the EL display device according to the 8th aspect of the present invention, wherein:

an operation frame rate of said first gate driver circuit is different from an operation frame rate of said second gate driver circuit; and

said selection control circuit renders the pixel line selected by at least one of said first gate driver circuit and said second gate driver circuit non-selected when the pixel line selected by said first gate driver circuit matches with the pixel line selected by said second gate driver circuit.

The 10th aspect of the present invention is an EL display device having EL elements placed in a matrix state thereon, comprising:

a first gate driver circuit for selecting a pixel line for writing a video signal; and

a second gate driver circuit for selecting a pixel line for lighting EL elements,

wherein an operation frame rate of said first gate driver circuit is different from an operation frame rate of said second gate driver circuit.

The 11th aspect of the present invention is the EL display device according to the 7th aspect of the present invention, wherein:

an operation frame rate of said second selection portion or said second gate driver circuit is faster than an operation frame rate of said first selection portion or said first gate driver circuit.

The 12th aspect of the present invention is the EL display device according to the 8th aspect of the present invention, wherein:

an operation frame rate of said second selection portion or said second gate driver circuit is faster than an operation frame rate of said first selection portion or said first gate driver circuit.

The 13th aspect of the present invention is the EL display device according to the 9th aspect of the present invention, wherein:

an operation frame rate of said second selection portion or said second gate driver circuit is faster than an operation frame rate of said first selection portion or said first gate driver circuit.

The 14th aspect of the present invention is the EL display device according to the 10th aspect of the present invention, wherein:

an operation frame rate of said second selection portion or said second gate driver circuit is faster than an operation frame rate of said first selection portion or said first gate driver circuit.

The 15th aspect of the present invention is the EL display device according to the 7th aspect of the present invention, wherein a duty ratio is variable correspondingly to a lighting rate.

The 16th aspect of the present invention is the EL display device according to the 8th aspect of the present invention, wherein a duty ratio is variable correspondingly to a lighting rate.

The 17th aspect of the present invention is the EL display device according to the 9th aspect of the present invention, wherein a duty ratio is variable correspondingly to a lighting rate.

The 18th aspect of the present invention is the EL display device according to the 10th aspect of the present invention, wherein a duty ratio is variable correspondingly to a lighting rate.

The 19th aspect of the present invention is the EL display device according to the 9th aspect of the present invention, wherein, of multiple input terminals of said selection control circuit, at least one terminal is a gate signal line electrically connected to the first gate driver circuit or the second gate driver circuit.

The 20th aspect of the present invention is an EL display device having EL elements placed in a matrix state thereon, comprising:

a first selection circuit for selecting a pixel line for writing a video signal; and

a second selection circuit for selecting a pixel line for lighting EL elements.

An example of the present invention is as follows. However, the present invention is not limited to the following example.

For instance, according to the present invention, the off-voltage (VGH) is forcibly applied to one or both of the gate signal line 17a and gate signal line 17b when an applied position of the on-voltage (VGL) of the gate signal line 17a and an applied position of the on-voltage (VGL) of the gate signal line 17b are the same pixel 16 or when they coincide. To be more specific, at least one of the on-voltage (VGL) of the gate signal line 17a and the on-voltage (VGL) of the gate signal line 17b is rendered ineffective. Or else, only one of them is rendered effective.

For instance, according to the present invention, the gate driver circuit 12a rewrites the display screen 22 in synchronization with the frequency (operation frame rate, such as 30 images per second) of an input video signal. The gate driver circuit 12a sequentially selects the first to n-th pixel lines (n is a maximum value of the pixel lines) of the display screen 22 in synchronization with a horizontal synchronizing signal (HD) or the clock signal (CLK1) so as to apply a program current (voltage) from the source driver circuit 14 to the selected pixel lines.

For instance, the gate driver circuit 12b sequentially selects the first to n-th pixel lines (n is a maximum value of the pixel lines) of the display screen 22 in synchronization with a lighting control synchronizing signal (clock signal (CLK2)) which is different from the horizontal synchronizing signal (HD) or a vertical scanning synchronizing signal (VD) of the gate driver circuit 12. The gate driver circuit 12b selects the gate signal line 17b in synchronization with the lighting control synchronizing signal or shifts the position of the gate signal line 17b to be selected so as to on/off-control the gate signal line 17b. In the case of selecting the gate signal line 17a and the gate signal line 17b of the same pixel 16, the off-voltage (VGH) is forcibly applied to one or both of the gate signal line 17a and gate signal line 17b.

For instance, the lighting control synchronizing signal (clock signal (CLK2)) is oscillated inside the EL display device. To be more precise, an oscillation circuit is formed in the source driver circuit 14, and a clock signal (CLK) outputted by the oscillation circuit is divided to be used as the lighting control synchronizing signal (clock signals (CLK2)). The lighting control synchronizing signal (clock signal (CLK2)) is configured so that its frequency is variable as required.

For instance, the gate driver circuit 12a selects the gate signal line 17a in synchronization with the image rewriting cycle and writes the video signal to the pixel 16. The gate driver circuit 12b selects the gate signal line 17b in synchronization with the lighting control synchronizing signal (clock signal (CLK2)) to on/off-control the gate signal line 17b. The image rewriting cycle (rewrite frequency) and the lighting control synchronizing signal (lighting control frequency) are different frequencies, or the image rewriting cycle (rewrite frequency) and the lighting control synchronizing signal (lighting control frequency) are uniquely generated. Therefore, it is possible to differentiate between the operation frame rate for writing a video signal and the operation frame rate for displaying an image so as to render the operation frame rate for displaying an image faster. Thus, no flicker or the like is generated. And the frame memory for holding the image is not necessary.

The present invention can provide a driving method of an EL display device of which display quality is not degraded even in the case of operating driving of the gate signal line for selecting the write pixel line and driving of the gate signal line for specifying lighting of the EL element at different frame rates, and the EL display device.

The present invention can also provide a driving method of an EL display device which requires no frame memory even in the case where the image rewriting cycle is different from the operation frame rate of the gate driver circuit so as not to result in high cost, and the EL display device.

### BRIEF DESCRIPTION OF THE DRAWINGS

FIG. 1 is a block diagram of a pixel of an EL display device;

FIG. 2 is a block diagram of an EL display device;

FIG. 3A is an explanatory diagram related to operation of the pixel of the EL display device;

FIG. 3B is an explanatory diagram related to operation of the pixel of the EL display device;

FIG. 4A is an explanatory diagram related to a driving method of an EL display device;

FIG. 4B is an explanatory diagram related to a driving method of an EL display device;

FIG. 5 is an explanatory diagram related to a driving method of an EL display device;

FIG. 6A is an explanatory diagram related to a driving method of an EL display device of the present invention;

FIG. 6B is an explanatory diagram related to a driving method of an EL display device of the present invention;

FIG. 7A is an explanatory diagram related to a driving method of an EL display device of the present invention;

FIG. 7B is an explanatory diagram related to a driving method of an EL display device of the present invention;

FIG. 8 is an explanatory diagram related to an EL display device of the present invention;

FIG. 9A is an explanatory diagram related to an EL display device of the present invention;

FIG. 9B is an explanatory diagram related to an EL display device of the present invention;

FIG. 10A is an explanatory diagram related to an EL display device of the present invention;

FIG. 10B is an explanatory diagram related to an EL display device of the present invention;

FIG. 11 is an explanatory diagram related to an EL display device of the present invention;

FIG. 12 is an explanatory diagram related to an EL display device of the present invention;

FIG. 13 is an explanatory diagram related to an EL display device of the present invention;

FIG. 14 is an explanatory diagram related to an EL display device of the present invention;

FIG. 15 is an explanatory diagram related to an EL display device of the present invention;

FIG. 16 is an explanatory diagram related to a driving method of an EL display device of the present invention;

FIG. 17 is an explanatory diagram related to a driving method of an EL display device of the present invention;

FIG. 18 is an explanatory diagram related to a driving method of an EL display device of the present invention;

FIG. 19 is an explanatory diagram related to a driving method of an EL display device of the present invention;

FIG. 20 is an explanatory diagram related to an EL display device of the present invention;

FIG. 21 is an explanatory diagram related to an EL display device of the present invention;

FIG. 22 is an explanatory diagram related to an EL display device of the present invention;

FIG. 23 is an explanatory diagram related to an EL display device of the present invention;

FIG. 24 is an explanatory diagram related to an EL display device of the present invention;

FIG. 25 is an explanatory diagram related to an EL display device of the present invention;

FIG. 26 is an explanatory diagram related to an EL display device of the present invention;

FIG. 27 is an explanatory diagram related to an EL display device of the present invention;

FIG. 28 is an explanatory diagram related to an EL display device of the present invention;

FIG. 29 is an explanatory diagram related to an EL display device of the present invention;

FIG. 30 is an explanatory diagram related to an EL display device of the present invention;

FIG. 31 is an explanatory diagram related to an EL display device of the present invention;

FIG. 32 is an explanatory diagram related to a driving method of an EL display device of the present invention;

FIG. 33 is an explanatory diagram related to a driving method of an EL display device of the present invention;

FIG. 34 is an explanatory diagram related to a driving method of an EL display device of the present invention;

FIG. 35A is an explanatory diagram related to a driving method of an EL display device of the present invention;

FIG. 35B is an explanatory diagram related to a driving method of an EL display device of the present invention;

FIG. 36 is an explanatory diagram related to a driving method of an EL display device of the present invention;

FIG. 37 is an explanatory diagram related to a driving method of an EL display device of the present invention;

FIG. 38 is an explanatory diagram related to a driving method of an EL display device of the present invention;

FIG. 39 is an explanatory diagram related to a driving method of an EL display device of the present invention;

FIG. 40 is an explanatory diagram related to a driving method of an EL display device of the present invention;

FIG. 41 is an explanatory diagram related to an EL display device of the present invention;

FIG. 42 is an explanatory diagram related to an EL display device of the present invention;

FIG. 43 is an explanatory diagram related to an EL display device of the present invention;

FIG. 44 is an explanatory diagram related to a driving method of an EL display device of the present invention;

FIG. 45A is an explanatory diagram related to a driving method of an EL display device of the present invention;

FIG. 45B is an explanatory diagram related to a driving method of an EL display device of the present invention;

FIG. 45C is an explanatory diagram related to a driving method of an EL display device of the present invention;

FIG. 46 is an explanatory diagram related to a driving method of an EL display device of the present invention;

FIG. 47A is an explanatory diagram related to a driving method of an EL display device of the present invention;

FIG. 47B is an explanatory diagram related to a driving method of an EL display device of the present invention;

FIG. 48A is an explanatory diagram related to a driving method of an EL display device of the present invention;

FIG. 48B is an explanatory diagram related to a driving method of an EL display device of the present invention;

FIG. 48C is an explanatory diagram related to a driving method of an EL display device of the present invention;

FIG. 49 is an explanatory diagram related to an EL display device of the present invention;

FIG. 50A is an explanatory diagram related to an EL display device of the present invention;

FIG. 50B is an explanatory diagram related to an EL display device of the present invention;

FIG. 50C is an explanatory diagram related to an EL display device of the present invention;

FIG. 50D is an explanatory diagram related to an EL display device of the present invention;

FIG. 51 is an explanatory diagram related to an EL display device of the present invention;

FIG. 52 is an explanatory diagram related to an EL display device of the present invention;

FIG. 53 is an explanatory diagram related to an EL display device of the present invention;

FIG. 54 is an explanatory diagram related to an EL display device of the present invention;

FIG. 55 is an explanatory diagram related to an EL display device of the present invention;

FIG. 56A is an explanatory diagram related to a driving method of an EL display device of the present invention;

FIG. 56B is an explanatory diagram related to a driving method of an EL display device of the present invention;

FIG. 57A is an explanatory diagram related to a driving method of an EL display device of the present invention;

FIG. 57B is an explanatory diagram related to a driving method of an EL display device of the present invention;

FIG. 57C is an explanatory diagram related to a driving method of an EL display device of the present invention;

FIG. 57D is an explanatory diagram related to a driving method of an EL display device of the present invention;

FIG. 58 is an explanatory diagram related to a driving method of an EL display device of the present invention;

FIG. 59A is an explanatory diagram related to a driving method of an EL display device of the present invention;

FIG. 59B is an explanatory diagram related to a driving method of an EL display device of the present invention;

FIG. 60 is an explanatory diagram related to a driving method of an EL display device of the present invention;

FIG. 61A is an explanatory diagram related to a driving method of an EL display device of the present invention;

FIG. 61B is an explanatory diagram related to a driving method of an EL display device of the present invention;

FIG. 61C is an explanatory diagram related to a driving method of an EL display device of the present invention;

FIG. 61D is an explanatory diagram related to a driving method of an EL display device of the present invention;

FIG. 62 is an explanatory diagram related to an EL display device of the present invention;

FIG. 63 is an explanatory diagram related to a display instrument using the EL display device of the present invention;

FIG. 64 is an explanatory diagram related to a display instrument using the EL display device of the present invention;

FIG. 65 is an explanatory diagram related to a display instrument using the EL display device of the present invention;

FIG. 66 is an explanatory diagram related to an EL display device of the present invention;

FIG. 67 is an explanatory diagram related to an EL display device of the present invention;

FIG. 68 is an explanatory diagram related to an EL display device of the present invention;

FIG. 69 is an explanatory diagram related to an EL display device of the present invention.

### DESCRIPTION OF SYMBOLS

11 Transistor (TFT)
12 Gate driver IC (circuit)
14 Source driver circuit (IC)
15 EL (element)
16 Pixel
17 Gate signal line
18 Source signal line
19 Storage capacitance (additional capacitor, additional capacitance)
22 Display screen
41 Write pixel line
45 Nondisplay area (non-lightning area, black display area)
46 Display area (lightning area, image display area)
81 AND circuit
111 Shift register circuit
112 Voltage level shift circuit
271 Operational amplifier (buffer circuit)
272 Electron volume (voltage output circuit)
273 Reference current circuit
274 Transistor
275 Unit transistor group
276 Output terminal
281 Analog switch (on-off portion, selection on)
282 Unit transistor
283 Internal writing
284 Gate wiring
285 Decoder circuit
291 Amplitude adjustment register
292 Gradation amplifier
293 Terminal (wiring)
301 Voltage data latch circuit
302 Gradation voltage output circuit
303 Voltage DAC circuit
304 Voltage amplifier circuit
411 Temperature detection circuit
412 External memory circuit (EEPROM)
413 AD conversion circuit
414 Selector circuit
415 Data comparator circuit
416 Temperature correction sensor change amount DATA
417 Detection wiring
621 Selection signal line
631 Antenna
632 Key
633 Cabinet
634 Display panel
635 Photosensor
641 Supporting point
643 Photographing lens
644 Storage unit
651 Body
652 Shooting unit
653 Shutter switch
671 Decoder circuit

### PREFERRED EMBODIMENT OF THE INVENTION

Hereunder, an embodiment of the present invention will be described with reference to the drawings.

In this specification, some parts of the drawings are omitted and enlarged or reduced to facilitate understanding and drawing figures. The parts given the same numbers or symbols have the same or similar forms, configurations, materials, functions or operations.

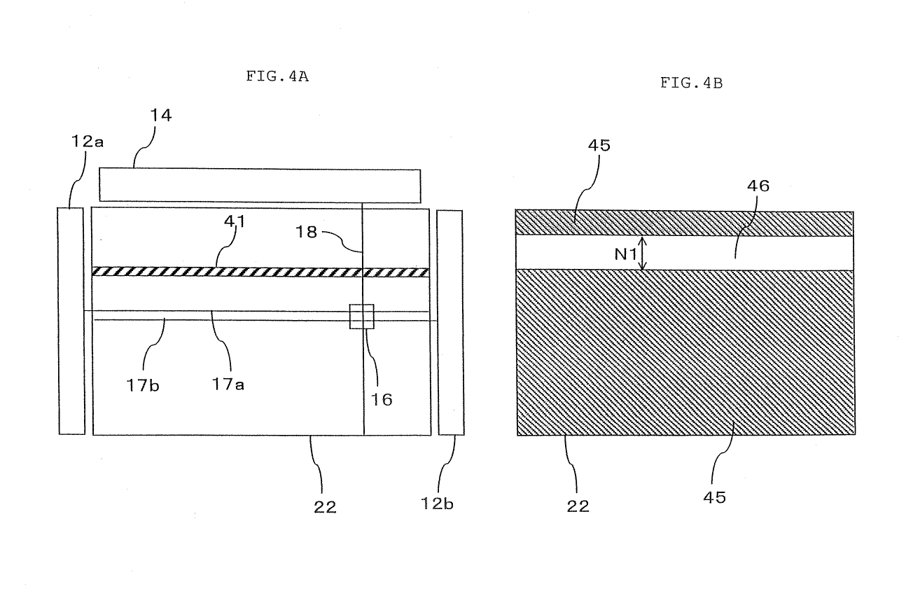

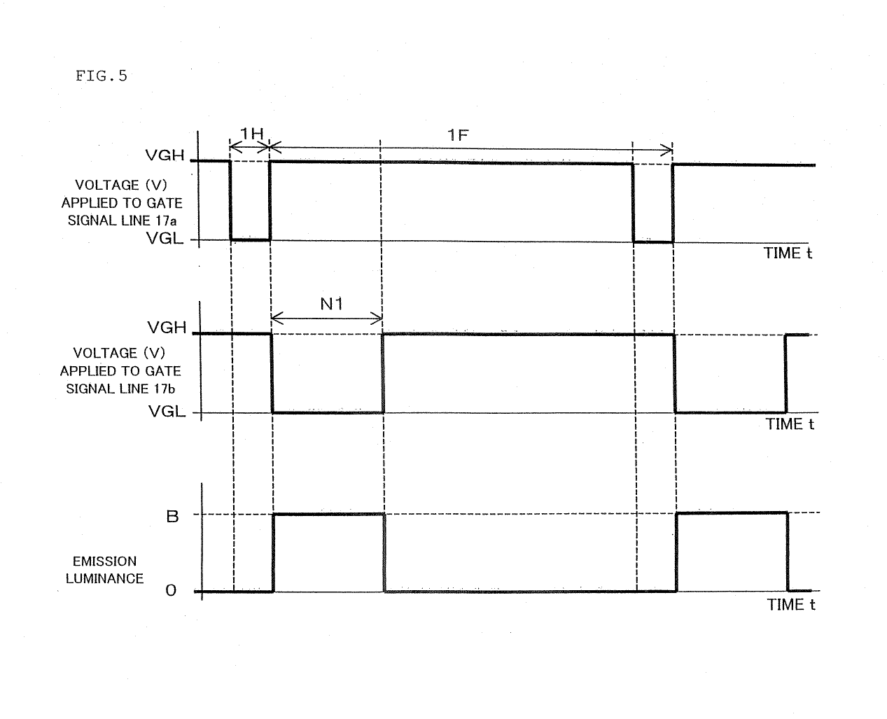

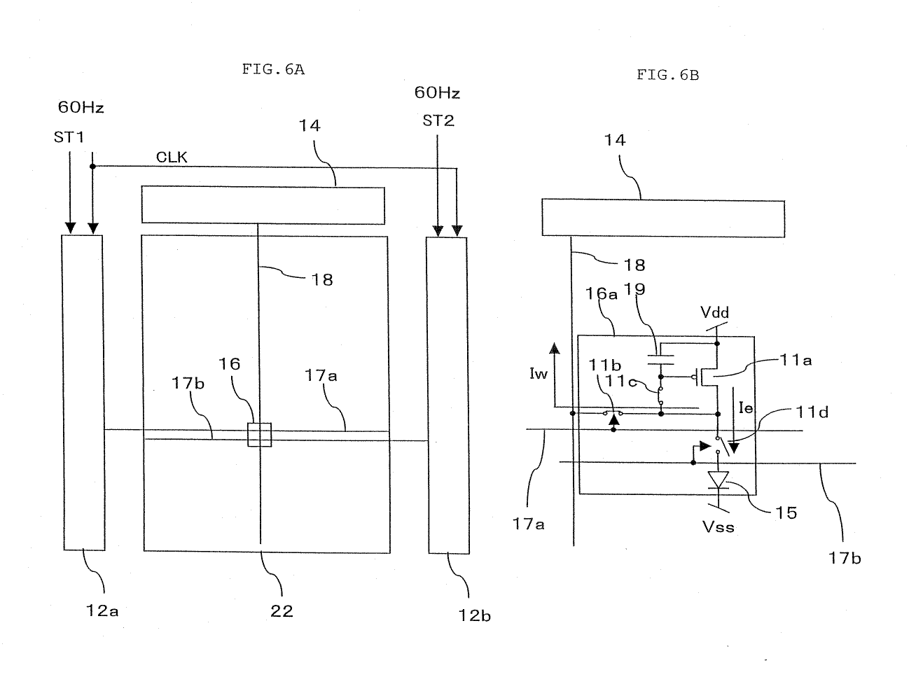

As shown in FIGS. 4A, 4B, the present invention generates a nondisplay area 45 and a display area 46 on a display screen 22. A driving method for performing such display is called a duty driving method. A ratio of Display area 46/(Display area 46+Nondisplay area 45) is called a duty ratio. The duty ratio is also (Number of gate signal lines 17b having on-voltage applied thereto)/(Total number of gate signal lines 17b). It is also, with the on-voltage applied to the gate signal lines 17b, (Number of selected pixel lines connected to the gate signal lines 17b)/(Total number of pixel lines of the display area 46).

The present invention changes the ratio between the display area 46 and the nondisplay area 45. Or it changes area of the nondisplay area 45 against the area of the display screen 22. It is also characterized by adjusting luminance or brightness of the screen by increasing or decreasing the number of pixels in a display state. It also writes to the display screen 22 and changes size or an amplitude value of a video signal. As an example, the luminance of the screen is realized by changing or adjusting the duty ratio, a reference current and a video amplitude value.

The present invention changes the duty ratio correspondingly to a lighting rate. The lighting rate is a ratio to a maximum current flowing through an anode or a cathode of a panel. In other words, the lighting rate is a ratio between the current flowing through the panel when a certain video is displayed and the maximum current flowing through the entire EL elements of the panel. When the lighting rate is high, the display is close to a white raster. In the case where the lighting rate is low, a black display portion occupies much of the entire screen. It is possible to average electric power consumed by the display screen 22 by changing the duty ratio correspondingly to the lighting rate. It is also possible to suppress it to certain power consumption or less.

A low lighting rate means that the current flowing through the display screen 22 is small. However, it also means that there are a large number of low gradation display pixels constituting the image. To be more specific, the video constituting the display screen 22 has a large number of dark pixels (low gradation pixels). Therefore, in other words, the low lighting rate is the state in which there is a lot of low gradation video data when the video data constituting the screen is histogram-processed.

A high lighting rate means that the current flowing through the display screen 22 is large. However, it also means that there are a large number of high gradation display pixels constituting the image. To be more specific, the video constituting the display screen 22 has a large number of bright pixels (high gradation pixels). Therefore, in other words, the high lighting rate is the state in which there is a lot of high gradation video data when the video data constituting the screen is histogram-processed. Controlling the duty ratio and the like correspondingly to the lighting rate can be synonymous with or mean a similar state to exerting control correspondingly to a gradation distribution state of the pixels or a histogram distribution.

From the above, exerting control based on the lighting rate is, in other words, exerting control based on the gradation distribution state of the images (low lighting rate=a lot of low gradation pixels, high lighting rate=a lot of high gradation pixels) according to the circumstances. For instance, it is also effective to increase a reference current ratio as the lighting rate becomes lower. It is also effective to reduce the duty ratio as the lighting rate becomes higher on the point that the electric power consumed by an EL display panel is averaged. It is also effective on the point that peak power can be suppressed.

To facilitate understanding, this specification gives a description on condition that duty ratio control and the like are mainly changed according to the lighting rate (%).

According to the present invention, it is possible to divide the display area 46 occupying the display screen 22 into a plurality. Division of the display area 46 can be realized by an input pattern of a start pulse signal (ST2) to be inputted to a gate driver circuit 12b. It is possible to suppress generation of flicker even at a low frame rate by dividing the display area 46 into a plurality. The number of divisions of the display area 46 or the nondisplay area 45 may be different between a movie display and a still image display. It is also possible to change the number of divisions of the display area 46 correspondingly to the lighting rate.

The present invention is characterized in that the nondisplay area 45 or the display area 46 occupying the display screen 22 becomes belt-like and moves downward from the top of the screen or upward from the bottom of the screen. According to the circumstances, it is possible, frame by frame, to switch between the case where the nondisplay area 45 or the display area 46 occupying the display screen 22 becomes belt-like and moves downward from the top of the screen and the case of moving upward from the bottom of the screen.

To facilitate understanding, the embodiment of this specification gives a description on condition that a gate driver circuit 12a and the gate driver circuit 12b have different operation frame rates (frame frequencies) but maintain synchronization. The state of maintaining the synchronization will be exemplified by an example of generating a clock signal (CLK1) of the gate driver circuit 12a and a clock signal (CLK2) of the gate driver circuit 12b from a main clock signal (CLK).

For instance, it is the case where twice the clock signal (CLK1) is the clock signal (CLK2). In this case, the operation frame rate of the gate driver circuit 12b becomes 60 Hz when the operation frame rate of the gate driver circuit 12a is 30 Hz.

A circuit configuration of an EL display device becomes simpler by generating the clock signal (CLK1) and the clock signal (CLK2) from the main clock signal (CLK). The main clock signal (CLK) is either inputted from outside the EL display device or generated by a source driver circuit 14. It is configured so that, in the case of generating the main clock signal (CLK) in the source driver circuit 14, the clock signal (CLK) is changeable by a command to the source driver circuit 14.

The above described that the gate driver circuit 12a and the gate driver circuit 12b have different operation frame rates (frame frequencies) but maintain the synchronization. However, the present invention is not limited thereto.

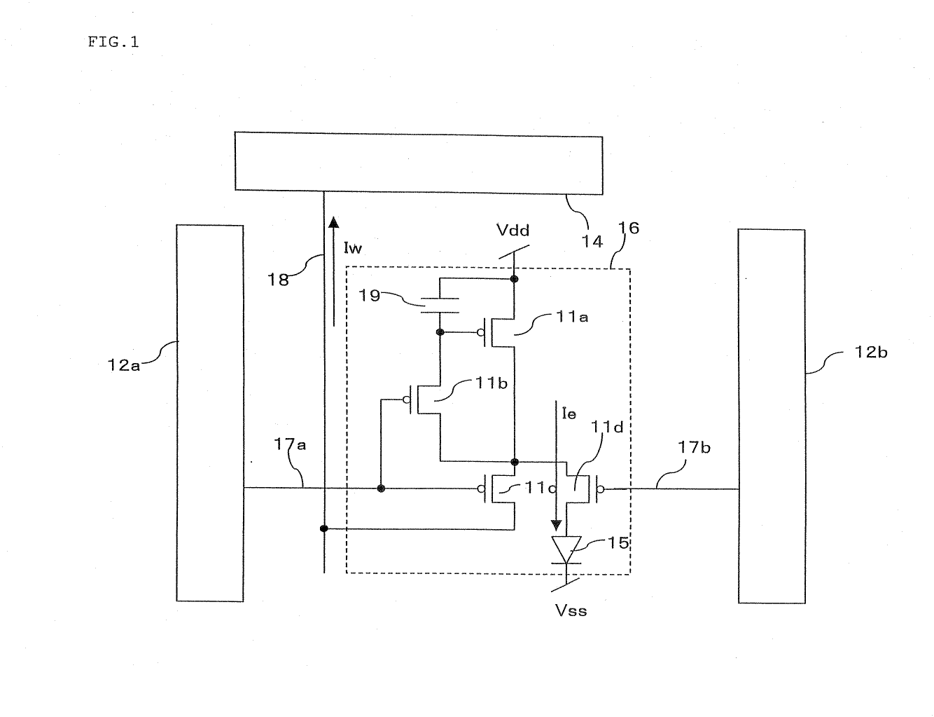

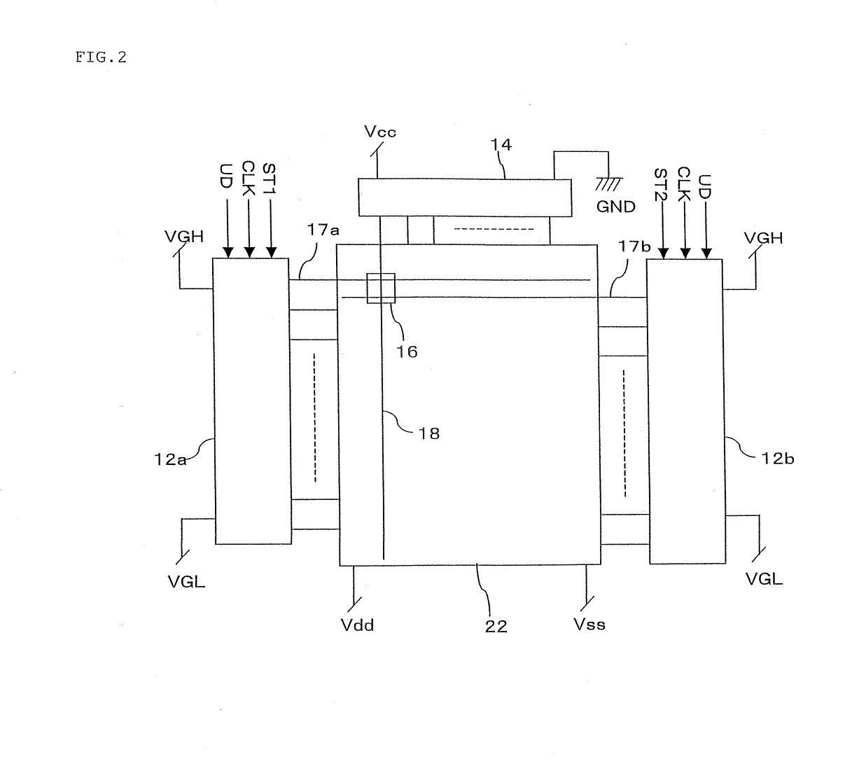

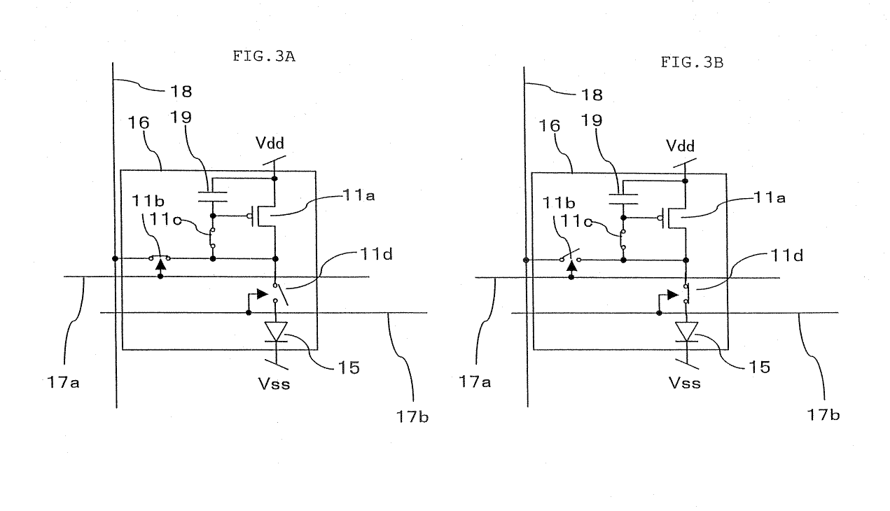

For instance, the clock signal (CLK1) and the clock signal (CLK2) may also be asynchronous. To be more specific, the clock signal (CLK1) and the clock signal (CLK2) may also be independently generated. In pixel configurations such as FIGS. 1 and 2, however, management is necessary so as not to have the same pixel line selected by a gate signal line 17a selected by the gate driver circuit 12a and the gate driver circuit 12b selected by the gate driver circuit 12b.

Management of on/off control of the gate signal lines 17 is easy. It is because a control circuit (not shown) manages and controls the data signals (ST1, ST2, CLK1, CLK2) of the gate driver circuit 12a and the gate driver circuit 12b. The controller circuit may be built into the source driver circuit 14. It has been described that one of the gate signal line 17a and gate signal line 17b is put in a nonselected state (state of applying the off-voltage (VGH)). However, the present invention is not limited thereto. It goes without saying that both of them may be controlled in the nonselected state (state of applying the off-voltage (VGH)).

Therefore, in the case of a configuration including multiple kinds of gate signal lines, it should be possible to control a selected or nonselected state of at least one kind of gate signal lines. The control of selection (state of applying the on-voltage (VGL)) and non-selection (state of applying the off-voltage (VGH)) may be exerted by time sharing. For instance, one horizontal scanning period (1H) may be divided into ½, where the gate signal line 17a is controlled in the first ½ period and the gate signal line 17b is controlled in the second ½ period.

In this specification, the gate driver circuit 12a selects a pixel line for writing a video signal and the gate driver circuit 12b selects a pixel line to be lighted. Therefore, the gate driver circuits 12 are pixel line selection circuits. It is not necessary to provide the gate driver circuit 12a and the gate driver circuit 12b by clearly separating them. It is also possible to form or place the gate driver circuit 12a and the gate driver circuit 12b in one gate driver circuit.

In this case, it is also considered that the gate driver circuits 12 which are not clearly separated have the gate driver circuit 12a and the gate driver circuit 12b formed or placed therein. The gate driver circuits 12 have a function of selecting or specifying the pixel line. Therefore, if they have a function of a shift register circuit, such circuits are synonymous with the gate driver circuits 12. If they have a function of specifying or selecting a specific pixel line, such circuits are the gate driver circuits 12. As above, this specification uses the gate driver circuits 12 in a broad sense.

In this specification, the off-voltage is VGH and the on-voltage is VGL. This is the case where switch transistors 11b, 11c, 11d and the like are P-channel transistors. In the case where the switch transistors 11b, 11c, 11d and the like are N-channel transistors, the on-voltage is VGH and the off-voltage is VGL. Therefore, as for setting of logic voltages (VGH, VGL) to be applied to the gate signal lines 17 according to the present invention, the logic voltages (VGH, VGL) to be applied to the gate signal lines 17 should be set in accordance with channel polarities of a driving transistor 11a and the switch transistors 11.

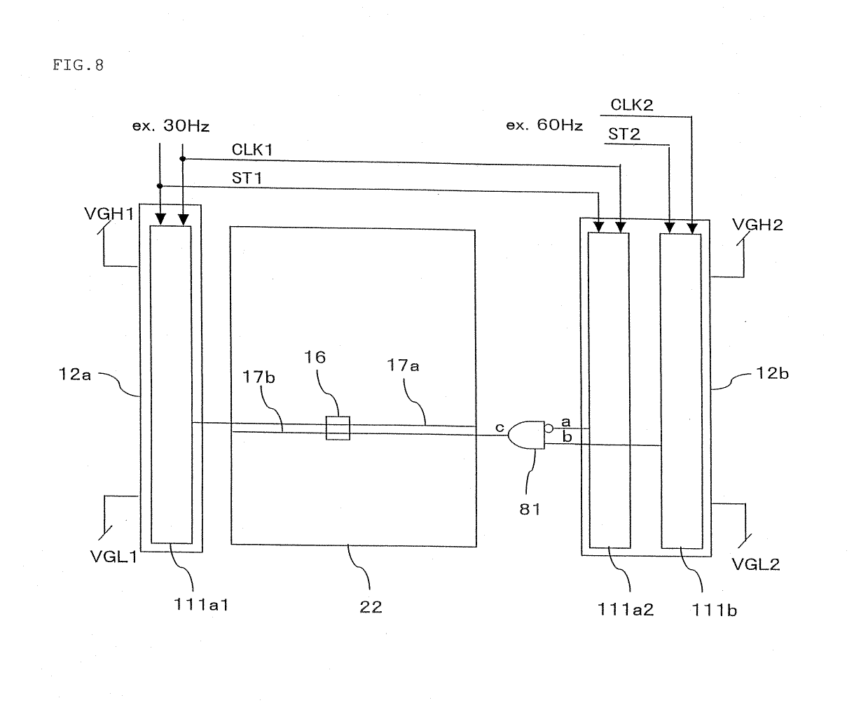

It is possible, by configuring the gate driver circuit 12b as shown in FIG. 8, to prevent the gate signal line 17a and the gate signal line 17b from being simultaneously selected in the pixel line.

The configuration of the gate driver circuit 12b in FIG. 8 includes a shift register circuit 111a2 operated by the same signals (ST1, CLK1 and the like) as a shift register circuit 111a1 of the gate driver circuit 12a and a shift register circuit 111b of the gate driver circuit 12b. The gate driver circuit 12b is formed on either the right or the left of the display screen 22. The shift register circuit 111a1 and the shift register circuit 111a2 have the same circuit configuration.

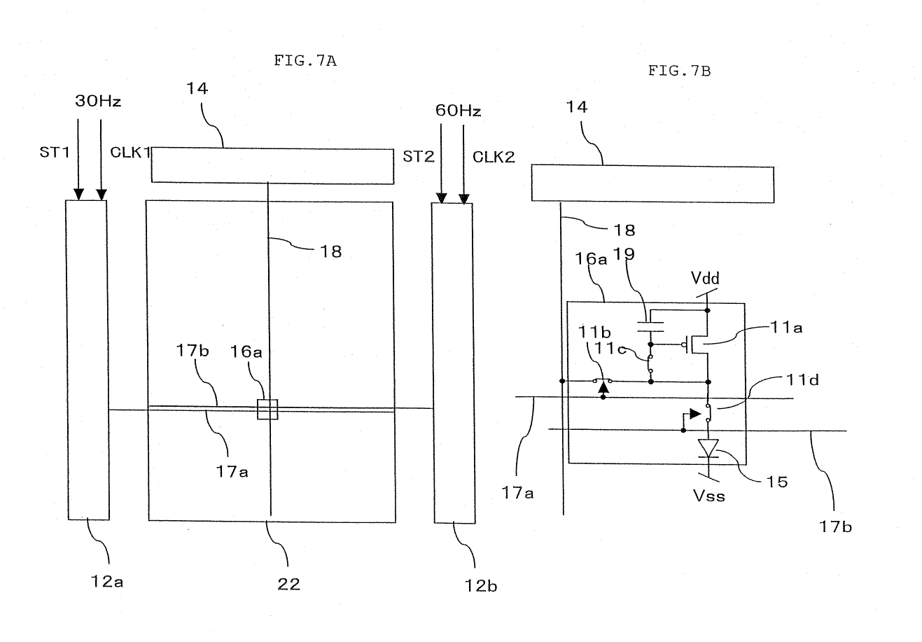

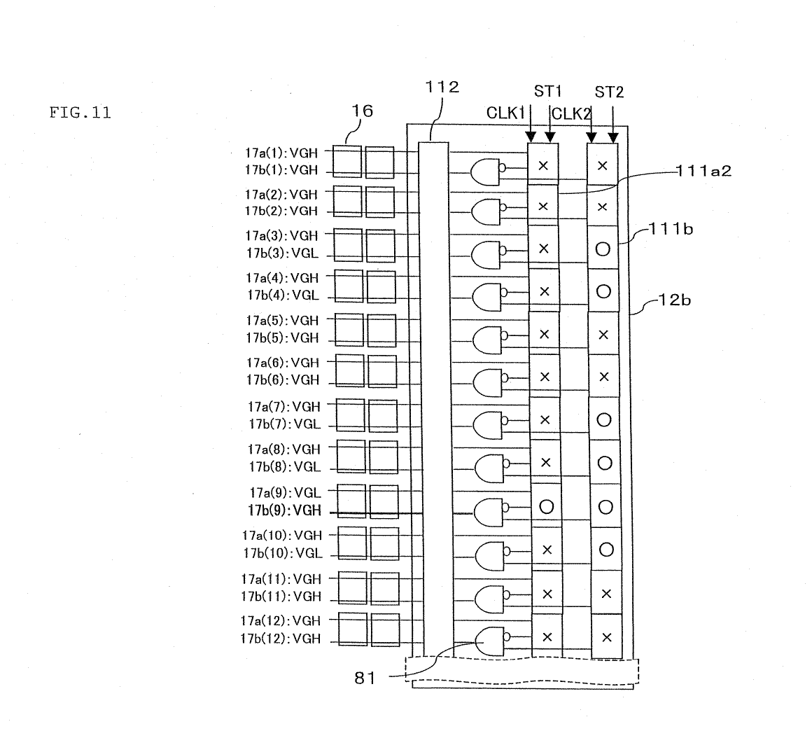

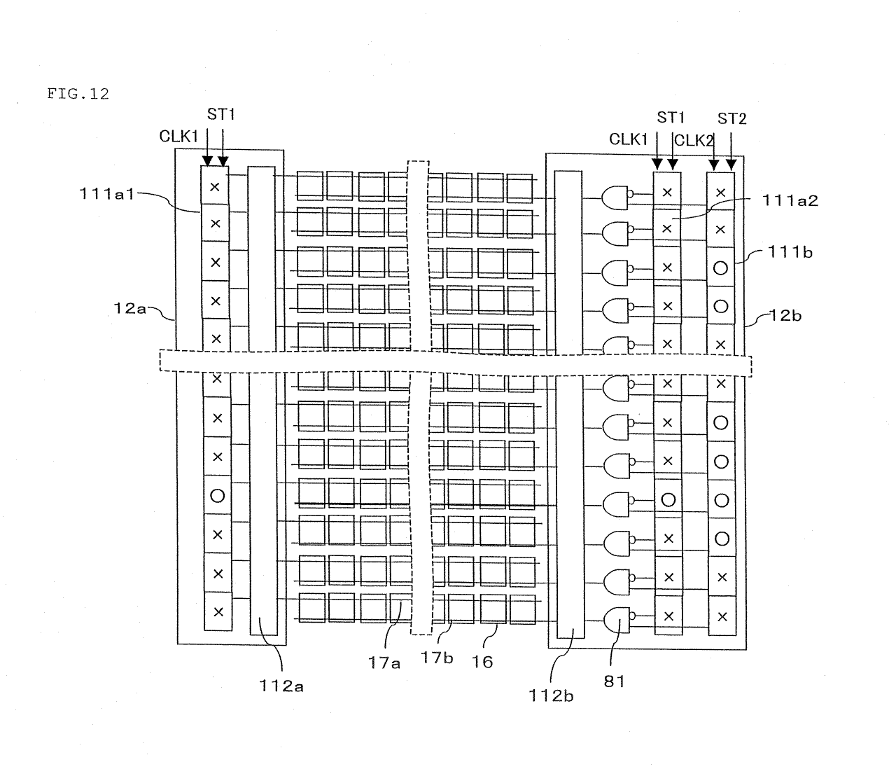

FIGS. 11 and 12 are explanatory diagrams for describing the operation of the configurations shown in FIGS. 7A, 7B and 8. In FIGS. 11 and 12, reference character × denotes data for rendering the gate signal lines 17 nonselected (outputting the off-voltage), and reference character ◯ denotes data for rendering the gate signal lines 17 selected (outputting the on-voltage).

As shown in FIGS. 7A, 7B and 8, the operation frame rate at which the shift register circuit 111a2 operates is different from the operation frame rate at which the shift register circuit 111b operates. To be more specific, in FIGS. 7A, 7B and 8, the frame rate at which the shift register circuit 111a2 operates is 30 Hz, and the frame rate at which the shift register circuit 111b operates is 60 Hz. The present invention will be described on condition that the frame rate at which the shift register circuit 111b operates is higher than the frame rate at which the shift register circuit 111a2 (=the shift register circuit 111a1) operates as described in FIGS. 7A, 7B.

A lighting control synchronizing signal (clock signal (CLK2)) is generated in the EL display device. To be more precise, an oscillation circuit is formed in the source driver circuit 14, and the clock signal (CLK) outputted by the oscillation circuit is divided to be used as the lighting control synchronizing signal (clock signals (CLK2)). The lighting control synchronizing signal (clock signal (CLK2)) is configured so that its frequency is variable as required. In the case where a display image displayed on the display screen 22 is a moving image, the lighting control synchronizing signal (clock signal (CLK2)) is slowed down to improve moving image visibility. In the case where a display image displayed on the display screen 22 is a still image, the lighting control synchronizing signal (clock signal (CLK2)) is sped up to suppress generation of the flicker and improve still image visibility.

The frequency of the clock signal (CLK2) is configured to be automatically switched by a switching signal of the moving image or the still image outputted from a moving image/still image detection circuit inside the controller circuit (not shown). In the case of partial display, the lighting control synchronizing signal (clock signal (CLK2)) is slowed down to reduce the power consumption.

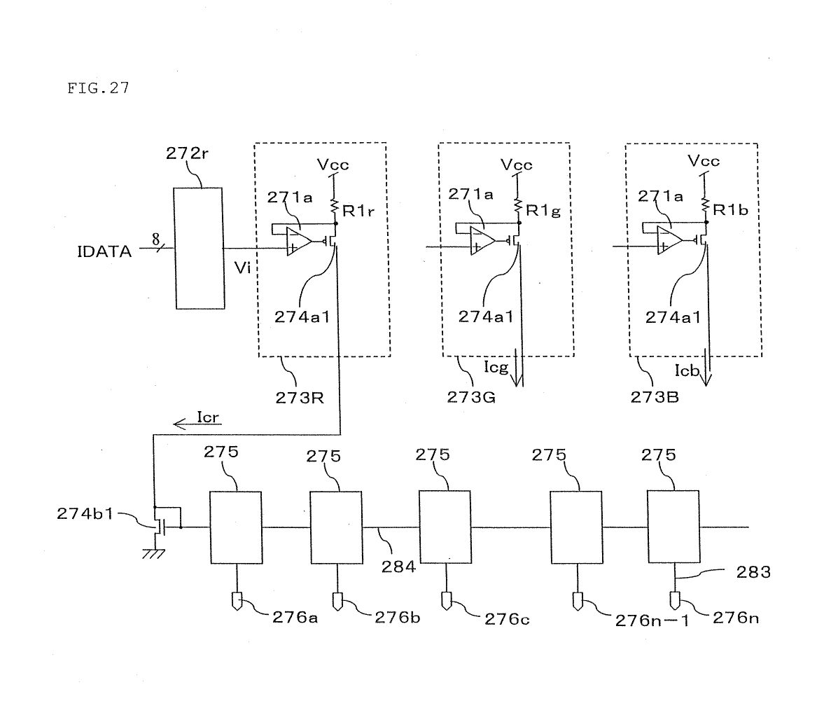

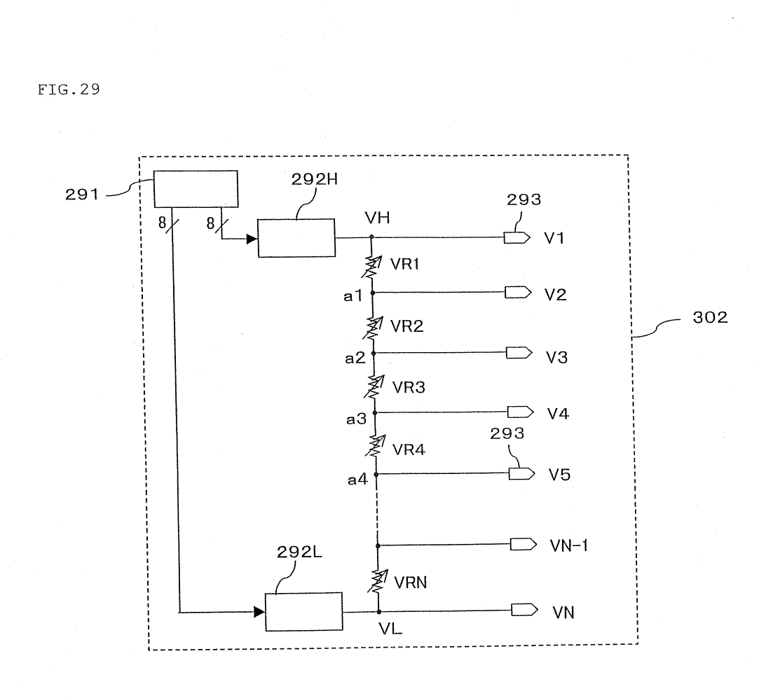

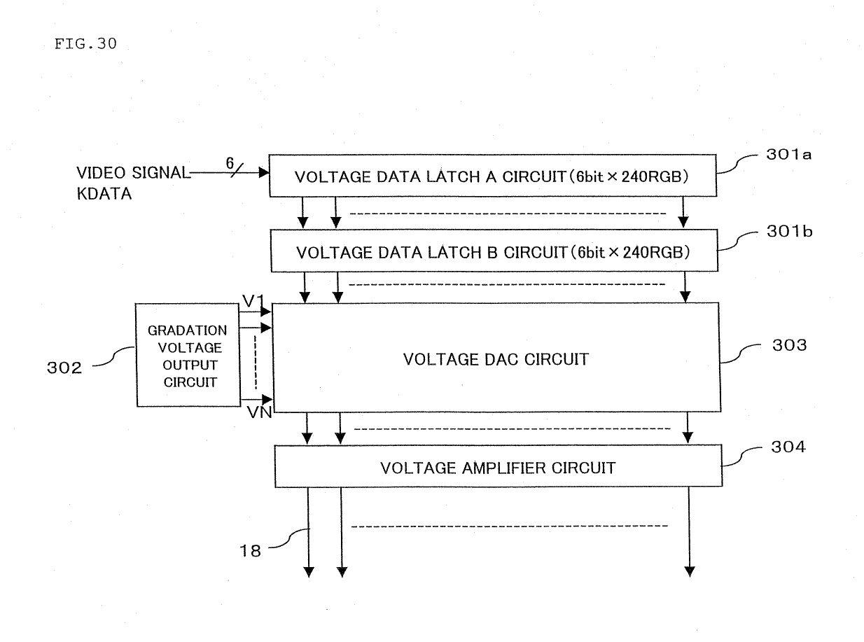

It is also effective to change the clock signal (CLK) generated in the EL display device according to external environment illuminance of the EL display device. The external environment illuminance is measured by a photosensor added to the EL display device. When the external environment illuminance is high, the duty ratio is increased (closer to 1). Or else, the reference current (refer to FIG. 27) is increased. And the amplitude value of the video signal is increased or a gamma curve is changed according to FIGS. 29 and 30. The display screen becomes brighter by such an operation. When the external environment illuminance is low, the duty ratio is reduced (closer to 0). Or else, the reference current is reduced. And the amplitude value of the video signal is reduced or the gamma curve is changed according to FIGS. 29 and 30. The display screen becomes darker by such an operation.

The start pulse signal (ST1) is generated by using the clock signal (CLK1). The start pulse signal (ST2) is generated by using the clock signal (CLK2). It is also possible to provide a frame memory in the source driver circuit 14 or the like and thereby operate writing of the video signal by the gate driver circuit 12a and lighting control by the gate driver circuit 12b.

According to the foregoing embodiment, the lighting control synchronizing signal (clock signal (CLK2)) is oscillated in the EL display device. It is also possible, however, to generate the clock signal (CLK1) in the EL display device. A clock signal (CLK) inputted from outside the EL display device is used as the lighting control synchronizing signal (clock signal (CLK2)). It is also possible to generate both the lighting control synchronizing signal (clock signal (CLK2)) and clock signal (CLK1) in the EL display device. In this case, the clock signal generated in the source driver circuit 14 is divided to generate the clock signal (CLK1) and the clock signal (CLK2).

It is also desirable to synchronize the clock signal (CLK2) with the clock signal (CLK1). It is possible to accurately perform writing of the video signal, calculation of the lighting rate, duty control, power consumption and the like by synchronizing the clock signal (CLK1) and the lighting control synchronizing signal (clock signal (CLK2)) with the start pulse signal (ST1).

However, the present invention is not limited thereto. It is also possible, for instance, to render the frame rate at which the shift register circuit 111a2 operates higher than the frame rate at which the shift register circuit 111b operates. The present invention is characterized in that it can differentiate between or freely set the operation frame rate for writing the video signal and the operation frame rate for displaying the image (lighting control frequency).

FIG. 11 shows a configuration which does not include the gate driver circuit 12a of FIG. 8. A voltage level shift circuit 112 potential-shifts an output signal of a selection controller circuit (AND circuit 81) and an output signal of the shift register circuit 111a2 to a voltage in accordance with a potential of each of the gate signal lines 17. The gate driver circuit 12b shifts the data in the shift register circuit 111 with the clock signals (CLK1, CLK2) and the start pulse signals (ST1, ST2) as synchronizing signals. The gate driver circuit 12b outputs the on-voltage (VGL)) and the off-voltage (VGH) to the gate signal lines 17a and 17b correspondingly to the shifted data positions.

The shift register circuit 111a2 outputs the voltage to the gate signal line 17a, and the output of the shift register circuit 111b is selectively controlled with an output of a shift register circuit 111b2 by the selection controller circuit (AND circuit 81) so that the voltage is applied to the gate signal line 17b.

The shift register circuit 111a2 shifts a data position in synchronization with a horizontal synchronizing signal (HD) of the video signal. The shift register circuit 111b shifts the data position in synchronization with the lighting control synchronizing signal. The horizontal synchronizing signal and the lighting control synchronizing signal are generated based on the same main clock or oscillating frequency. The horizontal synchronizing signal (HD) is basically the clock signal (CLK1), and the lighting control synchronizing signal is basically the clock signal (CLK2).

The shift register circuit 111a2 (shift register circuit 111a1) selects the pixel line for writing a program current (voltage) or the gate signal line 17a. The pixel line to be selected is basically one pixel line. However, there are also the cases where multiple (two pixel) lines are selected, such as the case of implementing a pseudo-interlace. This specification does not limit the pixel line to be selected by the gate driver circuit 12a to one pixel line. To make the description easier, however, it will be described on condition that one pixel line is selected by the gate driver circuit 12a. Therefore, “◯” which is the data to be selected (position for applying the on-voltage) is one location. This “◯” is shifted in synchronization with the horizontal synchronizing signal (HD) of the video signal. A vertical synchronizing signal (VD) of the video signal is the start pulse signal (ST1).

The shift register circuit 111b selects the pixel line for lighting an EL element 15. Therefore, it selects the gate signal line 17b connected to the pixel line. One or more gate signal lines 17b are selected, and the gate signal lines 17b to be selected are successively selected. The embodiment of the present invention will be described on condition that multiple gate signal lines 17b to be selected are simultaneously selected.

The data “◯” to be selected by the shift register circuit 111b is at multiple locations. In FIG. 11, four groups of “◯” and two groups of “◯” are described to facilitate understanding and drawing figures. In reality, succession of “◯” is n/4 (240/4=60 in the case of n=240 pixel lines) at 1/4 duty. It is more desirable to render the groups of “◯” successive than separated as in FIG. 11. The “◯” of the shift register circuit 111b is shifted in synchronization with the lighting control synchronizing signal (basically CLK2).

In FIGS. 11, 12, reference numeral 112 denotes the voltage level convert circuit. The voltage level convert circuit 112 converts a logic signal which is an output of the AND circuit 81 to match with on/off control logic of the gate signal lines 17. It also performs a level shift to the VGL and VGH voltages to be used.

This specification describes it as the AND circuit 81. However, it is not limited to the AND circuit. It may also be configured by an OR circuit for instance. It is described as the AND circuit 81 in order to facilitate understanding. A basic function of the AND circuit is the selection controller circuit. The selection controller circuit produces a logical decision output from at least two inputs. The selection controller circuit has a function of a voltage level shift circuit which converts a voltage level as required. The selection controller circuit also has a timing control function by inputting the clock signal as required. The selection controller circuit further has a function of selectively controlling whether or not to output a signal to the output.

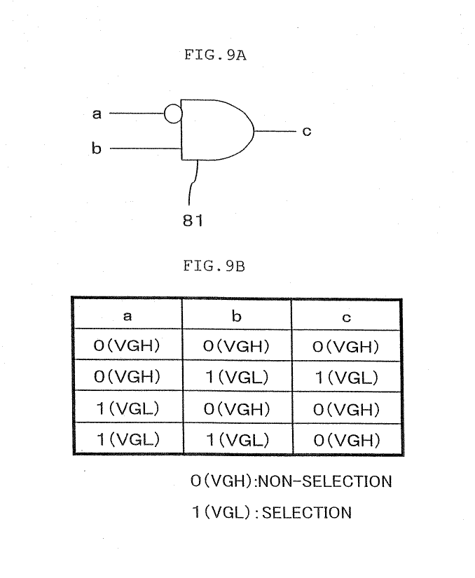

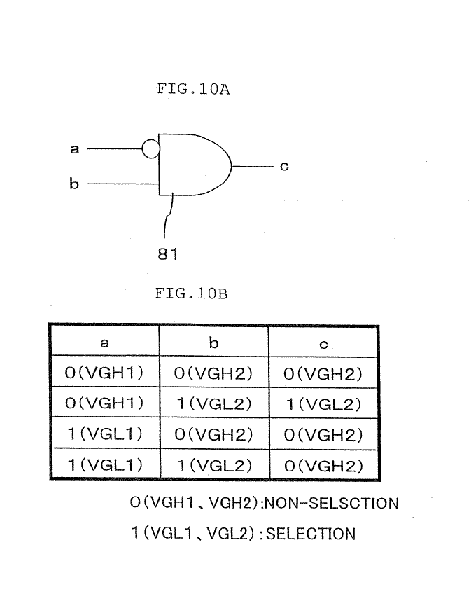

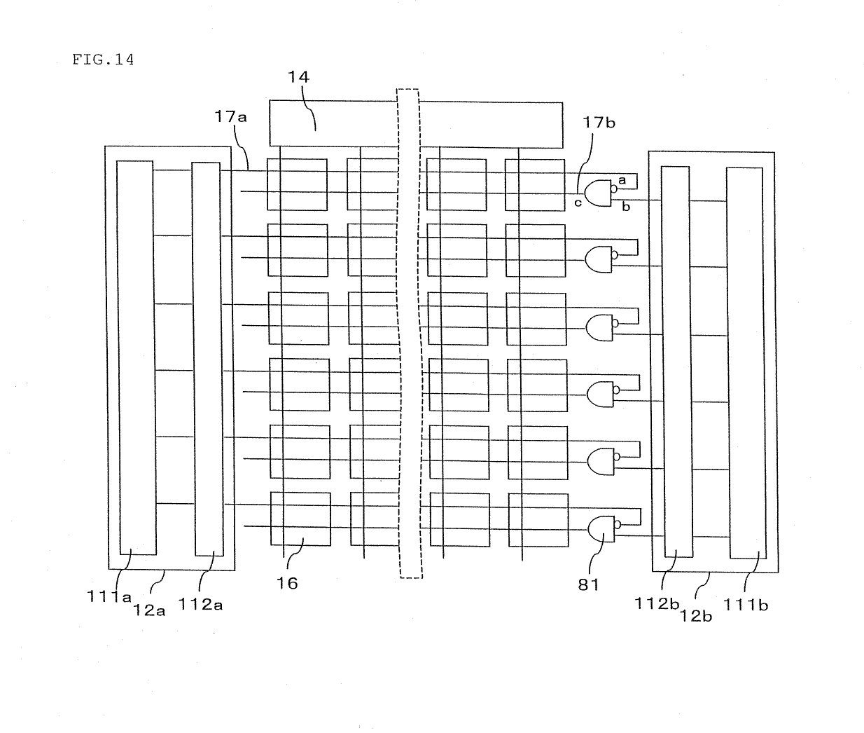

According to the embodiment of FIG. 11 of the present invention, the selection controller circuit (AND circuit 81) has two input signals, where the two signal inputs are the outputs of the two shift register circuits 111. According to the embodiment of FIGS. 14, 42, 55 and 69, the selection controller circuit (AND circuit 81) has two input signals, where one of the signal inputs is a signal applied to the gate signal line 17a or 17b (VGH, VGL or the like), and the other signal is the output of the shift register circuit 111. The selection controller circuit outputs a predetermined output voltage to the input signals of FIGS. 9A, 9B, 10A and 10B from a terminal c.

In FIGS. 9B, 10B, 0 is non-selection and 1 is selection. According to the present invention, in the case of the off-voltage (VGH), it is non-selection 0 because no pixel line is selected. And in the case of the on-voltage (VGL), it is selection 1 because the pixel line is selected. As it is presumed that the on-voltage (VGL) is differentiated between the gate driver circuits 12a and 12b, it is VGL1 or VGL2. It is also presumed that the off-voltage (VGH) is differentiated between the gate driver circuits 12a and 12b, and so it is VGH1 or VGH2. According to the present invention, however, the off-voltage (VGH) is the same between the gate driver circuits 12a and 12b. It is because of simplification of a voltage generator circuit and also because there is almost no difference in image display even if different voltages are set to VGH1 and VGH2.

Input logic of the AND circuit 81 is different among FIGS. 8, 42 and 55. According to the present invention, the logic of selection and non-selection of the pixel line is set correspondingly to each of the embodiments. Therefore, the AND circuit 81 is just an example.

Hereunder, a description will be given on condition that the selection controller circuit is the AND circuit 81 to facilitate the description. The output of the shift register circuit 111a logically inverts and becomes the input of the AND circuit 81, and the output of the shift register circuit 111b becomes the input of the AND circuit 81. The output of the AND circuit 81 is applied as a logic signal of the gate signal line 17b to the level convert circuit 112. The output of a shift register circuit 112a is inputted as a logic signal of the gate signal line 17a to the level convert circuit 112. The level convert circuit 112 performs a level shift of the voltage so as to match the inputted logic signal to control logic of the gate signal lines 17.

As shown in FIG. 11, because of the data “◯” of the shift register circuit 111b, the on-voltage (VGL) as a selection voltage is outputted to the gate signal line 17b (3), gate signal line 17b (4), gate signal line 17b (7), gate signal line 17b (8) and gate signal line 17b (10). As for the gate signal line 17b (9), however, it is the off-voltage (VGH) output because the selection voltage (VGL) of the shift register circuit 111a is outputted thereto. The other gate signal lines 17b are also the off-voltage (VGH) outputs.

As for the shift register circuit 111a, the on-voltage (VGL) as the selection voltage is outputted to the gate signal line 17a (9) because of the data “◯.” The other gate signal lines 17a are the off-voltage (VGH) outputs.

It is possible, by having the above configuration, to easily exert control so that the gate signal line 17a having the selection voltage applied thereto will not be the same pixels as the gate signal line 17b having the selection voltage applied thereto. The gate signal line 17a can write the video signal from the source driver circuit 14 to the selected pixel line without relying on the selection of the gate signal line 17b. Writing the video signal means to store it in a memory of the capacitor 19 of a pixel 16. Conversion of the operation frame rate can be easily realized by using this memory function.

FIG. 12 is an embodiment in which the gate driver circuit 12a for selecting the gate signal line 17a for writing the video signal is formed on the left side of the display screen 22, and the gate driver circuit 12 for selecting the gate signal line 17b described in FIG. 12 is formed as the gate driver circuit 12b on the right side of the display screen 22.

The data of the shift register circuit 111a of the gate driver circuit 12a is the same data as the data of the shift register circuit 111b of the gate driver circuit 12b. The shift register circuit 111a and the shift register circuit 111b shift the data position and has selection data inputted with the same horizontal synchronizing signal. The shift register circuit 111b of the gate driver circuit 12b shifts the data position and has the selection data (ST2) inputted in synchronization with the clock signal (CLK2).

The output of the shift register circuit 111a2 is inputted to a terminal a of the AND circuit 81. The output of the shift register circuit 111b of the gate driver circuit 12b is inputted to a terminal b of the AND circuit 81. The shift register circuit 111a1 and the shift register circuit 111a2 have the same configuration and data contents.

The logic and output potential of the output terminal c of the AND circuit 81 are decided by the signal of the terminal a and the signal of the terminal b. As for the input of the AND circuit 81, potential level conversion and a level shift are implemented as required. As for the output of the shift register circuit 111b, the potential level is converted by a voltage level shift circuit 112b.

As shown in FIGS. 9A, 9B, the output (VGH, VGL) of the terminal c is decided by the input voltage (VGH, VGL) of the terminal a and the terminal b. In FIGS. 9A, 9B, the logic control or the potential conversion is performed so that the terminal c of the AND circuit 81 becomes nonselected (VGH) when the gate signal line 17a is in a selected (VGL) state and the shift register circuit 112b of the gate driver circuit 12b is a selected output (a state in which the gate signal line 17b is selected (VGL)). As for the EL element 15 of the pixel line pertinent to the gate signal line 17b having the off-voltage applied thereto, the transistor 11d becomes open so that no current flows and it becomes unlighted.

It is desirable to differentiate between the voltage (VGH, VGL) outputted to the gate signal line 17a by the gate driver circuit 12a and the voltage (VGH, VGL) outputted to the gate signal line 17a by the gate driver circuit 12b (refer to FIG. 8).

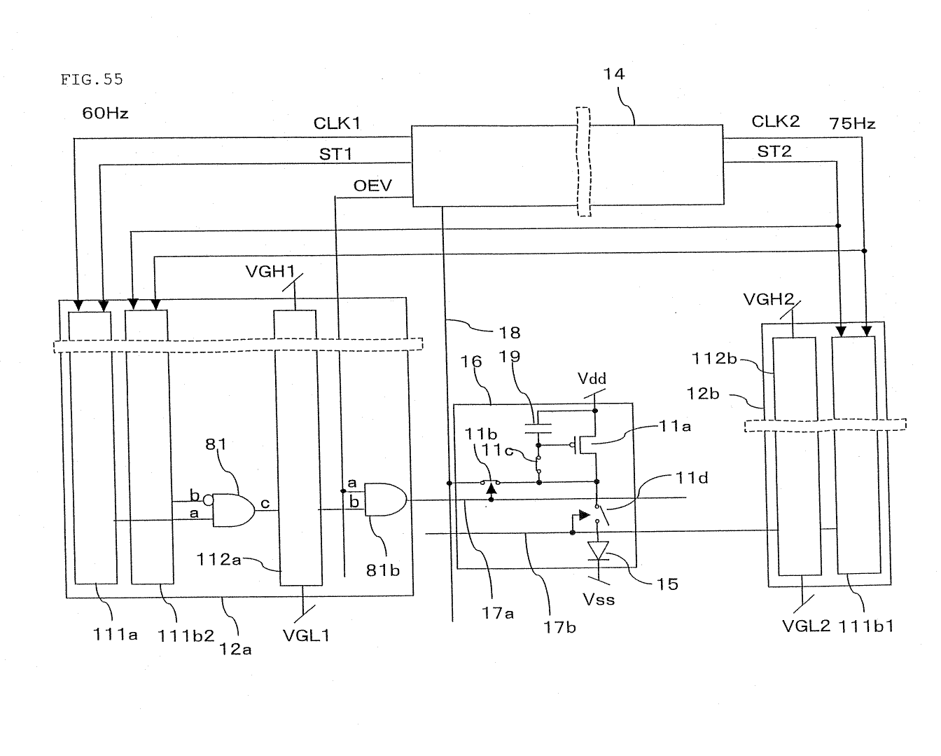

FIG. 12 has a configuration in which the shift register circuit 111a2 and the shift register circuit 111b are provided to the gate driver circuit 12b. However, the present invention is not limited thereto. It is also possible to provide the shift register circuit 111b2 and the shift register circuit 111a to the gate driver circuit 12a. Hereunder, this embodiment will be described with reference to FIG. 55.

In FIG. 55, only the shift register circuit 111b1 is provided on the gate driver circuit 12b side. The shift register circuit 111b2 on the gate driver circuit 12a side has the same configuration and operation as the shift register circuit 111b1. The same clock signal (CLK2) and start pulse signal (ST2) from the source driver circuit 14 are applied to the shift register circuit 111b1 and the shift register circuit 111b2. The start pulse signal (ST), the source driver circuit 14 have its voltage level converted and is applied to each of the gate driver circuits 12.

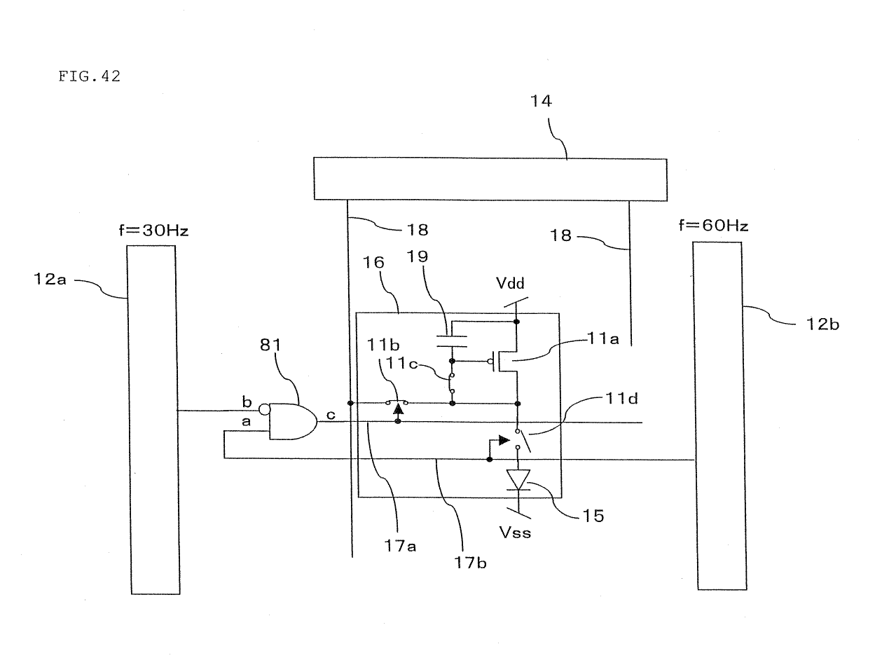

The configuration of FIG. 55 is the configuration of FIG. 12 of which right and left gate driver circuits 12 are interchanged, provided that the gate driver circuit 12a selects the gate signal line 17a and the gate driver circuit 12b selects the gate signal line 17b. The AND circuit 81 is formed on the gate driver circuit 12a side. It goes without saying that the configuration of FIG. 55 may use the gate signal line 17b as an input signal line of the AND circuit 81 as with FIG. 42.

In the case where the gate signal line 17a and the gate signal line 17b select the same pixel line in the embodiment of FIG. 55, the off-voltage is applied to the gate signal line 17a to exert control not to write the video signal to the pixel line. For that reason, the logic of the AND circuit 81 is different from FIG. 8. The positions of invertors of the terminal a and the terminal b are different.

The input voltages of the voltage level shift circuit 112a of the gate driver circuit 12a are VGH1 and VGL1. The input voltages of the voltage level shift circuit 112b of the gate driver circuit 12b are VGH2 and VGL2. The voltage level shift circuit 112 shifts the level of the output to each of the input voltages.

In FIG. 55, the operation frame rate of the gate driver circuit 12a is different from the operation frame rate of the gate driver circuit 12b. Therefore, the period in which the gate driver circuit 12a shifts (a period a in which one pixel line is selected) is different from the period in which the gate driver circuit 12b shifts (a period b in which one pixel line is selected).

The period in which the gate driver circuit 12a selects the gate signal line 17a gets mixed with the period in which the gate driver circuit 12b selects the gate signal line 17b so that a potential state of the pixel 16 suddenly changes. As for this problem, the embodiment of FIG. 55 takes measures by means of an OEV signal which is applied from the source driver circuit 14 to the gate driver circuit 12a. In the period in which the shift register circuit 112a changes due to a data shift, the output of the gate signal line 17a is controlled in an off output state (outputting the off-voltage (VGH)). The off voltage (VGH) should be outputted for the period of: the period a for selecting one pixel line at the maximum×2. The OEV signal means an output enable control signal in the vertical direction. For instance, in the case where the gate driver circuit 12a selects seventh and eighth pixel lines in the period in which the gate driver circuit 12b is selecting the eighth pixel line, the off-voltage (VGH1) is applied to the seventh and eighth gate signal lines 17a by controlling an OEV terminal. To be more specific, the period selected by two pixel lines of the gate driver circuit 12a is put in a nonselected state.

The OEV signal is applied to the terminal a of an AND circuit 81b. The on-voltage or the off-voltage is outputted to the gate signal line 17a according to the data contents of the shift register 112a at a logic level of the OEV signal. When the OEV is at an L (0) level, the off voltage (VGH) is outputted to the gate signal line 17a. To be more specific, the gate signal line 17a becomes nonselected. When the OEV signal is at an H (1) level, the signal inputted to the terminal b of the AND circuit 81b is passed through. In the case where the input signal is the on-voltage (VGL), the on-voltage (VGL) is outputted to the gate signal lines 17. In the case where the input signal is the off-voltage (VGH), the off-voltage (VGH) is outputted to the gate signal lines 17. It is effective to turn the OEV signal to L and render the gate signal lines 17 nonselected (applying the off-voltage (VGH)) when changing the state from selecting the first gate signal line 17 to selecting the following second gate signal line (following pixel line) 17, because a normal video signal can thereby be written to the pixel.

According to the present invention, the frame rate of the gate driver circuit 12a is slower than the frame rate of the gate driver circuit 12b. Therefore, the period for applying the off-voltage to the gate signal line 17a so as not to write the video signal to the pixel line is a part of the period for selecting one pixel line (which is the period for selecting one pixel line of the gate driver circuit 12a). It is because there is a relation of Period for selecting one pixel line of the gate driver circuit 12a > Period for selecting one pixel line of the gate driver circuit 12b. Therefore, it is also possible to write the video signal to the pixel line by using the remaining period.

If the frame rate of the gate driver circuit 12a is 15 Hz and the frame rate of the gate driver circuit 12b is 60 Hz, the period for the gate signal line 17a and the gate signal line 17b to select the same pixel line is only ¼ of the period for the gate driver circuit 12a to select one pixel line. Therefore, it is possible to write the video signal to the pixel line in the period of ¾ of one horizontal scanning period. There are the cases where the period for the gate signal line 17a and the gate signal line 17b to select the same pixel line involves an adjacent pixel line. In this case, it is also possible to write the video signal to the pixel line in the remaining period. It is also possible, as a matter of course, to adopt a method of writing no video signal to the pixel line.

In the case where the period for the gate driver circuit 12a to select one pixel line is longer than the period for the gate driver circuit 12b to select one pixel line, such as when the frame rate of the gate driver circuit 12a is 15 Hz and the frame rate of the gate driver circuit 12b is 60 Hz, the on-voltage (VGL) may be simultaneously applied to the gate signal line 17a and the gate signal line 17b in the same pixel line. It is because the normal video signal can be written to the pixel line in the remaining period of the period for the gate driver circuit 12a to select one pixel line even if an abnormal voltage is written to the pixel by simultaneously applying the on-voltage (VGL) to the gate signal line 17a and the gate signal line 17b.

Inversely, in the case where the frame rate of the gate driver circuit 12a is faster than the frame rate of the gate driver circuit 12b, there is a relation of Period for selecting one pixel line of the gate driver circuit 12a <Period for selecting one pixel line of the gate driver circuit 12b. Therefore, it is also possible to light up the pixel line by using the remaining period of the period for the gate driver circuit 12b to select one pixel line. If the frame rate of the gate driver circuit 12a is 60 Hz and the frame rate of the gate driver circuit 12b is 15 Hz, the period for the gate signal line 17a and the gate signal line 17b to select the same pixel line is only ¼ of the period for the gate driver circuit 12b to select one pixel line. Therefore, it is possible to select the gate signal line 17b of the pixel line and supply a current to the EL element 15 from the driving transistor 11a in the period of ¾ of one horizontal scanning period. There are the cases where the period for the gate signal line 17a and the gate signal line 17b to select the same pixel line involves an adjacent pixel line. In this case, it is also possible to emit light from the EL element 15 of the pixel line in the remaining period of the period for the gate driver circuit 12b to select one pixel line. It is also possible to reduce a correction amount by exerting such control.

The operation frame rate of the gate driver circuit 12a and the frame rate of the gate driver circuit 12b should be determined so that a greatest common multiple between them becomes large. For instance, if the operation frame rate of the gate driver circuit 12a is 30 Hz, the frame rate of the gate driver circuit 12b is 61 Hz. Establishment of the gate signal line 17a and the gate signal line 17b coinciding in the same pixel line of the display screen 22 is reduced by thus determining the values of the operation frame rate of the gate driver circuit 12a and the frame rate of the gate driver circuit 12b.

It is desirable to determine the values of the operation frame rate of the gate driver circuit 12a and the frame rate of the gate driver circuit 12b to be the values wherein a relation of a constant value of 0.25 times is multiplied by a value of 1.01 to 1.3 times.

For instance, in the case where the operation frame rate of the gate driver circuit 12a is 30 Hz, the operation frame rate of the gate driver circuit 12b is a value between 30×2×(0.25×8)×1.01=60.6 Hz and 30×2×(0.25×8)×1.3=78 Hz. In the above, 2×(0.25×8) is the relation of a constant value of 0.25 times.

In the case where the operation frame rate of the gate driver circuit 12a is 30 Hz for instance, the operation frame rate of the gate driver circuit 12b is a value between 30×1.5×(0.25×6)×1.01=45.5 Hz and 30×1.5×(0.25×6)×1.3=58.5 Hz. In the above, 1.5×(0.25×6) is the relation of a constant value of 0.25 times.

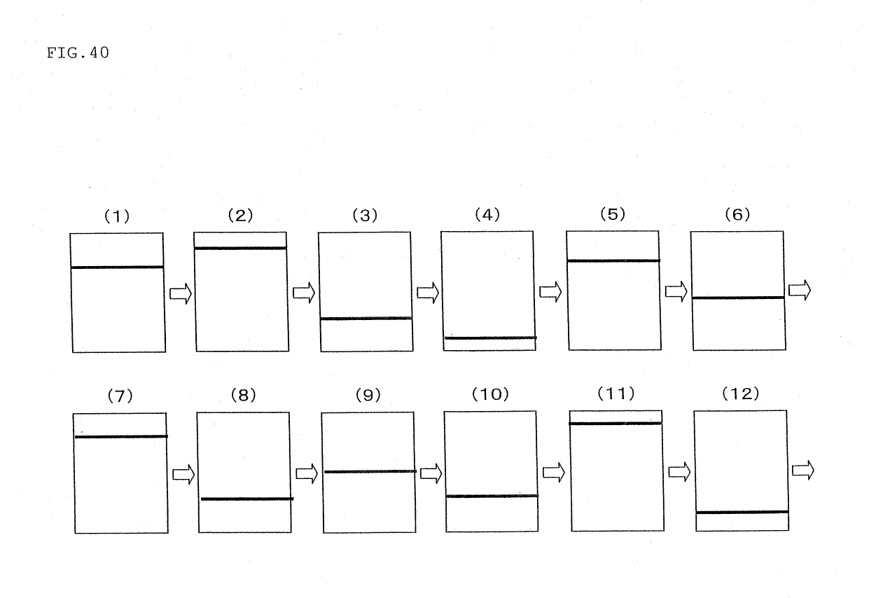

If the constant value is set as above, a position at which the pixel line selected to write the video signal matches with the pixel line selected to apply a current to the EL element is no longer fixed by each of the frames. For instance, the description of horizontal lines in (1) to (12) of FIG. 40 indicates the positions at which the pixel line selected to write the video signal matches with the pixel line selected to apply a current to the EL element. Reference numerals (1) to (12) of FIG. 40 denote frame numbers.

In FIG. 40, the positions at which the pixel line selected to write the video signal matches with the pixel line selected to apply a current to the EL element are different frame by frame. It is desirable that the positions become random in each of the frames. This is because the positions thereby become visually hard to notice.

The embodiments of FIGS. 8, 11, 12, 42 and 55 have a configuration in which the gate driver circuit 12a or the gate driver circuit 12b is formed or placed on one side of the display screen 22. However, the present invention is not limited thereto. For instance, the configuration shown as an example has the gate driver circuit 12a of the pixel selecting side on the right side of the display screen 22 and the gate driver circuit 12b for on/off-controlling the EL element 15 on the left side of the display screen 22.

According to the present invention, a cathode voltage Vss is a ground (GND) voltage. An anode voltage Vdd and a supply voltage Vcc of the source driver circuit 14 are in common. To be more specific, they are the same voltage. As a matter of course, the cathode voltage Vss can be set at a voltage other than the GND. However, a power circuit can be can be simplified and efficiency is improved by rendering the cathode voltage Vss as Cathode voltage Vss=GND. If the anode voltage Vdd fluctuates, the supply voltage Vcc of the source driver circuit 14 is also fluctuated.

As shown in FIG. 8, a gate-off voltage VGH2 outputted by the gate driver circuit 12b of the present invention is taken in a normal direction with the anode voltage Vdd as a reference (origin). VGH2−Vdd is between 0.2 V and 2.5 V. To be more specific, the off voltage (VGH2) of the gate signal lines 17 is a higher voltage than the anode voltage Vdd. A gate-on voltage VGL2 outputted by the gate driver circuit 12b is taken in a negative direction with the ground voltage (GND) as a reference (origin). GND−VGL is 0.0 or less and 2.5 V or more. VGL2 may be generated in reference to Vdd. VGH2 and VGL2 are generated in a charge pump circuit.

When the size of amplitude Vg of the gate signal line 17a for selecting the pixel 16 is Vg=VGH1−VGL1, the size of Vg is 6 (V) or more according to the present invention. In the case of the anode voltage Vdd and the cathode voltage Vss, a potential difference Ve=Vdd−Vss between the anode voltage and the cathode voltage is Vg+2 (V) or more. The voltage VGL1 may also be generated by forming the charge pump circuit or the like on an array substrate 30 by a polysilicon technology.

FIG. 8 shows an example in which the on-voltage of the gate driver circuit 12a is VGL1 and the off-voltage thereof is VGH1, and the on-voltage of the gate driver circuit 12b is VGL2 and the off-voltage thereof is VGH2.

VGL1 is the on-voltage of the gate driver circuit 12a for selecting the pixel line, and VGL2 is the on-voltage of the gate driver circuit 12b for selecting the switch transistor 11d. In this case, it is desirable to have a relation of VGL1<VGL2. To be more specific, VGL1 is a lower voltage than VGL2. However, the above embodiments are the cases where the driving transistor 11a is a P-channel. In the case where the driving transistor 11a is an N-channel, the relation is reversed. To be more specific, in the case where the driving transistor 11a is an N-channel, the relation should be VGL1=VGL2 and VGH1>VGH2. To be more specific, it is desirable that VGH1 become a higher voltage than VGH2.

This is because a punch-through voltage of a gate terminal of the driving transistor 11a is increased due to oscillation movement of the gate signal line 17a by rendering VGL1 smaller than VGL2 so that a good black display can be realized by combining it with the driving method (driving method, driving circuits, driving circuit configuration, driving equipment and the like) of the present invention. For instance, VGL1=−9 (V), VGL2=−3 (V) will be described as an example.

The anode voltage Vdd and the cathode voltage Vss may also be changed according to the kind or state of the display image such as a moving image or a still image. The anode voltage Vdd and the cathode voltage Vss may also be changed correspondingly to rise and fall of the external illuminance. When the external illuminance is high, the anode voltage Vdd and the like are increased. When the illuminance is low, the anode voltage Vdd and the like are reduced. The illuminance is detected by a PIN photodiode (photosensor) 635 or the like.

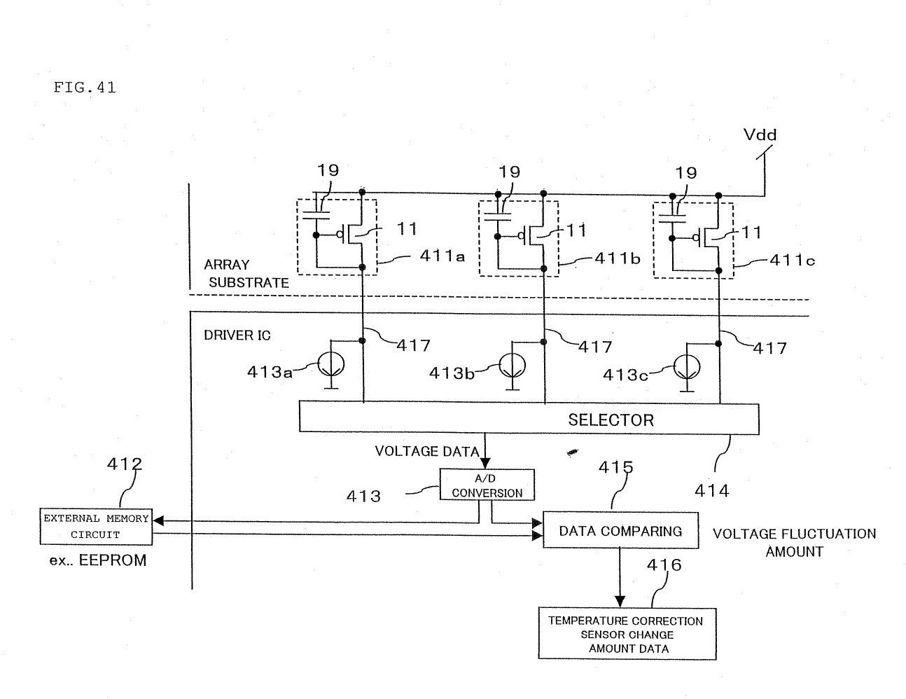

There are the cases where the writing state on applying a program voltage or a program current changes from a panel temperature. Also in this case, the anode voltage Vdd and the like should be changed. The temperature should be detected by a thermistor and a posistor mounted on a backside or an ineffective area (area emitting no effective light for display) of the panel, and the output voltages are AD-converted and used. A temperature detection circuit of FIG. 41 is also used.

Changes or adjustments of the anode voltage Vdd and the cathode voltage Vss are made correspondingly to display luminance of the display screen 22, a writing state of the program current, the duty ratio, lighting rate, external illuminance and the like. It is especially desirable to change the anode voltage Vdd and the like correspondingly to the lighting rate or the duty ratio.

The voltages outputted to the gate signal line 17a by the gate driver circuit 12a are VGH1, VGL1, and the voltages outputted to the gate signal line 17a by the gate driver circuit 12b are VGH2, VGL2. An output c of the AND circuit 81 is set as in FIGS. 10A, 10B.

In FIG. 10A, the outputs of the terminal c are the potentials of the gate signal line 17b, and so they are VGH2, VGL2. Therefore, the inputs of the terminal a of the AND circuit 81 are the potentials of the gate signal line 17a, and so they are VGH1, VGL1. Although the inputs of the terminal b of the AND circuit 81 are VGH2, VGL2 which are the outputs of the gate driver circuit 12b, they are not limited thereto. They may also be the logic signals of the shift register circuit 112b as-is, or the logic signals may be level-converted to the inputs of the terminal b of the AND circuit 81. It is desirable to render VGH1 the same as VGL2. It is because a generation circuit of the supply voltage can thereby be simplified.

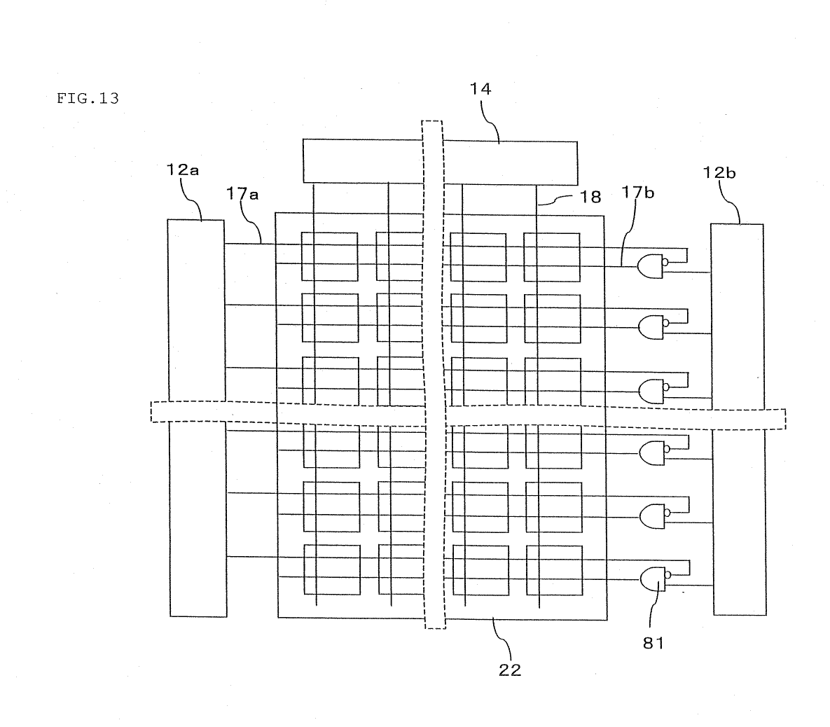

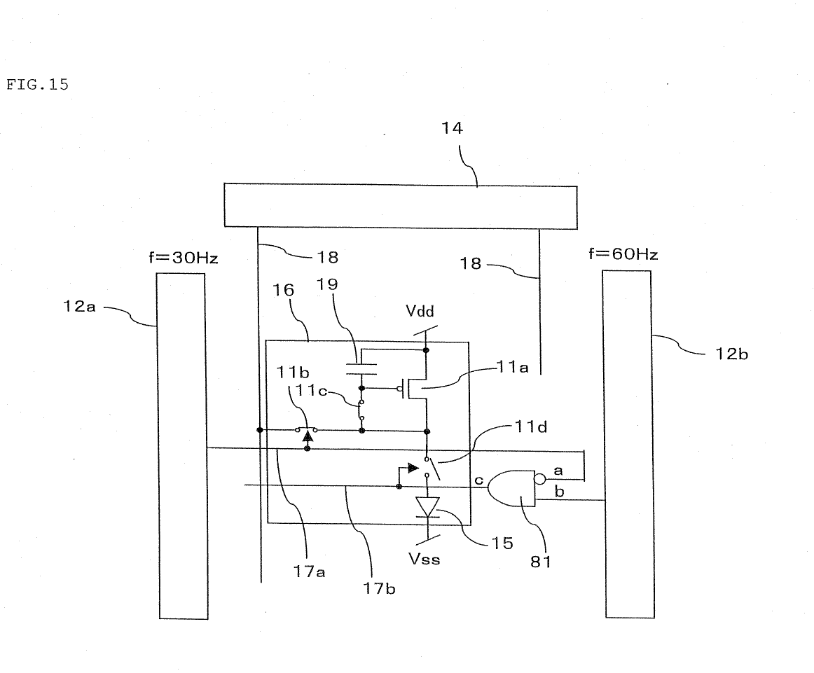

Hereunder, another embodiment will be described. FIG. 13 is another embodiment of the present invention. FIG. 14 is an explanatory diagram of the embodiment of FIG. 13. FIG. 15 is an explanatory diagram for describing the operation of a pixel portion.

FIGS. 13 and 14 are characterized in that the output signal of the gate driver circuit 12a is transmitted to the other end of the display screen 22 by the gate signal line 17a. To be more specific, the gate signal line 17a is exploited as a logic signal line in FIGS. 13, 14. In FIGS. 13, 14, the gate signal line 17a is the input of the AND circuit 81. In the embodiment of FIGS. 13, 14, it is not necessary to form the two shift register circuits 112a, 112b in the gate driver circuit 12b as in the embodiment of FIGS. 8, 12. Therefore, it is possible to narrow the frame of the display panel.

As shown in FIG. 15, the operation of the pixel 16 is the same as FIG. 8. The on/off voltages (VGH, VGL) applied to the gate signal line 17b causes the switch transistor 11d to perform on/off operation. The on/off voltages applied to the gate signal line 17a causes the switch transistors 11b, 11c to perform the on/off operation.

The gate signal line 17a controlled by the gate driver circuit 12a sequentially selects the pixel lines, and the video signal from the source driver IC (circuit) 14 is written to the pixel 16. At the same time, the voltage applied to the gate signal line 17a becomes the logic signal (terminal a) of the AND circuit 81.

In FIG. 14, the AND circuit 81 and the like are placed on the gate driver circuit 12b side. However, the present invention is not limited thereto. The AND circuit 81 and the like may also be placed on the gate driver circuit 12a side. In this case, the output of the gate driver circuit 12b is transmitted to the gate driver circuit 12a side by the gate signal line 17b. FIG. 42 is the embodiment thereof.

The gate signal line 17b controlled by the gate driver circuit 12b sequentially selects the pixel lines to control the lighting of the EL element 15. At the same time, the voltage applied to the gate signal line 17b becomes the logic signal of the terminal a of the AND circuit 81. The gate driver circuit 12a shifts a selected position of the gate signal line 17a in synchronization with the horizontal synchronizing signal (HD). At the same time, the voltage applied to the gate signal line 17a becomes the logic signal (terminal b) of the AND circuit 81. Logic operation is the same as FIGS. 9A, 9B, 10A and 10B.

In the case where the output of the terminal c of the AND circuit 81 is the on-voltage (VGL or VGL1), the video signal from the source driver IC (circuit) 14 is written to the pixel 16. In the case where the gate signal line 17a and the gate signal line 17b select the same pixel 16, the output of the gate signal line 17a becomes ineffective so that neither the pixel 16 nor the pixel line is selected, and the video signal from the source driver circuit 14 will not be written to the pixel 16 or the pixel line.

In the configurations of FIGS. 13 and 14, the output of the shift register circuit 111a of the gate driver circuit 12a or the output of the voltage level shift circuit 112a is the gate signal line 17a, and the input of the terminal a of the AND circuit 81 is the potential of the gate signal line 17a. For that reason, it is not necessary to form the shift register circuit 111a2 in the gate driver circuit 12b as in FIG. 12. As for the potential level, the voltage level is shifted as in FIGS. 9A, 9B, 10A and 10B. The voltage level shift circuit 112 is formed as required.

In FIGS. 12, 14, it has been described that the potential of the gate signal line 17b is decided by the AND circuit 81. However, the AND circuit 81 is merely shown in order to facilitate understanding, and it goes without saying that the potential of the gate signal line 17b may be decided by another method. For instance, it may be composed of an analog switch circuit. The potentials of VGH and VGL are for convenience sake to exemplify and describe the configuration of the pixel 16 of FIG. 1 and the like. The potentials should be decided and potential control should be exerted according to the configuration of the pixel 16.

As for the EL display device of the present invention, the video signal is held by the capacitor 19 of the pixel 16. To be more specific, it is equivalent to holding an image memory of the display area. The image held by the capacitor 19 is displayed by turning on the switch transistor 11d and thereby passing a current through the EL element 15. Therefore, the image display can be realized just by controlling the gate signal line 17b.

If the display screen 22 has the image memory, the operation frame rate can be converted by using the image memory. For instance, if the operation frame rate (cycle) of an input video signal is 60 Hz, the image is written to the capacitor 19 formed like a matrix on the display screen 22 at the operation frame rate of 60 Hz to be held by the capacitor 19. Reading can be performed by operating the gate driver circuit 12b. The reading means to pass a current through the EL element 15 and perform the image display.

The cycle (operation frame rate) for the gate driver circuit 12b to select the gate signal line 17b can be performed independently from that for the gate driver circuit 12a, and so the operation frame rate can be converted. To be more specific, if the operation frame rate (operation cycle) of the gate driver circuit 12b is 75 Hz, the operation of the display area 46 vertically moving on the display screen 22 of FIG. 4B can be performed 75 times a second.

To convert the operation frame rate, a liquid crystal display device and a conventional EL display device require an external semiconductor memory. The liquid crystal display device and the conventional EL display device need to perform readout of the memory at high speed for the sake of converting the operation frame rate. However, the EL display device of the present invention requires no semiconductor memory so that lower cost can be realized.

It is important to select a line of the EL element 15 and set the cycle for emitting light from the line of the EL element 15 at 60 Hz or more. The operation frame rate of the gate driver circuit 12b should desirably have the cycle between 70 Hz and 150 Hz. It should preferably be between 72 Hz and 130 Hz.

The operation frame rate of the gate driver circuit, the operation frame rate (the number of times of selecting arbitrary pixels in a second) of the gate driver circuit 12b should desirably have a value of 1.25 times, 1.5 times, 1.75 times, 2.0 times, 3.0 times or the like of the operation frame rate (the number of times of rewriting the display screen 22 in a second) of the gate driver circuit 12a. When the number of frames of an image (number of times of rewriting in a second) inputted to the EL display device or the operation frame rate of the gate driver circuit 12a is C and a selection cycle (operation frame rate) of the pixel of the gate driver circuit 12b is D, it is any one of D=C×1.00, D=C×1.25, D=C×1.50, D=C×1.75, D=C×2.00, D=C×2.25, D=C×2.50, D=C×2.75, D=C×3.00, D=C×3.25, D=C×3.50, D=C×3.75 and D=C×4.00. To be more specific, it is a multiple of 0.25 between 1.0 and 4.0 times a coefficient of multiplication.

For instance, if the cycle for the gate driver circuit 12a to rewrite the display screen 22 is 60 Hz (60 frames/second), the cycles for the gate driver circuit 12b to select one display screen 22 are 60 Hz, 75 Hz, 90 Hz, 105 Hz, 120 Hz and so on. If the cycle for the gate driver circuit 12a to rewrite the display screen 22 is 50 Hz, the cycles for the gate driver circuit 12b to select one display screen 22 are 50 Hz, 62.5 Hz, 75 Hz, 87.5 Hz, 100 Hz and so on.

The above multiples such as 1.25 times and 1.5 times are not limited only to these values. Even if the multiples are around these values, they are effective because of the circuit configuration. Therefore, if the values are within the range of ±5% to the coefficients of multiplication exemplified above, they are within the technical scope of the present invention. For instance, when the coefficient is 2.0, the value is within the technical scope of the present invention if it is between 1.9 and 2.1.

The above matters relating to the frame rate and the like are applied likewise to the following or other embodiments of the present invention.

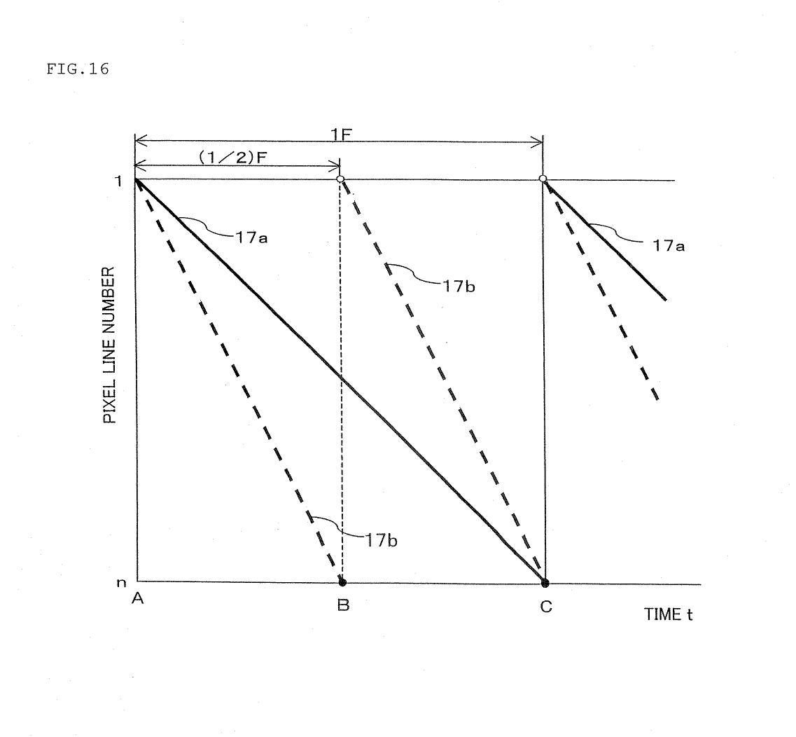

Hereunder, the operation of the driving method of the present invention will be described with reference to FIG. 16. In FIG. 16, the vertical axis indicates pixel line numbers. There are n pixel lines. Therefore, the pixel lines to be selected by the gate driver circuits 12 are the first to n-th pixel lines. The horizontal axis indicates time. The horizontal axis may also be considered as the frames.

To facilitate the description, the selection of pixel lines is started from one pixel line on the top side of the display screen 22. In FIG. 16, the operation frame rate (cycle) of the gate driver circuit 12b is: 60 Hz of the input×2=120 Hz. The pixel configuration will be described by taking the pixel configuration of FIG. 1 as an example.

In FIG. 16, a solid line indicates the operation of the gate driver circuit 12a. To be more specific, it indicates the position of the gate signal line 17a at which the gate driver circuit 12a performs shift operation and outputs the on-voltage (VGL). The gate driver circuit 12a selects the first to n-th pixel lines in one frame (1 F) of 60 Hz. The gate driver circuit 12b operates at 120 Hz. Therefore, the display screen 22 is selected twice in 1 F of the gate driver circuit 12a. To be more specific, it selects the first to n-th pixel lines in (½) F.

The gate driver circuit 12b simultaneously selects multiple pixel lines in duty driving. To facilitate understanding, a dashed line indicates a tip location of the operation of the gate driver circuit 12b in FIG. 16. For instance, in a state in which only one pixel line of the gate signal line 17b is simultaneously selected, the dashed line shown in FIG. 16 is the position of the pixel line where the on-voltage (VGL) is applied to the gate signal line 17b.

In FIG. 16, the pixel lines are selected from A by the gate driver circuits 12. To facilitate the description and understanding, it is presumed that the gate driver circuit 12b selects the first pixel line, and the gate driver circuit 12a selects the first pixel line in the next scanning period. To be more specific, control is started so that the gate signal line 17a selected by the gate signal line 12a will not be the same pixel line as the gate signal line 17b selected by the gate driver circuit 12b.

The gate signal lines 17a are sequentially selected by the gate driver circuit 12a, and the video signal (program current or program voltage) is outputted from the source driver circuit 14 to be written to the selected pixel line. Scanning is completed up to the n-th pixel line (point C) which is the bottom side of the display screen 22 in 1 F, and the selection of the gate signal line 17a is started from the first pixel line on the top side of the display screen 22 again in the next frame.

The gate signal lines 17b are sequentially selected by the gate driver circuit 12b by the gate driver circuit 12b, the on-voltage (VGL) or the off-voltage (VGH) is applied to the gate signal lines 17b, and the applied positions are shifted in synchronization with the lighting control synchronizing signal. As the operation frame rate of the gate driver circuit 12b is 120 Hz, one frame is completed at a point B. This frame period is a (½) F period of the gate driver circuit 12a.

As in FIG. 16, the gate driver circuit 12a and the gate driver circuit 12b operate at different operation frame rates. As the operation frame rate of the gate driver circuit 12b is 120 Hz, the display area 46 of FIG. 4B is vertically scanned on the screen twice in the 1 F period of the gate driver circuit 12a. As the operation frame rate of the gate driver circuit 12b is 120 Hz which is over 70 Hz, no flicker occurs.

In the case where the number of the gate signal lines 17b to which the gate driver circuit 12b simultaneously applies the on-voltage is one, there will arise no problem if start timing of the gate driver circuit 12a and the gate driver circuit 12b is separated by one horizontal scanning period as shown in FIG. 16. To be more specific, the on-voltage will not be simultaneously applied to the gate signal line 17a and the gate signal line 17b in an arbitrary pixel line. In the case where the on-voltage is simultaneously applied to the gate signal line 17a and the gate signal line 17b in an arbitrary pixel 16 or pixel line, the off-voltage is forcibly applied to one of the gate signal line 17a and gate signal line 17b as described in FIGS. 8 to 15.

In most cases, there are multiple gate signal lines 17b selected by the gate driver circuit 12b in the lighting control of the EL display device. In the case of 1/2 duty driving for instance, the on-voltage (VGL) is applied to n/2 gate signal lines 17b. Therefore, the off-voltage (VGH) is applied in a (½) period of one cycle of the gate driver circuit 12b, and the on-voltage (VGL) is applied in a (½) F period.

As shown in FIG. 16, after starting of A, the gate driver circuit 12b inputs data to the shift register circuit 111b to output the off-voltage so as to operate it. In the case of 1/2 duty, after the state of outputting the off-voltage to the n/2 gate signal lines 17b, it is operated to output the on-voltage to the gate signal lines 17b thereafter.

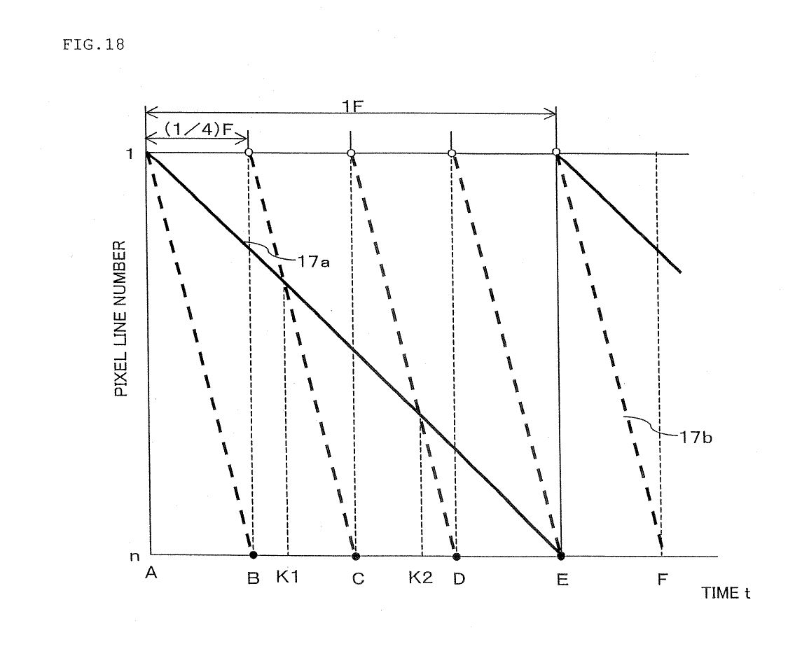

FIG. 18 is an embodiment of (1/4) duty driving. Each of the EL elements 15 has the on-voltage applied thereto in a (¼) period of one cycle, and has the off-voltage applied thereto in a (¾) cycle. Therefore, ¼ of the display screen 22 is in the lighted state, and ¾ is in the non-lighted state.

In the case where the on-voltage is simultaneously applied to the gate signal line 17a and the gate signal line 17b in an arbitrary pixel 16 or pixel line, the off-voltage is forcibly applied to one gate signal line 17 of the pertinent gate signal line 17a and gate signal line 17b as described in FIGS. 8 to 15. To be more specific, when the gate signal line 17a and gate signal line 17b are simultaneously selected in an arbitrary pixel, normal image writing and image display can be realized by forcibly applying the off-voltage to the gate signal line 17b and putting it in a nonselected state.

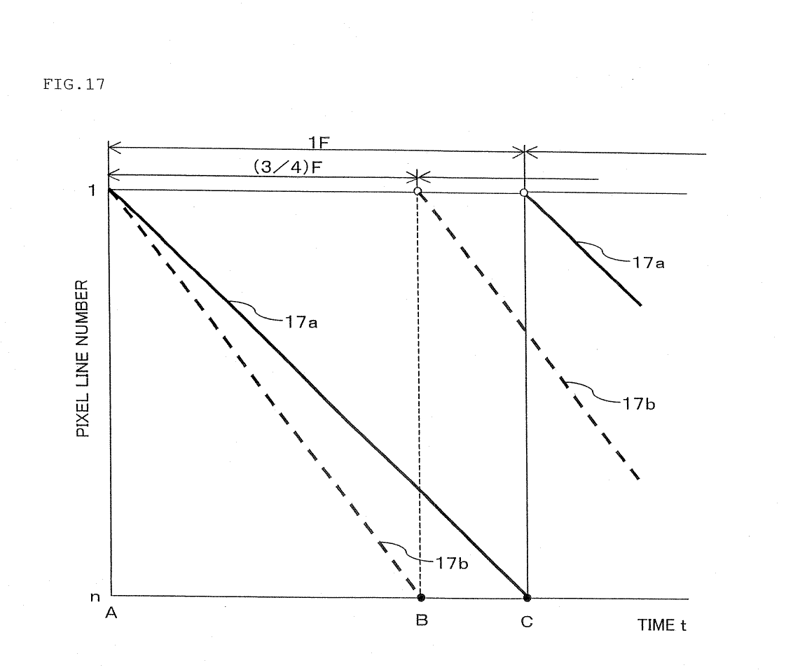

FIG. 17 is an embodiment wherein the operation frame rate of the gate driver circuit 12a is 60 Hz, and the cycle of the operation frame rate of the gate driver circuit 12b is ¾ of the cycle of the operation frame rate of the gate driver circuit 12a. The gate driver circuit 12b selectively scans one screen in a (¾) F period of the gate driver circuit 12a.

FIG. 18 is an embodiment wherein the operation frame rate of the gate driver circuit 12a is 60 Hz, and the cycle of the operation frame rate of the gate driver circuit 12b is ¼ of the cycle of the operation frame rate of the gate driver circuit 12a. The gate driver circuit 12b selectively scans one screen in a (¼) F period of the gate driver circuit 12a.

In the embodiment of FIG. 18, the gate signal line 17a selected by the gate driver circuit 12a and the gate signal lines 17b selected by the gate driver circuit 12b become the same pixel line at K1 and K2 positions. In this case, the gate signal lines 17b selected by the gate driver circuit 12b at the K1 or K2 position are forcibly rendered nonselected as described in FIGS. 8 to 15.

According to the above embodiment, the gate signal lines 17b selected by the gate driver circuit 12b are forcibly rendered nonselected. However, it is not limited thereto, but the gate signal line 17a selected by the gate driver circuit 12a may also be forcibly rendered nonselected. In this case, the program current (or program voltage) from the source driver circuit 14 will not be written to the pertinent pixel lines. However, there is no problem since it will be written to the pixel lines in the next frame cycle.

According to the above embodiment, the gate driver circuit 12a and the gate driver circuit 12b have different operation frame frequencies but maintain synchronization. However, it is not limited thereto, but they may also be asynchronous, provided that the management is necessary so as not to have the same pixel line selected by the gate signal line 17a selected by the gate driver circuit 12a and the gate driver circuit 12b selected by the gate driver circuit 12b. Such management is easy. It is because the controller circuit (not shown) manages and controls the data signals of the gate driver circuits 12a and 12b.

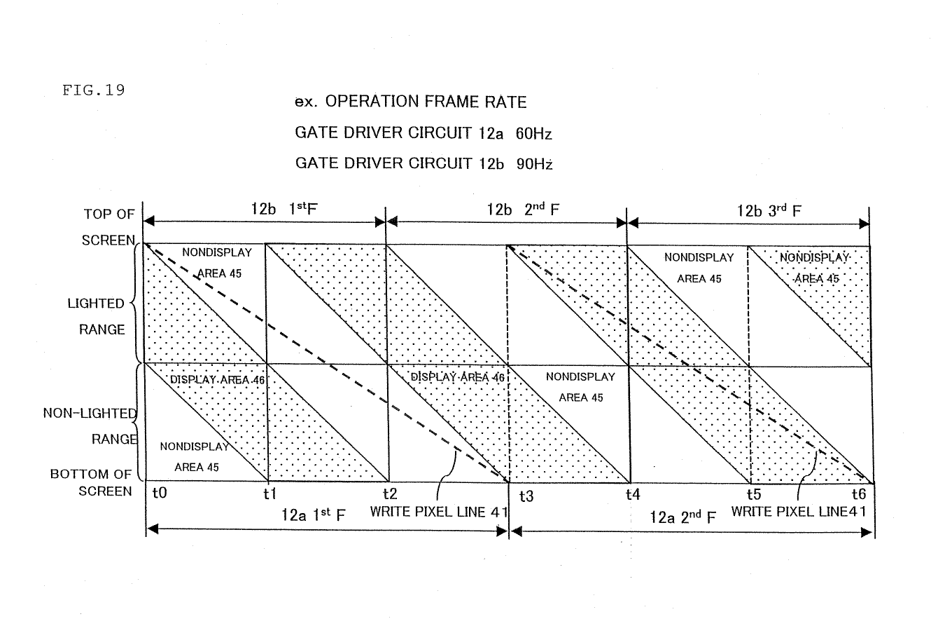

FIG. 19 is an example in which the operation frame rate of the gate driver circuit 12a is 60 Hz (operation frame rate of the video signal is 60 Hz (60 images per second)) and the operation frame rate of the gate driver circuit 12b is 90 Hz (scanning the nondisplay area 45 downward from the top of the screen 90 times per second). Therefore, the gate driver circuit 12b scans the screen three times in the period for rewriting the image of the display screen 22 twice. On the top side of the drawing, a first frame (first F), a second frame (second F) and a third frame (third F) are described as the frames of the gate driver circuit 12b. On the down side of the drawing, the first frame (first F) and second frame (second F) are described as the frames of the gate driver circuit 12a. The duty ratio of the driving method is 1/2 as an example.

The vertical axis of FIG. 19 indicates distribution of the lighted areas (display areas 46) and the non-lighted areas (nondisplay areas 45). At t0 for instance, an upper half of the display screen 22 is the display area 46 (the image is displayed), and a lower half is in the nondisplay area 45 (no image is displayed) state. The selected position of the gate signal line 17b of the gate driver circuit 12b moves over time so that the upper half of the display screen 22 is the nondisplay area 45 (no image is displayed) and the lower half is in the display area 46 (the image is displayed) state at t1. After t1, the display areas 46 are sequentially generated from the top side of the display screen 22, and the lower half is sequentially put in the nondisplay area 45 state.

In FIG. 19, the dashed lines indicate the positions of the gate signal lines 17a selected by the gate driver circuit 12a. To be more specific, they are the positions of “write pixel lines 41” for writing the video signals.

The present invention performs a process for applying a nonselective voltage (off-voltage) to the gate signal line 17b of the gate driver circuit 12b when the pixel line for writing the video signal (pixel line having the on-voltage applied to the gate signal lines 17a selected by the gate driver circuit 12a) matches with the pixel line having the selective voltage (on-voltage) applied to the gate signal line 17b of the gate driver circuit 12b. Therefore, if the dashed line of a write pixel line 61 enters the range of the display areas 46, the process described earlier is performed. To be more specific, either the gate signal line 17b selected by the gate driver circuit 12b is forcibly rendered nonselected or the gate signal line 17a selected by the gate driver circuit 12a is forcibly rendered nonselected.

In the embodiment of FIG. 19, the positions of the write pixel lines 61 (indicated by the dashed lines) are all within the ranges of the nondisplay areas 45 in the first F of the gate driver circuit 12b. Therefore, the pixel line for writing the video signal (pixel line having the on-voltage applied to the gate signal lines 17a selected by the gate driver circuit 12a) does not match with the pixel line having the selective voltage (on-voltage) applied to the gate signal line 17b of the gate driver circuit 12b.

In the second F range of the gate driver circuit 12b, the positions of the write pixel lines 61 (indicated by the dashed lines) are within the ranges of the display area 46 in the period of t3 to t4. Therefore, the pixel line for writing the video signal (pixel line having the on-voltage applied to the gate signal lines 17a selected by the gate driver circuit 12a) matches with the pixel line having the selective voltage (on-voltage) applied to the gate signal line 17b of the gate driver circuit 12b. Therefore, it is necessary to perform the process for applying the nonselective voltage (off-voltage) to the gate signal line 17b of the gate driver circuit 12b. Or else, it is necessary to perform the process for applying the nonselective voltage (off-voltage) to the gate signal line 17a of the gate driver circuit 12a.

In the range of t4 to t6 which is the third F of the gate driver circuit 12b, the positions of the write pixel lines 61 (indicated by the dashed lines) are all within the ranges of the display areas 46. Therefore, the pixel line for writing the video signal (pixel line having the on-voltage applied to the gate signal line 17a selected by the gate driver circuit 12a) matches with the pixel line having the selective voltage (on-voltage) applied to the gate signal line 17b of the gate driver circuit 12b. Therefore, it is necessary to perform the process for applying the nonselective voltage (off-voltage) to the gate signal line 17b of the gate driver circuit 12b. Or else, it is necessary to perform the process for applying the nonselective voltage (off-voltage) to the gate signal line 17a of the gate driver circuit 12a.

Similarly, in the fourth F range of the gate driver circuit 12b, the position of the write pixel line 61 (indicated by the dashed line) is within the range of nondisplay area 45 in the first half. However, it is in the range of the display area 46 in the second half. To be more specific, in the second half, the pixel line for writing the video signal (pixel line having the on-voltage applied to the gate signal line 17a selected by the gate driver circuit 12a) matches with the pixel line having the selective voltage (on-voltage) applied to the gate signal line 17b of the gate driver circuit 12b. Therefore, it is necessary to perform the process for applying the nonselective voltage (off-voltage) to the gate signal line 17b of the gate driver circuit 12b. Or else, it is necessary to perform the process for applying the nonselective voltage (off-voltage) to the gate signal line 17a of the gate driver circuit 12a.

If the frame frequency of the gate driver circuit 12b is heightened, the flicker is less likely to occur. If it is rendered too high, however, the moving image visibility is reduced. In the case of a still image, the flicker is easy to see and so it is necessary to heighten the operation frame rate of the gate driver circuit 12b. Inversely, as for the moving image, the flicker is not so noticeable because the image display is constantly changing. For that reason, the moving image visibility is improved by lowering the operation frame rate.

In view of the above matter, the present invention changes the operation frame rate of the gate driver circuit 12b as to the moving image and the still image.

It has been described that one of the gate signal lines 17a and 17b is put in the nonselected state. However, the present invention is not limited thereto. It goes without saying that both of them may be controlled to be in the nonselected state. Therefore, in the case of the configuration having multiple gate signal lines, it should be possible to control the selected or nonselected state of at least one gate signal line.

The present invention interrupts a current pathway for flowing from the driving transistor 11a to the EL element 15 in the pixel line for writing the video signal. Or an exclusion process is performed so as not to write the video signal to the pixel line in which the current pathway for flowing from the driving transistor 11a to the EL element 15 is generated. It may be any configuration capable of satisfying this operation. The exclusion process is also realizable by time-dividing one horizontal scanning period. For instance, one horizontal scanning period may be divided into ½ so as to exert control by the gate signal line 17a in the first ½ period and exert control by the gate signal line 17b in the second ½ period.

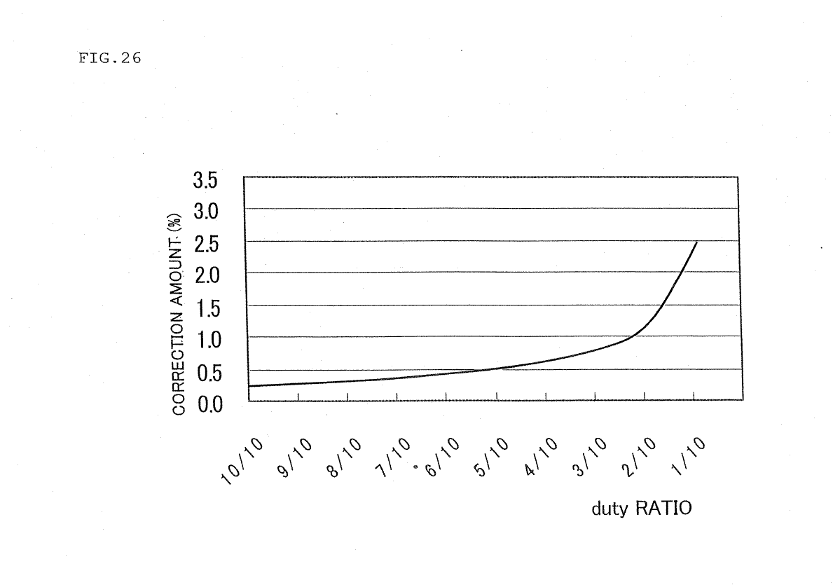

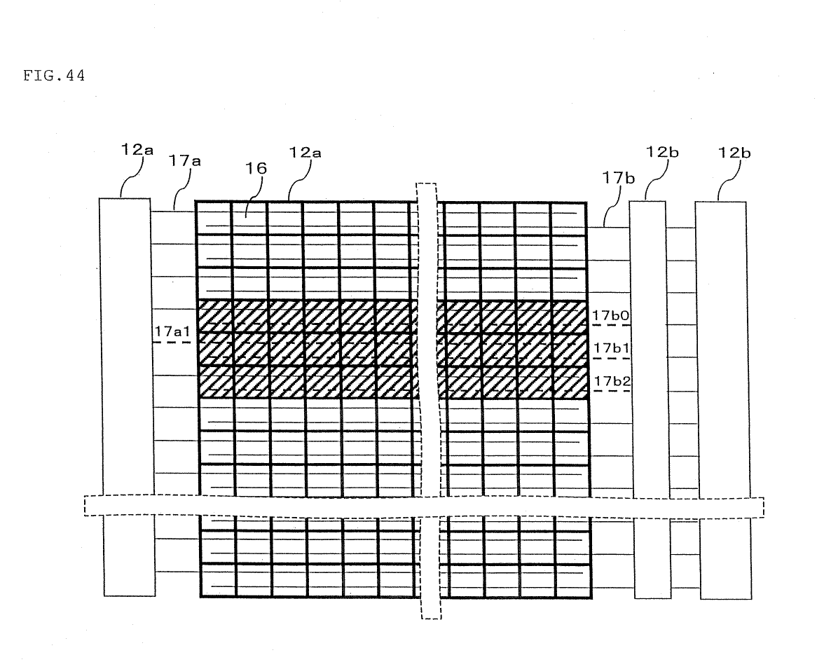

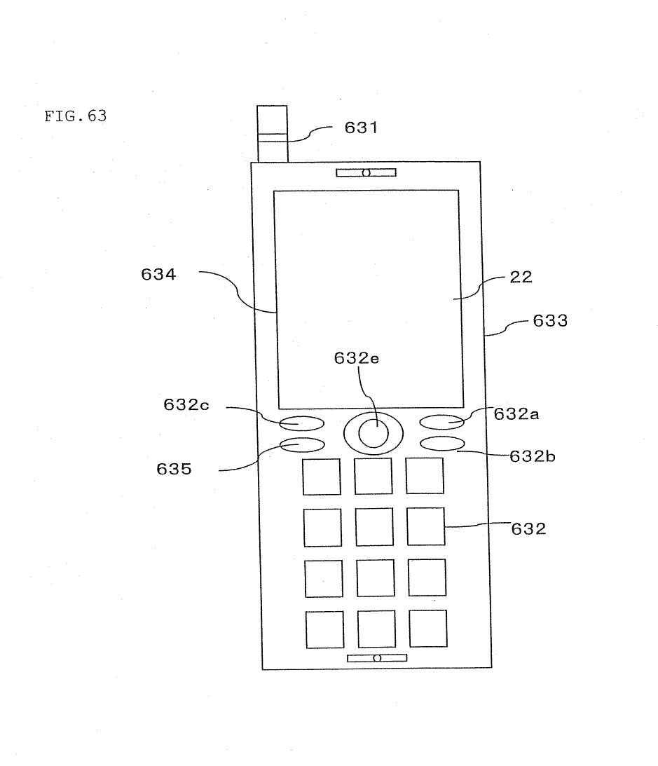

It goes without saying that the present invention described above is applicable to the embodiment of FIG. 42. It goes without saying that it is also applicable to and combinable with the matters relating to a correction method of a correction amount of FIGS. 26 to 40 described below. It goes without saying that it is also applicable to and combinable with temperature correction of FIG. 41. It goes without saying that it is also applicable to and combinable with the driving method of FIGS. 44 to 47A, FIG. 47B and FIGS. 49 to 62. Furthermore, it goes without saying that the above embodiment is also applicable to the display device of the present invention shown in FIGS. 63 to 65.

The above embodiment has been described by taking the pixel configuration of FIG. 1 as an example. However, the present invention is not limited to the pixel configuration of FIG. 1. It is applicable to any pixel configuration which includes the switch transistor 11 for turning on and off (supplying and interrupting) the current pathway for flowing from the driving transistor 11a to the EL element 15 and the switch transistor 11 for applying the video signal to the driving transistor 11.

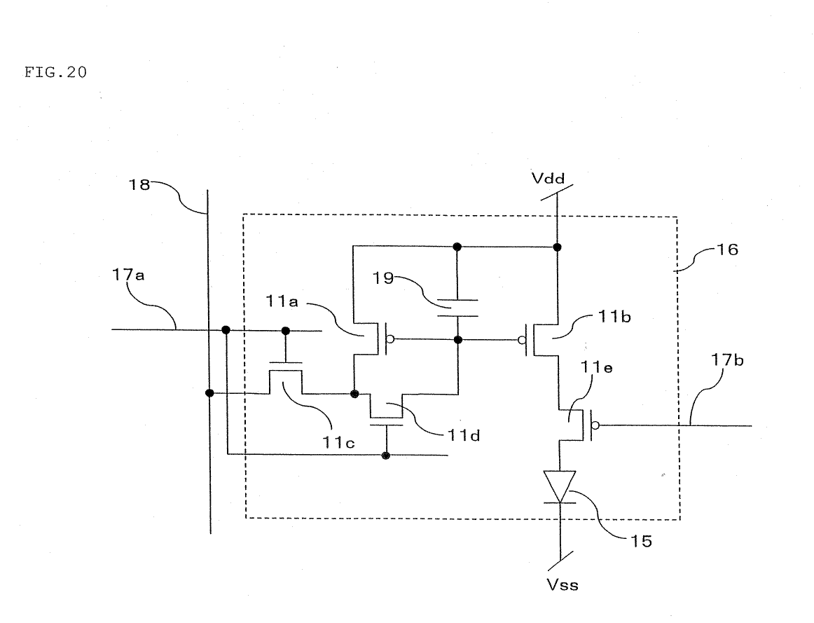

For instance, a current mirror pixel configuration of FIG. 20 has a switch transistor 11e formed in the current pathway to the EL element 15, and includes the switch transistor 11c for generating a path for applying the video signal to the driving transistor 11a or 11b. In the case where the on-voltage (VGL) is applied to the gate signal line 17a and the gate signal line 17b of the same pixel 16, the off-voltage is applied to one of the gate signal lines 17 (17a, 17b) and the switch transistor 11e or 11c is opened.

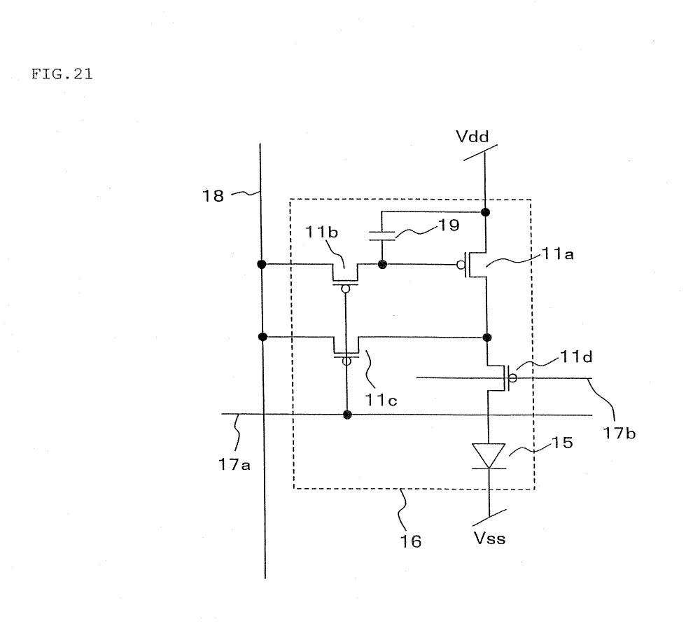

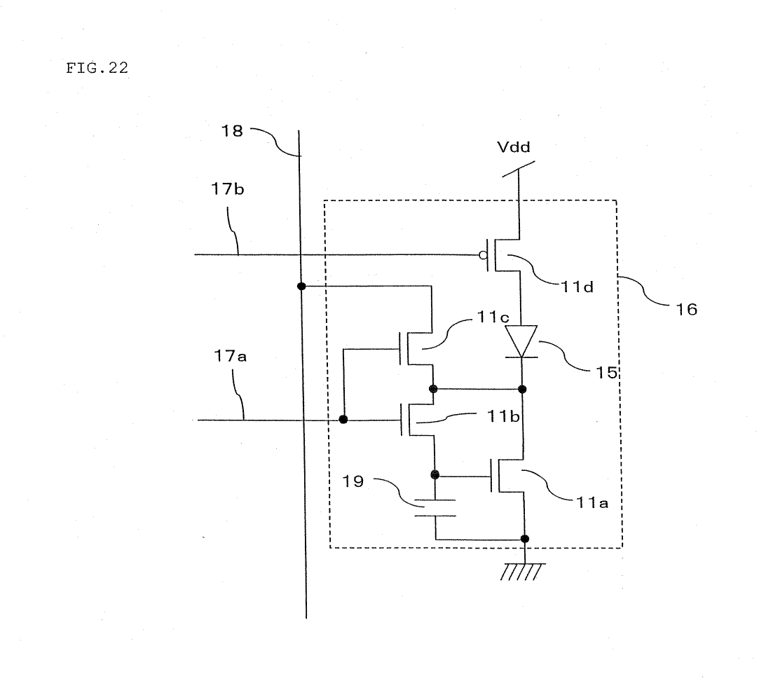

The present invention is also applicable to the pixel configurations of FIGS. 21, 22. In FIGS. 21, 22, the switch transistor 11d is formed in the current pathway to the EL element 15, and the switch transistor 11c is included, which generates a path for applying the video signal to the driving transistor 11a. In the case where the on-voltage (VGL) is applied to the gate signal line 17a and the gate signal line 17b of the same pixel 16, the off-voltage is applied to one of the gate signal lines 17 (17a, 17b) and the switch transistor 11d or 11c is opened.

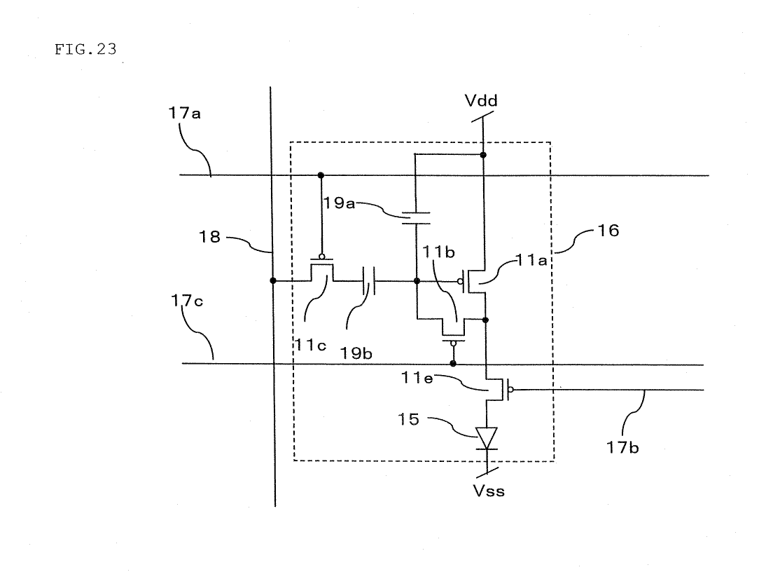

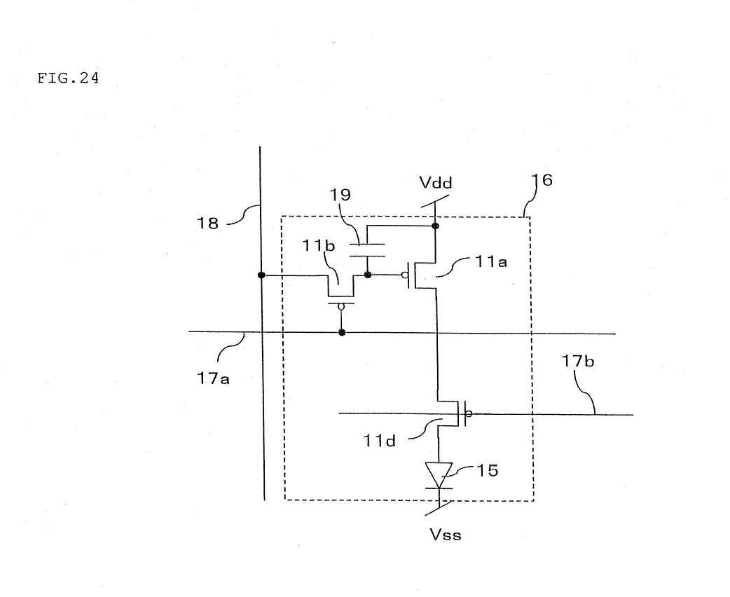

FIGS. 1, 20, 21, 22 are the pixel configurations of a current program method. The present invention is also applicable to the pixel configurations of a voltage program method shown in FIGS. 23, 24.

In FIG. 23, a capacitor 19b is formed between the gate terminal of the driving transistor 11a and the switch transistor 11c. The video signal applied to a source signal line 18 is applied to the gate terminal of the driving transistor 11a via the capacitor 19b by turning on the switch transistor 11c.

The pixel configuration of FIG. 23 has the switch transistor 11e formed in the current pathway to the EL element 15, and includes the switch transistor 11c for generating a path for applying the video signal to the driving transistor 11a. In the case where the on-voltage (VGL) is applied to the gate signal line 17a and the gate signal line 17b of the same pixel 16, the off-voltage is applied to one of the gate signal lines 17 (17a, 17b) and the switch transistor 11e or 11c is opened.

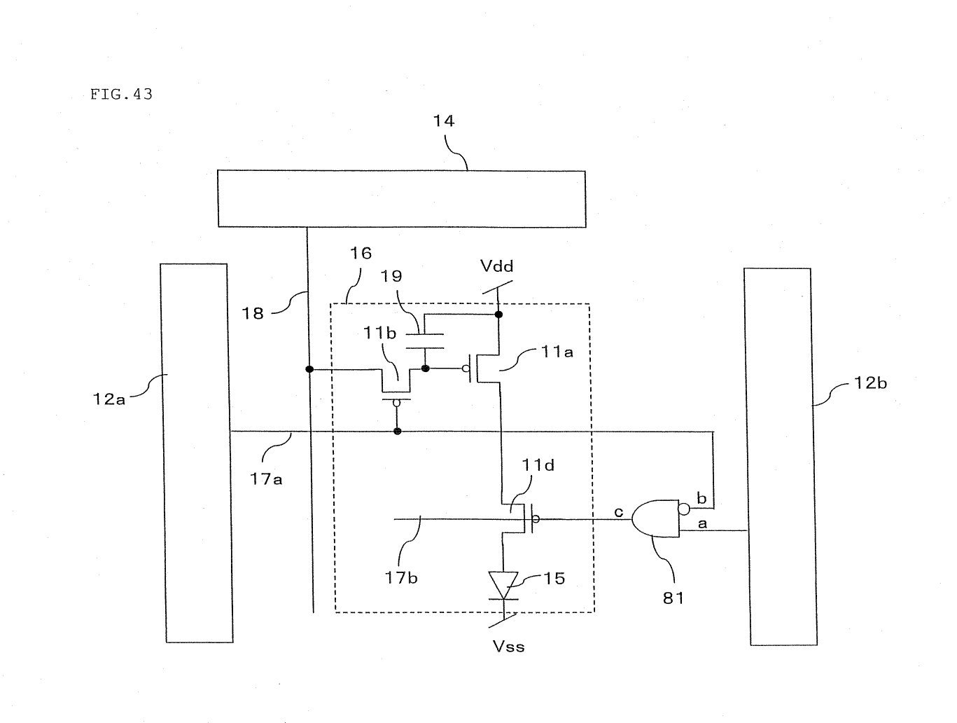

The pixel configuration of FIG. 24 has the switch transistor 11d formed in the current pathway to the EL element 15, and includes the switch transistor 11b for generating a path for applying the video signal to the driving transistor 11a. FIG. 43 shows a configuration in which the configuration of the AND circuit 81 is applied to the pixel configuration of FIG. 24. In the case where the on-voltage (VGL) is applied to the gate signal line 17a and the gate signal line 17b of the same pixel 16, the off-voltage is applied to one of the gate signal lines 17 (17a, 17b) and the switch transistor 11d or 11b is opened.

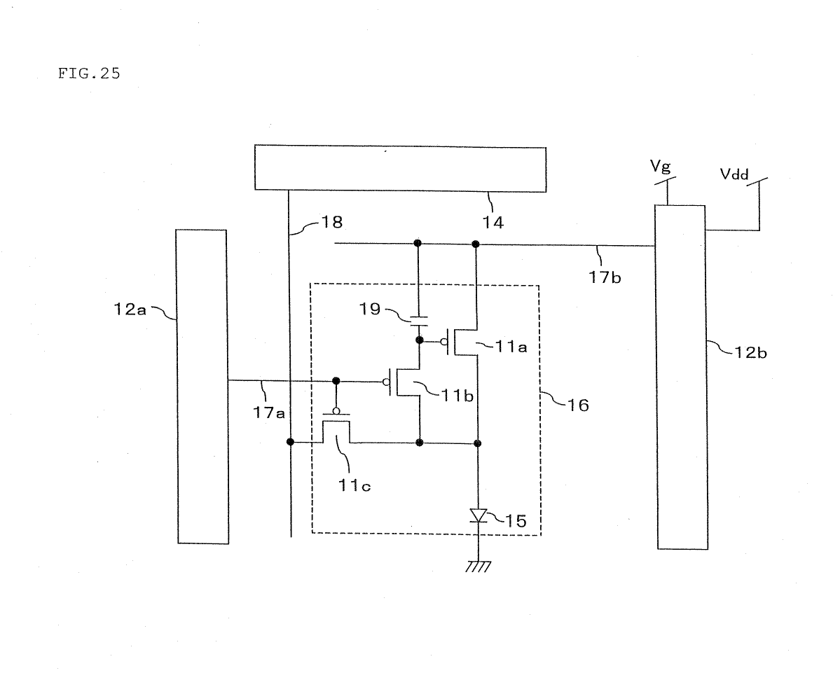

The above embodiment has the configuration in which the switch transistors 11 are formed in the current pathway to the EL element 15. However, the present invention is not limited thereto. The present invention is also applicable to the pixel configuration of FIG. 25.

In FIG. 25, the switch transistors 11 are not formed in the current pathway for supplying to the EL element 15. Instead, the gate signal line 17b is an anode terminal. The gate signal line 17 is connected to the gate driver circuit 12b, where the supply voltage of the gate driver circuit 12b is the anode voltage Vdd. If the gate signal line 17b is selected, the anode voltage Vdd is supplied to the gate signal line 17b from the gate driver circuit 12b. Therefore, the pixel line can be on/off-controlled by selection of the gate signal line 17b. In the case where the on-voltage (VGL) is applied to the gate signal line 17a and the gate signal line 17b of the same pixel 16, the off-voltage is applied to one of the gate signal lines 17 (17a, 17b) and the switch transistor 11e or 11c is opened.

It goes without saying that the above pixel configurations of FIGS. 20 to 25 are also applicable to the embodiments of FIGS. 8 to 19 and FIG. 42. It goes without saying that it is also applicable to and combinable with the matters relating to the correction method of a correction amount of FIGS. 26 to 40 described below. It goes without saying that it is also applicable to and combinable with the temperature correction of FIG. 41. It goes without saying that it is also applicable to and combinable with the driving method of FIGS. 44 to 47A, FIG. 47B and FIGS. 49 to 62. Furthermore, it goes without saying that the above embodiment is also applicable to the display device of the present invention shown in FIGS. 63 to 65.

According to the driving method of the present invention in FIGS. 8 to 15, the gate signal line 17b of the pixel line to be lighted is forcibly put in the off state. In this case, a light-emitting period of the pixel line is shorter than that of the other pixel lines. Therefore, the luminance of the pixel line lowers. A method of correcting the lowering of the luminance will be described.

First, a method of generating the video signal will be described. FIG. 27 is an explanatory diagram of a program current generating circuit constituting the source driver circuit 14. The source driver circuit 14 includes reference current circuits 273 (273R, 273G and 273B) corresponding to red (R), green (G) and blue (B). A reference current circuit 273 is composed of a resistance R1 (R1r, R1g and R1b), an operational amplifier 271a and a transistor 274a. The values of the resistances R1 (R1r, R1g and R1b) can be independently set or adjusted correspondingly to gradation currents of R, G and B. The resistances R1 are external resistances placed outside the source driver circuit 14.

A voltage Vi is applied to a plus terminal c of the operational amplifier by an electron volume 272. The voltage Vi can be acquired by dividing a stable reference voltage Vb by resistances R. The electron volume 272 changes the output voltage Vi by a signal IDATA. A reference current Ic is (Vs−Vi)/R1. Reference currents Ic (Icr, Icg and Icb) of RGB are adjusted or varied by the reference current circuits 273 which are independent respectively. The variance is made by the electron volumes formed for each of the RGB. Therefore, the value of the voltage Vi outputted from the electron volume 272 changes according to the control signal applied to the electron volume 272. The size of the reference currents of RGB is changed by the voltage Vi, and the size of the gradation currents (program currents) Iw outputted from a terminal 276 changes in proportion.

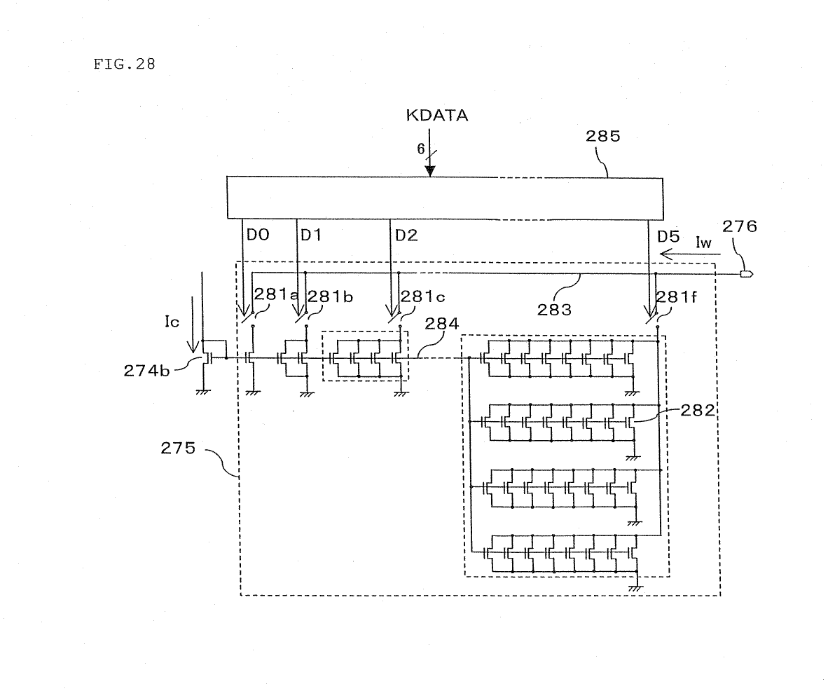

The generated reference currents Ic (Icr, Icg and Icb) are applied to a transistor 274b from the transistor 274a. The transistor 274b and a transistor group 275 constitute a current mirror circuit. In FIG. 27, a transistor 274b1 is shown as if it is composed of one transistor. In reality, however, it is formed as a collection of unit transistors 282 (transistor group) as with the transistor group 275. The unit transistors 282 are shown in FIG. 28 described later.

The program currents Iw from the transistor group 275 are outputted from the output terminal 276. The gate terminal of each unit transistor 282 of the transistor group 275 is connected with the gate terminal of the transistor 274b by a gate wiring 284.

As shown in FIG. 28, the transistor group 275 is constituted as a collection of the unit transistors 282. To facilitate understanding, a description will be given on condition that the video data and the program currents are converted in a proportional or correlative relation. A switch 281 is selected by the video signal, and the program currents Iw as a collection (addition) of output currents of the unit transistors 282 are generated by the selection of the switch 281. Therefore, the video signal can be converted to the program currents Iw. The present invention is configured so that a unitary current of the unit transistors 282 is equivalent to the size of a piece of the video data.

The unitary current is the size of one unit of the program currents which is outputted by the unit transistors 282 correspondingly to the size of the reference current Ic. If the reference current Ic changes, the unitary current outputted by the unit transistors 282 also changes in proportion. It is because the current mirror circuit is constituted by the transistor 274b and the unit transistors 282.

Each of the transistor groups 275 of RGB is composed of a collection of the unit transistors 282, and the size of the output current (unit program current) of the unit transistors 282 is adjustable by the size of the reference current Ic. It is possible, by adjusting the size of the reference current Ic, to change or vary the size of the program currents (constant currents) Iw of each gradation for each of the RGB. Therefore, in an ideal state in which the characteristics of the unit transistors 282 of the RGB are the same, it is possible to strike a white balance of a display image of the EL display device by changing the size of the reference current Ic of the reference current circuits 273 of the RGB.

Hereunder, a description will be given on condition that the transistor groups 275 of the source driver circuit 14 are 6 bits to facilitate understanding and drawing figures. In FIG. 28, the unit transistors 282 are placed at each of constant current data (D0 to D5). One unit transistor 282 is placed at the D0 bit. Two unit transistors 282 are placed at the D1 bit. Four unit transistors 282 are placed at the D2 bit, eight unit transistors 282 are placed at the D3 bit, and sixteen unit transistors 282 are placed at the D4 bit. Similarly, thirty-two unit transistors 282 are placed at the D5 bit.

It is realized by the on/off control with the analog switches 281 (281a to 281f) as to whether or not the output currents of the unit transistors 282 of each individual bit are outputted to the output terminal 276. A decoder circuit 285 decodes inputted video data KDATA. The analog switches are on/off controlled correspondingly to the video signal data KDATA.

The program currents Iw pass through an internal wiring 283. The potential of the internal wiring 283 becomes the potential of the source signal line 18. The potential of the internal wiring 283 is Vcc or less and a GND potential or more. When the constant currents Iw are applied to the source signal line 18 and reaches a steady state, the potential of the source signal line 18 is the voltage of the gate terminal on the driving transistor 11a of the pixel 16 (in the case of the pixel configuration of FIG. 1).

FIG. 29 is an explanatory diagram of a gradation voltage output circuit of the voltage program method. The lowest potential generated by the gradation voltage output circuit is 0 V (GND potential), and the highest potential is the supply voltage Vcc of the source driver circuit 14. A low potential of the gamma curve is regulated by a gradation amplifier 292L. A high potential of the gamma curve is regulated by a gradation amplifier 292H. The voltage outputted by the gradation amplifier 292H is referred to as VH. The voltage outputted by the gradation amplifier 292L is referred to as VL. Therefore, amplitude width is VH−VL.

The output voltage of the gradation amplifiers 292 is controlled by an amplitude adjustment register 291. Output bits of the amplitude adjustment register 291 are 8 bits. Therefore, the gradation amplifiers 292 allow output changes in 256 stages. The amplitude value of the gamma curve is increased by increasing the value of the gradation amplifier 292H (high potential). The amplitude value of the gamma curve is decreased by reducing the value of the gradation amplifier 292H (low potential). The amplitude value of the gamma curve is reduced by increasing the value of the gradation amplifier 292L (high potential). The amplitude value of the gamma curve is increased by reducing the value of the gradation amplifier 292L (low potential). In the configuration of FIG. 29, it is also possible to separately operate the gradation amplifier 292H and the gradation amplifier 292L.

The resistances are connected like a ladder between the gradation amplifier 292H and the gradation amplifier 292L. Wiring terminals 293 are drawn out among the respective resistances (VR1, VR2, VR3, VR4 to VRN). The wiring terminals 293 are connected to selector circuits of a voltage DAC circuit of FIG. 30.

Resistance values of the resistances (VR1, VR2, VR3, VR4 to VRN) of the resistance ladder are variable by command setting. The resistance values of the resistances (VR1, VR2, VR3, VR4 to VRN) are changed by the command setting.

As shown in FIG. 30, the video signal data KDATA is held by a voltage data latch circuit 301a. Each piece of data is 6 bits. A pixel row is 240 dots, where each of the dots has three pieces of data of RGB. Therefore, line memories of a voltage data latch A circuit and a voltage data latch B circuit are 6 bits×240 RGB. The data of the voltage data latch A circuit 301a is copied on the voltage data latch B circuit 301b in synchronization with a horizontal synchronizing signal (HD).

A voltage DAC circuit 302 is composed of a switch circuit. It selects one out of the terminals 293 of a gradation voltage output circuit 302 from digital data of the voltage data latch B circuit 301b. The voltage of the selected terminal 293 is outputted to the source signal line 18.

In the case where the operation frame rates of the gate driver circuit 12a and the gate driver circuit 12b are different, the on-voltage (VGL) may be applied to the gate signal line 17a and the gate signal line 17b connected to the same pixel 16.

The source driver circuit 14 has both the output circuit of the program current in FIGS. 27, 28 and the output circuit of the program voltage in FIGS. 29, 30 configured therein. While the program current method causes a lack of writing of the video signals in a low gradation area, the program voltage method can realize good writing of the video signals even in the low gradation area. However, the program voltage method is not complete as to correction of a variation characteristic of the driving transistor 11a. The program current method is good as to the correction of the variation characteristic of the driving transistor 11a.

It is possible to configure both the output circuit of the program current and output circuit of the program voltage in the source driver circuit 14 and operate them so as to compensate for faults of the program current method and faults of the program voltage method and realize good image display. The present invention adopts the driving method of applying the program voltage to each of the pixels in the first half of the period for selecting one pixel line and applying the program current in the second half of the period as against an applied video signal. To be more specific, it applies the program current after applying the program voltage. The program voltage is not applied in the case where a corresponding video signal is of a high gradation. It is because a target gradation signal can be sufficiently written by the program current. As for the pixel configuration, it adopts the configuration capable of taking out the current outputted by the driving transistor 11a to the source signal line 18 as in FIG. 1. In the case of the pixel configuration of FIG. 23, the current pathway is not cut by the capacitor 19b. As for the pixel configuration, the configurations of FIG. 15, FIG. 42 and FIGS. 20 to 25 can be adopted other than FIG. 1.

If both the output circuit of the program current and output circuit of the program voltage are configured in the source driver circuit 14, it is possible, unlike the above, to apply it to the driving method of applying the constant current to each of the pixels in the first half of the period for selecting one pixel line and applying the program voltage in the second half of the period as against the applied video signal. An operating point of the driving transistor 11a is reset (an offset position is acquired) by applying the constant current. Next, the program voltage is applied to the pixel. As for the pixel configuration, a configuration combining FIG. 1 with FIG. 23 or the like is used.

If both the output circuit of the program current and output circuit of the program voltage are configured in the source driver circuit 14, it becomes easier to modulate the amplitude or the size of the video signal by the reference current in any of the above cases. It is also easy to realize a white balance adjustment and a duty driving method. The process of the correction amount to be described in FIG. 26 and the like is also easy.

The present invention is the method of changing the on-voltage applied to the gate signal line 17b to the off-voltage in the case where the gate signal line 17a and the gate signal line 17b are selecting the same pixel 16. To be more specific, it is a method of exclusively processing (disabling) the gate signal line 17b.

The present invention also includes in its technical scope an embodiment for changing the on-voltage applied to the gate signal line 17a to the off-voltage in the case where the gate signal line 17a and the gate signal line 17b are selecting the same pixel 16. To be more specific, it is a method of exclusively processing (disabling) the gate signal line 17a. In this case, the video signal is not written to the pixel line. The pixel line is not rewritten and the next frame also has the same image display. However, there is no adverse effect in the case of the still image. In the case of the moving image, it is not visually recognized because a normal video signal is written in the frame after the next. In this case, the pixel line is selected by the gate signal line 17b, and the EL element 15 of the pixel line emits light. Therefore, the emission luminance of the EL element 15 is not reduced so that there is no need of correction. To be more specific, it is not necessary to correct the correction amount.

If the gate signal line 17b is forcibly rendered nonselected, the EL element 15 of the pixel line which should originally be lighted becomes unlighted. For that reason, the pixel line which has remained unlighted becomes less bright. Under normal conditions, however, the duty ratio is controlled to be 1/4 or more. Therefore, each of the pixel lines is lighted for over a ¼ period in one frame. In the case where there are 240 pixel lines for instance, each of the pixel lines is lighted 240/4=60 times. If it is not lighted once therein, it is 1/60=1.7% so that the luminance of the pixel is reduced by less than 2%. Therefore, it is not visually recognized.

The video signal written to each pixel 16 is corrected by the correction amount (correction data). In the case where a pixel having data of a gradation K for emitting light written thereto became nonselected and could not emit light, the portion which could not emit light is corrected. If the time when it could not emit light is 1/240 of one frame, this period is corrected. As for the correction, if the time when it could not emit light is 1/240 of one frame, the time for emitting light is extended (added) by 1/240 in the next frame or the like. Extension is easily realizable by manipulating the duty ratio. It is also realizable by stopping the shift of the gate driver circuit 12b for the time for selecting one pixel line at the pixel line location. The video signal written to the pixel to correct decreasing luminance in advance is enlarged. And the video signal written to the pixel in the next frame or the like is enlarged just by an equivalent of the decrease. The correction amount (correction data) is realizable by time manipulation in the case of duty ratio control, and is realizable by a multiplication circuit or by adding a certain correction value to the video signal in the case of manipulating the size of the video signal to be written to the pixel line.

Therefore, there are the cases where the correction amount (correction data) is an amount of time (time data) and also the cases where it is a multiplier coefficient for correcting the video signal. There are the cases where it is an amount to be added or added data. The correction amount (correction data) corrects the emission luminance or an emission volume of the reduced pixels.

In the case where the duty ratio is large, such as 3/4, there is high probability that the gate signal line 17a and the gate signal line 17b select the same pixel line. In this case, however, the period in which each pixel line is lighted in one frame is long, and reduction in the luminance is little even if the pixel line is controlled in the non-lighted state so that it will not be visually recognized.

In the case where the operation frame rate of the gate driver circuit 12b is higher than the operation frame rate of the gate driver circuit 12a by three times or more, there is higher probability that the gate signal line 17a and the gate signal line 17b select the same pixel 16. While the operation frame rate of the gate driver circuit 12a is regulated by the number of frames per second of the video signal, the operation frame rate of the gate driver circuit 12b can be set rather freely.

Therefore, it is possible, by changing the operation frame rate of the gate driver circuit 12b, to vary the position at which the gate signal line 17a and the gate signal line 17b select the same pixel 16. It is also possible to reduce the probability that the gate signal line 17a and the gate signal line 17b select the same pixel 16. It is also easy to randomize the position at which the gate signal line 17a and the gate signal line 17b select the same pixel 16.

As described above, the present invention is also characterized by changing or being able to change the operation frame rate of the gate driver circuit 12b which controls the lighting of the pixel 16.

With the gate signal line 17a and the gate signal line 17b simultaneously selected, the luminance of the pixel line is reduced, where it is easy to light the pixel one extra time in the next frame. Inversely, it is also possible to have balance by lighting no other pixel line once and reducing the luminance. It is because the controller circuit (not shown) can grasp which pixel line has the gate signal line 17a and the gate signal line 17b simultaneously selected.

As the gate signal line 17a and the gate signal line 17b are simultaneously selected, the luminance of the pixel line is reduced. As a countermeasure against this, it is possible to write the video signal to the pixel line by adding an equivalent of the reduction in the luminance to the size of the video signal. When the duty ratio is 1/4 and there are 200 pixel lines, the pixel line is lighted for 200/4=50 horizontal scanning periods. As it is put in the non-lighted state once in the 50 horizontal scanning periods, an equivalent of 1/50=2% is written to the pixel line to add an equivalent of 2% of the video signal. Or else, the video signal to be written is enlarged by multiplication. In the case of 256 gradations, an equivalent of 4 gradations is added to the original video signal, which is then written to the pixel line. In the case where the original video signal has 253 or more gradations, it is not possible, even by adding 4 gradations, to apply more than 256 gradations at the maximum. In a high gradation area, however, human luminous efficiency to display luminance is low. Therefore, it is not problematic to correct 253 or more gradations to 256 gradations. Inversely, the number of gradations of the video signal to be written may be subtracted in the pixel lines other than the subject pixel line.

In the case where the video data is current data as in the configurations of FIGS. 27, 28, the reference current Ic corresponding to the correction is changed. The reference current Ic is easily realizable by changing the current data IDATA to the electron volume 272. It is because the voltage Vi is changed by IDATA to allow change in the reference current Ic. As for the amounts of change of the reference currents (Icr, Icg and Icb) of red (R), green (G) and blue (B), they are changed correspondingly to the duty ratio. The correction amounts may be a common ratio among the R, G and B.

It is also possible to manipulate the KDATA of FIG. 28 and compensate for the correction amounts in the case where the gate signal line 17a and the gate signal line 17b select the same pixel 16. In particular, a current output stage of FIG. 28 has an output current decided by the number of the unit transistors 282. Therefore, gradation data is in proportion to the number of the unit transistors 282. The correction amount is in proportion to the duty ratio. Therefore, the correction amount can be approximated by the number of the unit transistors 282.

In the case of the voltage program method of FIGS. 29, 30, the correction amount can be realized by changing the gradation amplifiers 292. It can also be realized by changing the resistances VR1 to VRN. As a matter of course, it can also be handled by correcting the video signal data KDATA of FIG. 30.

As for the correction using the circuits of FIGS. 27 to 30, the reference current, gradation amplifiers 292, resistance values and video signal data KDATA are changed correspondingly to the pixel line to be corrected. To be more specific, the change is made in synchronization with the horizontal synchronizing signal (HD).

In the case of correcting the video signal data KDATA, when the duty ratio is 1/D and the number of pixel lines on the display screen 22 of the EL display device is N, the ratio of 1/(N/D) is added if the gradation to be added is 1. To be more specific, it is desirable to perform multiplication or addition by a constant rate to the size of the applied video signal. For instance, when the duty ratio is 1/4 and the number of pixel lines on the display screen 22 of the EL display device is 200, it is: 1/(200/4)=1/50=2%.

The aforementioned correction of the number of gradations is simply performed in one frame period of the gate driver circuit 12b. In reality, however, one frame period is different between the gate driver circuit 12a and the gate driver circuit 12b so that the number of gradations or the ratio for performing addition and subtraction are decided by taking the cycle of the gate driver circuit 12a into consideration.

In particular, the present invention controls the brightness of the display screen 22 by the duty ratio. The brightness of the display screen 22 is linearly proportional to the number of lighted pixel lines. Therefore, even if one pixel line is forcibly rendered nonselected by the AND circuit 81, just an equivalent of one pixel line should be corrected. The correction is easy because of the linear relation.

The correction of the correction amount is performed in the frame in which a situation to be corrected has occurred or the frames thereafter. In the case where the situation to be corrected is known in advance (a change in the duty ratio is normally known in advance), the correction amount may be applied to the pixel line before the frame in which the situation to be corrected occurs.

The correction amount may be corrected over multiple frame periods. In the case where the correction amount of 2% is necessary for instance, it is possible to correct an equivalent of 1% in the first frame, correct an equivalent of 0.5% in the following second frame and further correct an equivalent of 0.5% in the following third frame. The correction amount may also be changed correspondingly to the lighting rate or the duty ratio.

FIG. 26 shows the correction amount (%) against the duty ratio. FIG. 26 shows the case where the number of pixel lines is 300. The larger the duty ratio is, the smaller the correction amount becomes. And the smaller the duty ratio is, the larger the correction amount becomes. It is sufficient if accuracy of the correction amount is within the range of ±30%. If the correction amount is 2% for instance, tolerance is 1.4% to 2.6%.

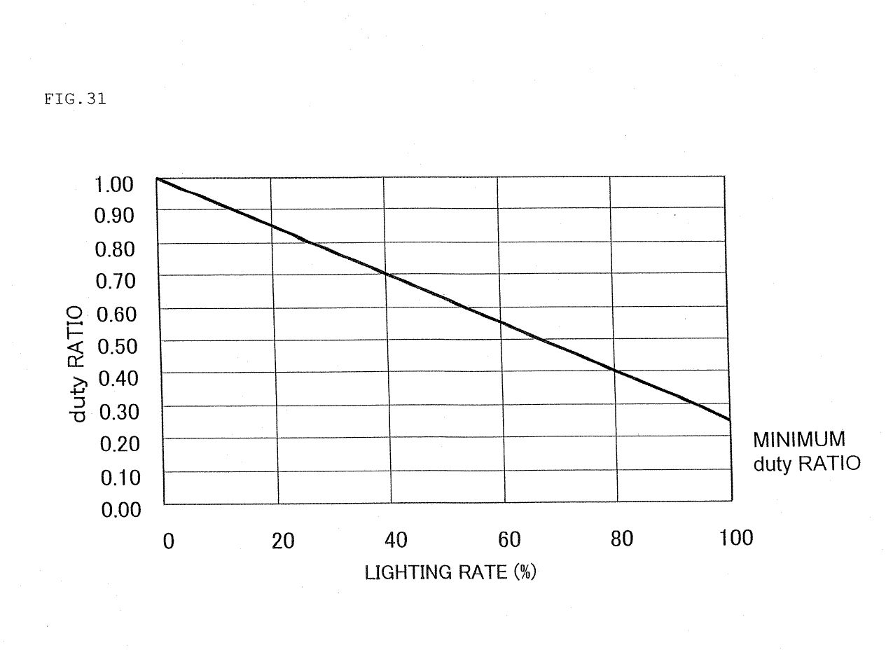

According to the present invention, the duty ratio changes correspondingly to the lighting rate (%) as shown in FIG. 31. The lighting rate can be acquired from the video signal inputted to the EL display device. Or else, the lighting rate can be acquired by measuring the current passing through the anode terminal or the cathode terminal of the EL display device.

Therefore, the lighting rate and the duty ratio change according to the display image displayed on the display screen 22. The lighting rate and the duty ratio are not changed in real time but are changed with certain delay or hysteresis. Therefore, the correction amount is also changed with certain delay. It is desirable to acquire the lighting rate and the duty ratio in consideration of an image changing state over multiple frame periods.

It is effective to vary the correction amount according to the external environment illuminance of the EL display device. The external environment illuminance is measured by the photosensor added to the EL display device. When the external environment illuminance is high, the correction amount may be omitted. It is because, even if the correction is performed, its effects are not noticeable. When the external environment illuminance is low, human senses are keen to the change of the correction amount. Therefore, it is necessary to perform an accurate correction.

Although the horizontal axis of FIG. 26 is the duty ratio, it may be replaced by the lighting rate. The higher the lighting rate is, the smaller the duty ratio becomes. And the lower the lighting rate is, the larger the duty ratio becomes. The lighting rate correlates with the electric power or the current consumed on the display screen 22 of the EL display device. Therefore, the correction amount is acquired from the electric power or the current consumed on the display screen 22 of the EL display device. The relation between the lighting rate and the duty ratio is acquired from FIG. 31 as an example. FIG. 31 is either acquired in advance or acquired in real time by calculation.

As described above, the present invention is characterized by correcting the pixel line to which the off-voltage is forcibly applied. The correction amount to be corrected is acquired from the lighting rate, duty ratio and power consumption of the display screen 22.

If the duty ratio changes, there is also a change in a pixel line position where the on-voltage (VGL) is applied to both the gate signal line 17a and gate signal line 17b. Therefore, the present invention can be described as a driving method of changing the pixel line for forcibly applying the off-voltage (VGH) to one of the gate signal line 17a and gate signal line 17b correspondingly to the duty ratio. The duty ratio may be replaced by the lighting rate. The lighting rate correlates with the electric power or the current consumed on the display screen 22 of the EL display device. Therefore, the present invention can be described as a driving method of changing the pixel line for forcibly applying the off-voltage (VGH) to one of the gate signal line 17a and gate signal line 17b correspondingly to the lighting rate, or the electric power or the current consumed on the display screen 22 of the EL display device.

It goes without saying that the above matters are also applicable to the other embodiments of the present invention.

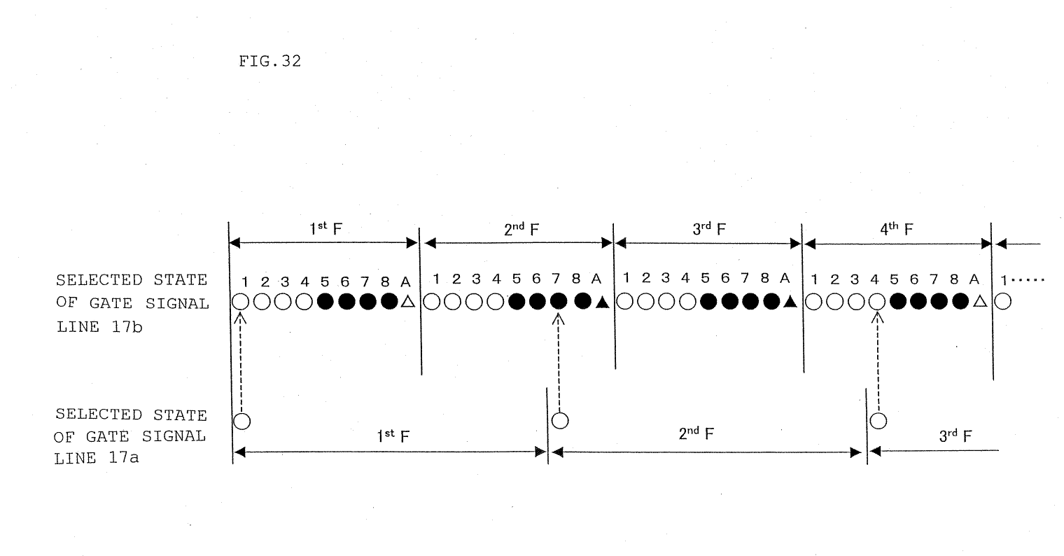

As shown in FIG. 32, a countermeasure can be taken by exerting control as to the problem that simultaneous selection of the gate signal lines 17a and 17b puts the pixel line in the non-lighted state and causes the luminance of the display screen 22 to be reduced.

FIG. 32 shows the selected state of the gate signal lines 17a and 17b in each individual frame (F). In the selected state of the gate signal line 17b in FIG. 32, a white circle indicates that the on-voltage is outputted to the gate signal line 17b. A black circle indicates that the off-voltage is outputted to the gate signal line 17b. The black circles and white circles may be considered as an arrangement of data pulses of the shift register circuit 112b. The positions of the white circles and black circles in the selected state of the gate signal line 17b in FIG. 32 move in synchronization with a clock frequency of the gate driver circuit 12b.

In the selected state of the gate signal line 17a in FIG. 32, the white circle indicates the selected position of the gate signal line 17a of the gate driver circuit 12a. The other gate signal lines 17a have the off-voltage applied thereto. To facilitate the description, the selected position of the gate signal line 17a is the first pixel line. The positions of the white circles in the selected state of the gate signal line 17a in FIG. 32 move in synchronization with a clock frequency of the gate driver circuit 12a (horizontal scanning period of the video signal).

In the selected state of the gate signal line 17b in FIG. 32, the duty ratio is 1/2 with four black circles and four white circles in order to facilitate drawing the figure. Therefore, the number of the black circles and white circles added together is eight pieces. Furthermore, a triangular mark is included so that nine clocks make up one frame of the gate driver circuit 12b.

The triangular mark is the data to be inserted into a blanking period. As a matter of course, the triangular marks are also sequentially shifted according to the synchronizing signal of the gate driver circuit 12b to perform pixel line selection and the like. A white triangular mark has the same function as the white circle (applying the on-voltage to the gate signal line 17b), and a black triangular mark has the same function as the black circle (applying the off-voltage to the gate signal line 17b).

It is presumed that one frame period of the gate driver circuit 12a in the selected state of the gate signal line 17a in FIG. 32 is longer than one frame period of the gate driver circuit 12b. As shown in the selected state of the gate signal line 17a in FIG. 32, one frame period of the gate driver circuit 12a is: 8+1+6=15 of the gate driver circuit 12b.

In FIG. 32, the selected position of the gate signal line 17a of the gate driver circuit 12a matches with the selected position of the gate driver circuit 12b in the first frame (1^{st} F) of the gate driver circuit 12a. For this reason, the switch transistor 11d for the pixel line is controlled in the open state and the pixel line is rendered unlighted. For this reason, the non-lighted state occurs in the first frame (1^{st} F) of the gate driver circuit 12a so that the luminance of one frame period of the gate driver circuit 12b is reduced. To correct this, the selection data is inserted into the blanking period in the first frame (1^{st} F) of the gate driver circuit 12b. The inserted data is indicated by the white triangular mark of A.

Also in FIG. 32, the selected position of the gate signal line 17a of the gate driver circuit 12a does not match with the selected position of the gate driver circuit 12b in the second frame (2^{nd} F) of the gate driver circuit 12a. In reality, the gate driver circuit 12a and the gate driver circuit 12b are data-shifted by different clocks, and so there is a possibility that they may match. To facilitate the description, however, it is presumed that the selected position of the gate signal line 17a of the gate driver circuit 12a does not match with the selected position of the gate driver circuit 12b in the second frame (2^{nd} F) of the gate driver circuit 12a in FIG. 32. For this reason, no non-lighted state is forcibly generated in the second frame (2^{nd} F) of the gate driver circuit 12a. Therefore, non-selection data is inserted into the blanking period in the second frame (2^{nd} F) and third frame (3^{rd} F) of the gate driver circuit 12b. The inserted data is indicated by the black triangular mark of A.

Also in FIG. 32, the selected position of the gate signal line 17a of the gate driver circuit 12a matches with the selected position of the gate driver circuit 12b in the third frame (3^{rd} F) of the gate driver circuit 12a. The fourth frame (4^{th} F) of the gate driver circuit 12b falls under this. For this reason, the switch transistor 11d of the pixel line is controlled in the open state and the pixel line is rendered unlighted. For this reason, the non-lighted state occurs so that the luminance of one frame period of the gate driver circuit 12b is reduced. To correct this, the selection data is inserted into the blanking period in the fourth frame (4^{th} F) of the gate driver circuit 12b. The inserted data is indicated by the white triangular mark of A.

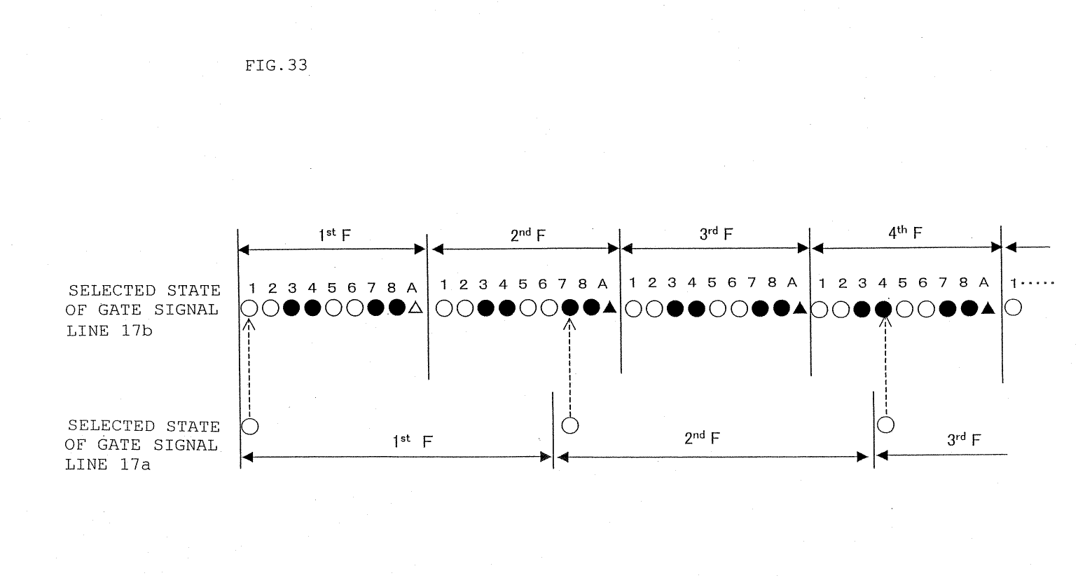

FIG. 32 showed the method wherein a data arrangement to be inserted into the gate driver circuit 12b has selections (white circle marks) and non-selections (black circle marks) in a row respectively. However, the present invention is not limited thereto. The selections (white circle marks) and non-selections (black circle marks) may be dispersed as shown in FIG. 33.

Also in FIG. 33, in the case where the selected position of the gate signal line 17a of the gate driver circuit 12a matches with the selected position of the gate driver circuit 12b, the selection (white triangular mark) is inserted into the position of A. In the frame in which the selected position of the gate signal line 17a of the gate driver circuit 12a does not match with the selected position of the gate driver circuit 12b, the selection (black triangular mark) is inserted into the position of A.

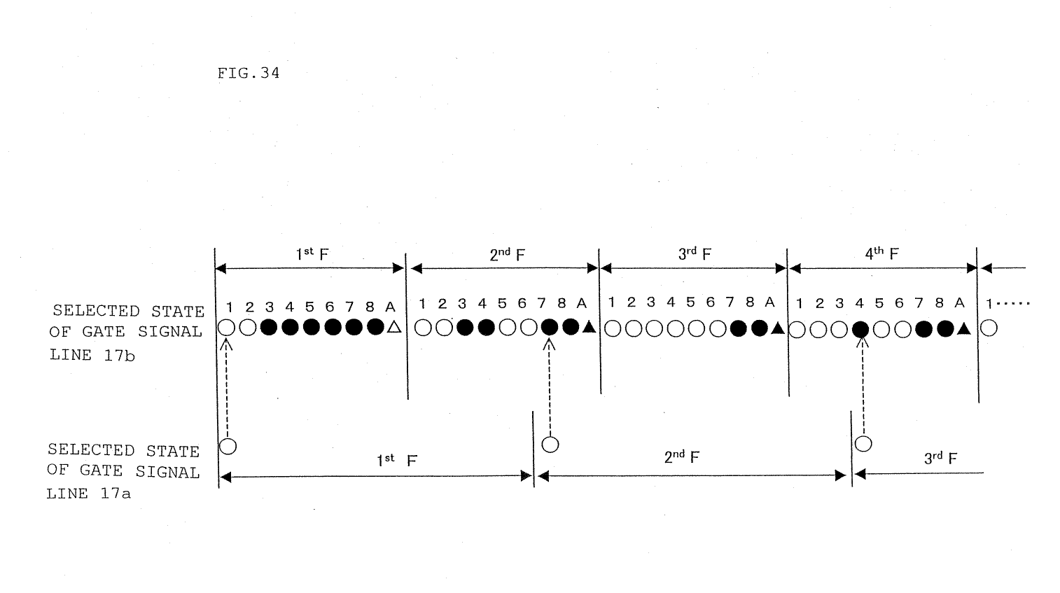

Furthermore, the selections (white circle marks) and non-selections (black circle marks) may be random as shown in FIG. 34. However, the duty ratio of one frame period should coincide among the frames.

Also in FIG. 34, in the case where the selected position of the gate signal line 17a of the gate driver circuit 12a matches with the selected position of the gate driver circuit 12b, the selection (white triangular mark) is inserted into the position of A. In the frame in which the selected position of the gate signal line 17a of the gate driver circuit 12a does not match with the selected position of the gate driver circuit 12b, the selection (black triangular mark) is inserted into the position of A.

According to the present invention, if the duty ratio is constant, a sequence of the selection data and non-selection data of the gate driver circuit 12b may be changed as in FIG. 34. The sequence can be freely set if the moving image visibility is not a problem. It is possible, by setting the arrangement of the selection data and non-selection data, to set the gate signal line 17a selected by the gate driver circuit 12a and the gate signal line 17b selected by the gate driver circuit 12b so that they will not become the same pixel line or easily coincide.

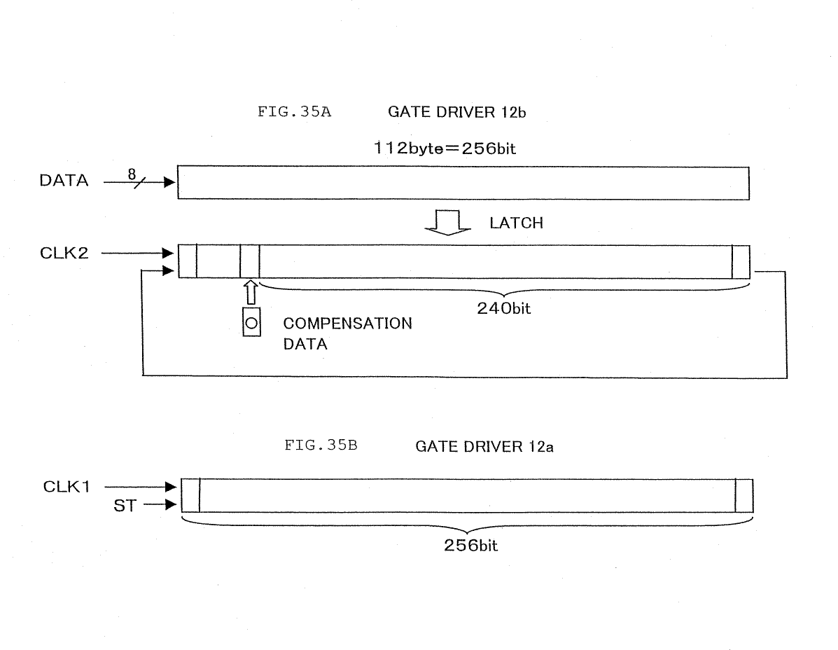

As for the moving image visibility, even when one frame is the data arrangement with no moving image visibility as in FIG. 34, it is not a problem if the other frames are the data arrangement with good moving image visibility as in FIG. 33. The data to be inserted into the position A of FIGS. 32 to 34 is derived by the controller circuit (not shown) for controlling the gate driver circuits 12. FIGS. 35A, 35B show the operation and the configuration.

As for FIGS. 35A, 35B, FIG. 35A describes the method of generating the data arrangement to be applied to the gate driver circuit 12b.

In FIG. 35A, the data arrangement of 32 bytes is prepared. To be more specific, it is an arrangement of 32×8 bits=256 bits. This arrangement (referred to as a data arrangement b) is set by inputting DATA by an 8-bit bus from outside. It is possible to arbitrarily set the data arrangement of selection and non-selection by inputting DATA. The non-selection and selection data can be continued as in FIG. 32. The non-selection and selection data can also be randomized as in FIG. 34.

FIG. 35B shows a data arrangement (referred to as a data arrangement a) to be applied to the shift register circuit 112a of the gate driver circuit 12b.

The data arrangement b performs a bit shift with a shift clock (CLK2) of the gate driver circuit 12b, and the data arrangement a performs a bit shift with a shift clock (CLK1) of the gate driver circuit 12a. The bit shifts of the data arrangement a and the data arrangement b are performed by the controller circuit. If the selected positions coincide, the selection data (white circle mark) is set to the correction data, which is inputted to the data arrangement b. In the case where the selected positions do not coincide within one frame of the gate driver circuit 12b, the non-selection data (black circle mark) is set to the correction data, which is inputted to the data arrangement b.

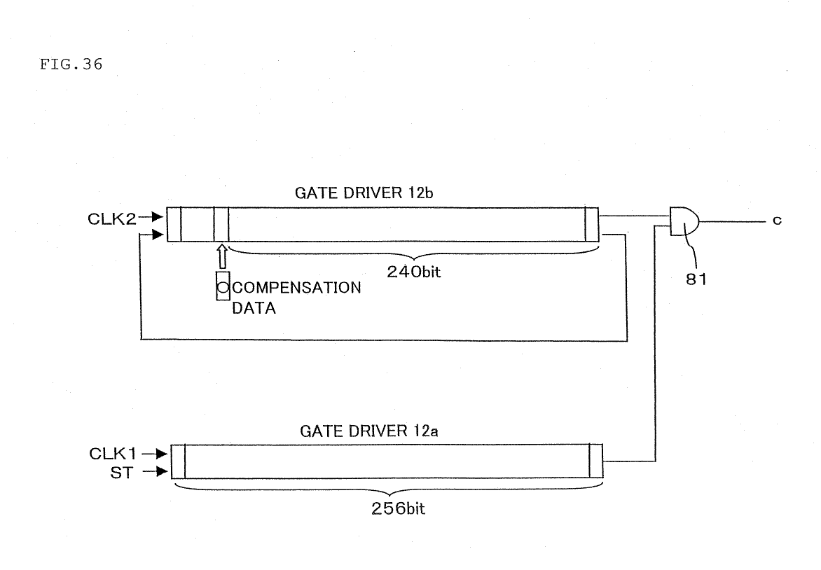

As for a determination of whether or not the selected positions coincide, the AND circuit 81 should be placed on an output stage of the data arrangement a and the data arrangement b as shown in FIG. 36.

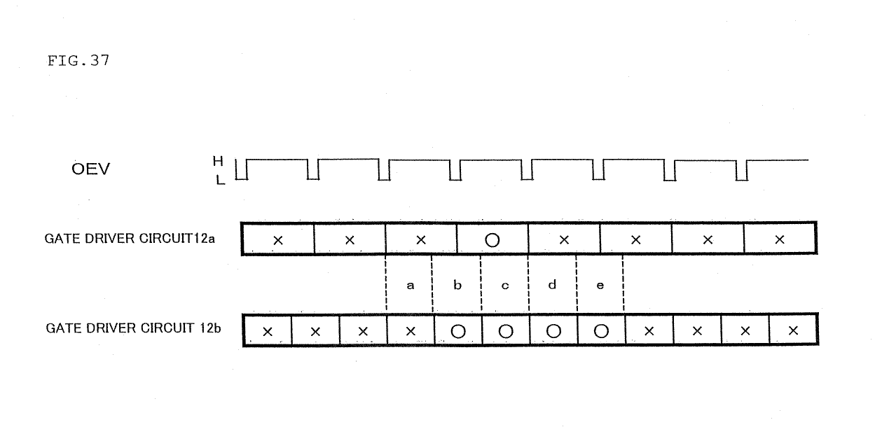

The clock (CLK1) of the gate driver circuit 12a is different from the clock (CLK2) of the gate driver circuit 12b. However, it is not limited only to being different. The clock (CLK1) of the gate driver circuit 12a may also match with the clock (CLK2) of the gate driver circuit 12b. Therefore, as shown in FIG. 37, the period in which the gate driver circuit 12a shifts is different from the period in which the gate driver circuit 12b shifts. In FIG. 37, one frame indicates the period and timing in which the gate driver circuits 12 perform one data shift.

As shown in FIG. 37, in the case where the first timing of a coincides between the gate driver circuit 12a and the gate driver circuit 12b for instance, the first timing does not coincide between the gate driver circuit 12a and the gate driver circuit 12b except for the first timing of a period d out of a, b, c, d and e. In the timing that does not coincide, the period when the gate driver circuit 12a selects the gate signal line 17a gets mixed with the period when the gate driver circuit 12b selects the gate signal line 17b so that a potential state of the pixel 16 undergoes a sudden change. Concerning this problem, the outputs of all the gate signal lines 17a are controlled in an off-output state in the period when the shift register circuit 112a changes due to the data shift.

The on-voltage or the off-voltage is outputted to the gate signal line 17a according to the data contents of the shift register 112a at the logic level of the OEV signal in FIG. 37. When the OEV is at the L level, the off-voltage is outputted to the gate signal line 17a. To be more specific, the gate signal line 17a becomes nonselected. When the OEV signal is at the H level, the inputted signal is passed through. To be more specific, in the case where the input signal is the on-voltage (VGL) when the OEV signal is at the H level, the on-voltage (VGL) is outputted to the gate signal lines 17. In the case where the input signal is the off-voltage (VGH), the off-voltage (VGH) is outputted to the gate signal lines 17. As in FIG. 37, the OEV signal is turned to L and the gate signal lines 17 are rendered nonselected (applying the off-voltage (VGH)) on changing the state from selecting the first gate signal line 17 to selecting the following second gate signal line 17. It is thereby possible to write a normal video signal to the pixel, which effective. The OEV signal will be described in detail later.

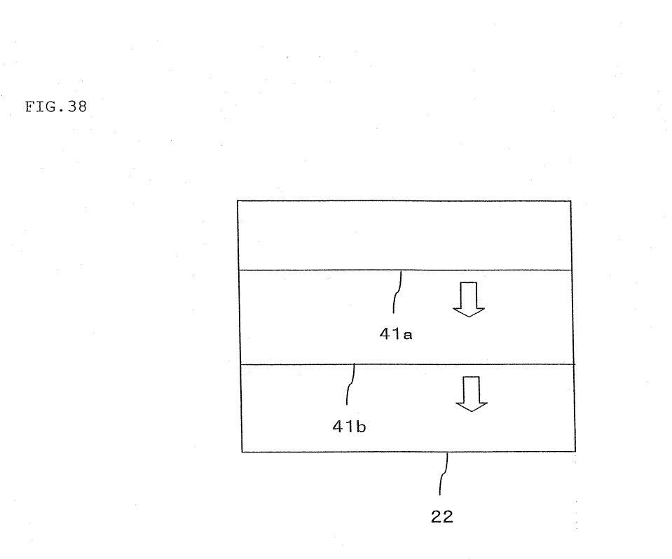

According to the above embodiment, there is one gate signal line 17a to which the gate driver circuit 12a outputs the selection voltage (on-voltage). However, the present invention is not limited thereto. As shown in FIG. 38 for instance, there may also be two gate signal lines 17a (write pixel lines 41a, 41b) selected by the gate driver circuit 12a.

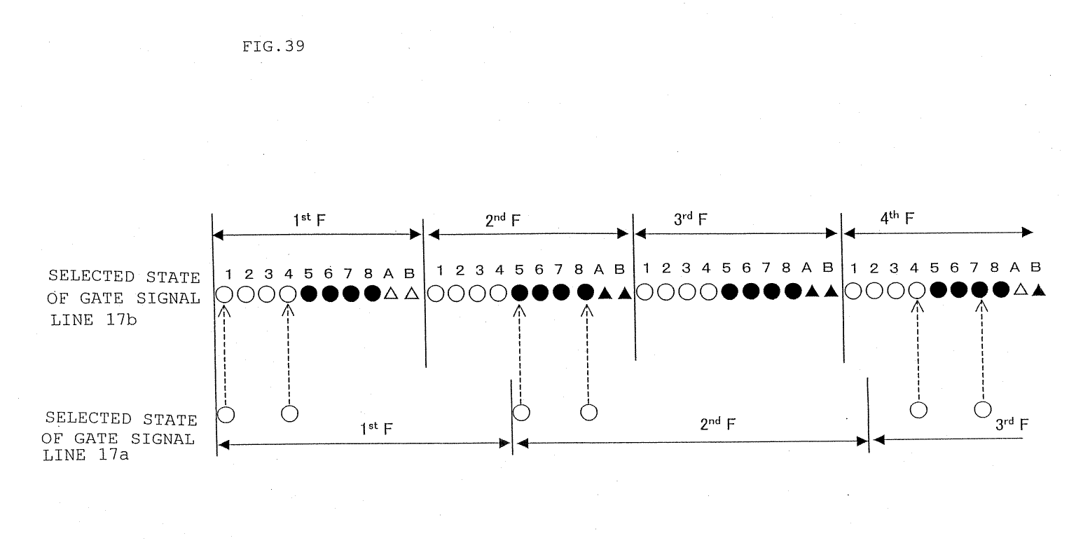

As shown in FIG. 39, there are two positions (white circle marks) selected by the gate driver circuit 12a in this case. As the two locations perform the process of the locations coinciding with the positions selected by the gate driver circuit 12a, the data positions for inputting the correction amount (correction data) are secured at the positions A, B as shown in the selected state of the gate signal line 17b in FIG. 39. The other points are the same as or similar to FIGS. 32 to 34, and so a description thereof will be omitted.

According to the above description, the contents of the correction data (white triangular marks, black triangular marks) to be inputted to the positions A, B are determined from the selected position of the gate signal line 17a and gate signal line 17b in a previous frame. In reality, however, they are determined by the controller circuit before displaying the image. For that reason, the correction data is not processed in delay by one frame. As a matter of course, the correction data of the correction amount may be processed in delay for a period of one frame or multiple frames. As for the correction amount, it is desirable to perform temperature correction. It is because a volt-ampere (V-I) characteristic of the driving transistor 11a is temperature-dependent.

According to the present invention, a temperature detection circuit (pixel) 411 having the configuration that is the same as or similar to the pixel 16 is formed on an array substrate as shown in FIG. 41. The temperature detection circuit 411 is composed of the driving transistors 11 for detecting a temperature change and the capacitor 19 for holding it.

Multiple temperature detection circuits 411 are formed on the array substrate. It is because, in the case where only one temperature detection circuit 411 is formed on the array substrate, a panel module becomes a defective product if the one temperature detection circuit 411 is defective. If multiple temperature detection circuits 411 are formed as in the embodiment of FIG. 41, the panel module can normally operate when at least one of the temperature detection circuits 411 is a nondefective product. One temperature detection circuit 411 is selected out of the multiple temperature detection circuits 411 by a selector circuit 414.

Each of the temperature detection circuits 411 is connected with a constant current circuit 413. The constant current circuit 413 is formed in the source driver circuit 14. The constant current circuit 413 passes a predetermined constant current to the temperature detection circuit 411.

The selector 414 selects one detection wiring 417, and outputs a reset voltage Va outputted to the detection wiring 417 to an AD conversion circuit 413. It goes without saying that the selector 414 can change the temperature detection circuits 411 which is selected in timing of the vertical synchronizing signal VD or the horizontal synchronizing signal HD. In this case, outputs Va of the multiple temperature detection circuits 411 are averaged.

The AD conversion circuit 413 converts the reset voltage Va to digital data. A data comparator 415 compares the converted digital data with the data of an external memory circuit (EEPROM for instance) 412. The external memory circuit 412 has the digital data at a room temperature or a predetermined temperature stored therein.

A voltage variable value against a present panel temperature can be acquired by comparing the reset voltage Va of the digital data at a room temperature or a predetermined temperature with the voltage acquired by the temperature detection circuits 411. The temperature correction is performed by using the voltage variable value. It is desirable to vary the duty ratio, lighting rate, size of the video signal applied to the pixel 16 and the like by using the circuit or the configuration shown in FIG. 41.

According to the above embodiment, the temperature correction is performed to the correction amount. However, it is desirable to apply the temperature correction not only to the correction amount but also to the driving method of the present invention. It is also desirable to perform it to duty ratio driving.

It goes without saying that the above embodiment and configuration relating to temperature correction are also applicable to and combinable with the embodiments in FIGS. 8 to 19, FIG. 42, FIG. 48A, FIG. 48B, FIG. 48C, FIG. 55, FIG. 66, FIG. 67, FIG. 68 and FIG. 69. It goes without saying that it is also applicable to and combinable with the matters relating to the correction method of the correction amount of FIGS. 26 to 40. It goes without saying that it is also applicable to and combinable with the driving method of FIGS. 44 to 47A, FIG. 47B and FIGS. 49 to 62. Furthermore, it goes without saying that the above embodiment is also applicable to the display device of the present invention shown in FIGS. 63 to 65.

According to the above embodiment, in the case where the gate signal line 17a and the gate signal line 17b select the same pixel line, the off-voltage is forcibly applied to the gate signal line 17b of the pertinent pixel line. However, the present invention is not limited thereto.

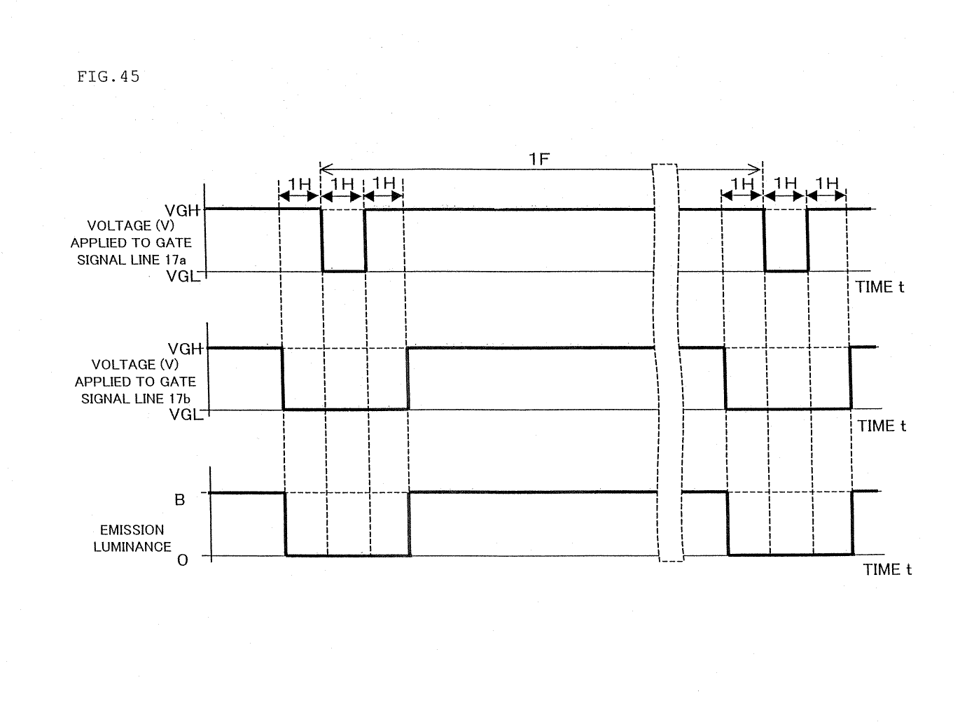

FIG. 44 shows an embodiment in which the off-voltage (VGH) is applied to the gate signal line 17b of the pixel line adjacent to the pixel line to which the off-voltage is forcibly applied. FIG. 45 is a timing diagram for describing the driving method of FIG. 44.

As shown in FIGS. 44, 45, the off-voltage (VGH) is applied to the gate signal line 17b in the pixel line adjacent to the pixel line selected by the gate signal line 17a. Therefore, in the pixel line, the off-voltage (VGH) is applied to the gate signal line 17b during a 3H period (a period for selecting three pixel lines). In FIG. 44, the off-voltage (VGH) is applied to the gate signal lines 17b0, 17b1 and 17b2 when the gate signal line 17a1 is selected.

The driving is performed as in FIG. 44 in order to eliminate uneasy time in the case where the operation frame rate of the gate driver circuit 12a is lower than the operation frame rate of the gate driver circuit 12b as described in FIG. 37. It is because the uneasy time is eliminated by turning off the gate signal lines 17b of the adjacent three pixel lines. It is also intended to stabilize the writing state of the video signals by applying the off-voltage (VGH) to the gate signal lines 17b in the pixel lines adjacent to the pixel line selected by the gate signal line 17a.

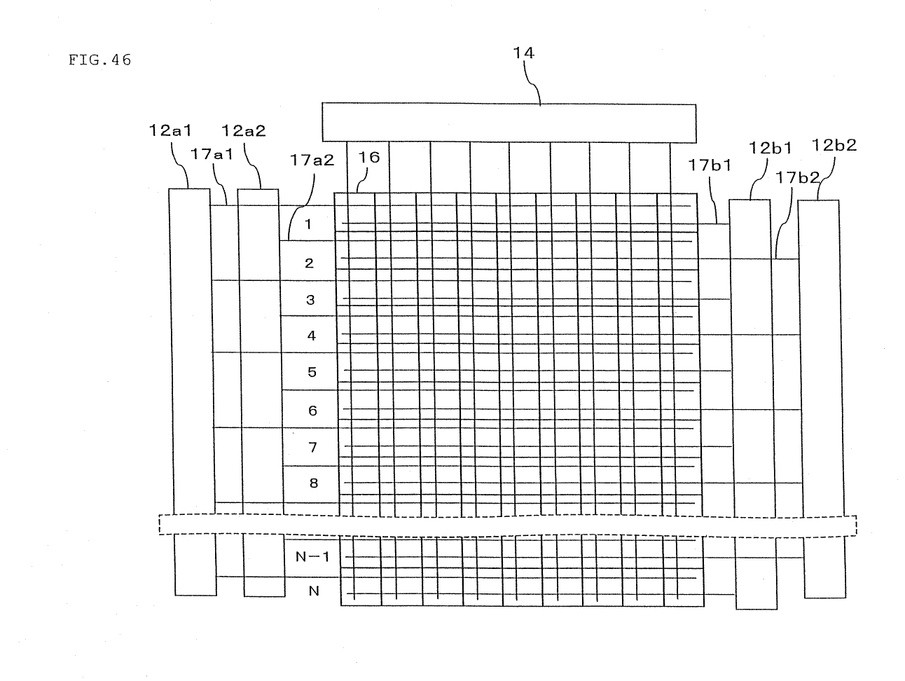

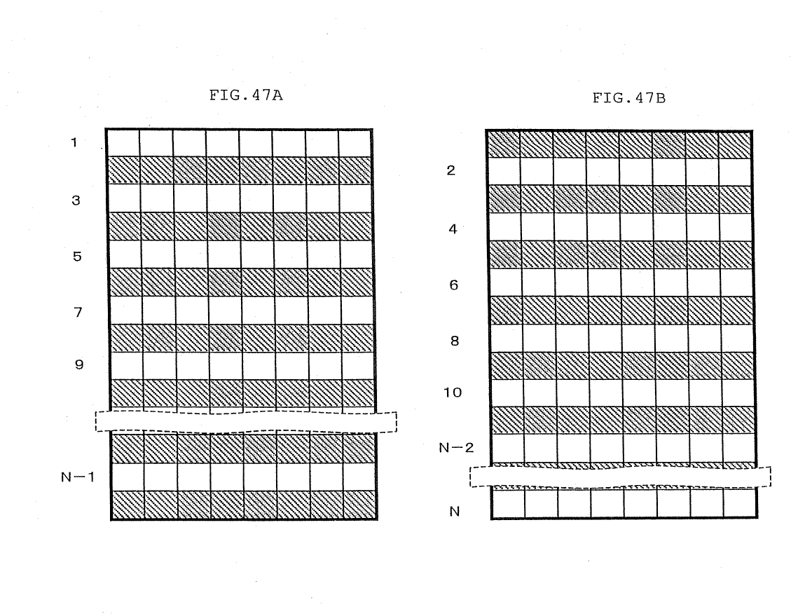

The above embodiment is the driving method of sequentially writing the video signals from the top position of the display screen 22. However, the present invention is not limited thereto. For instance, it may also be interlaced scan driving. FIGS. 46, 47A and 47B are explanatory diagrams of the interlaced scan driving. It goes without saying that the embodiment of the present invention is also applicable to the interlaced scan driving. In particular, the driving method described in FIG. 44 is easily realizable by the interlaced scan driving. In the case of the interlaced scan driving, the pixel lines to be written to are odd-numbered pixel lines and even-numbered pixel lines in odd-numbered fields and even-numbered fields. Therefore, it is easy to put the adjacent pixel lines in the off state.

In FIG. 46, a gate driver circuit 12a1 is a gate driver circuit for selecting the gate signal line 17a1 of the odd-numbered pixel line. A gate driver circuit 12a2 is a gate driver circuit for selecting the gate signal line 17a2 of the even-numbered pixel line. Similarly, a gate driver circuit 12b1 is a gate driver circuit for selecting the gate signal line 17b1 of the odd-numbered pixel line. A gate driver circuit 12b2 is a gate driver circuit for selecting the gate signal line 17b2 of the even-numbered pixel line.

FIG. 47A is a first field for selecting the odd-numbered pixel lines and writing the video signal data, and FIG. 47B is a second field for selecting the even-numbered pixel lines and writing the video signal data.

As shown in FIG. 47A, the video signal data is written to the odd-numbered pixel lines in the first field. The gate driver circuit 12a1 sequentially selects the gate signal lines 17a1 of the odd-numbered pixel lines and writes the video signals from the source driver circuit 14 to the pixel lines. In this field, the gate driver circuit 12a2 does not operate, and the off-voltage (VGH) is constantly applied to the gate signal line 17a2. And the gate driver circuit 12b1 does not operate, and the off-voltage (VGH) is constantly applied to the gate signal line 17b1. The gate driver circuit 12b2 lights the EL element 15 at a duty ratio specified by a lighting control signal.

In the second field of FIG. 47B, the video signal data is written to the even-numbered pixel lines. The gate driver circuit 12a2 sequentially selects the gate signal lines 17a2 of the even-numbered pixel lines and writes the video signals from the source driver circuit 14 to the pixel lines. In this field, the gate driver circuit 12a1 does not operate, and the off-voltage (VGH) is constantly applied to the gate signal line 17a1. The gate driver circuit 12b2 does not operate, and the off-voltage (VGH) is constantly applied to the gate signal line 17b2. The gate driver circuit 12b1 lights the EL element 15 at a duty ratio specified by a lighting control signal. As above, the present invention can also be implemented by the interlaced scan driving. The operation frame rate of the first field may be different from the operation frame rate of the second field.

The above embodiment is the method of performing the driving so as not to simultaneously apply the on-voltage (VGL) to the gate signal line 17a and the gate signal line 17b of the pixel 16 in the case where the operation frame rate of the gate driver circuit 12a is different from the operation frame rate of the gate driver circuit 12b. The operation frame rate of the gate driver circuit 12b may be different frame by frame.

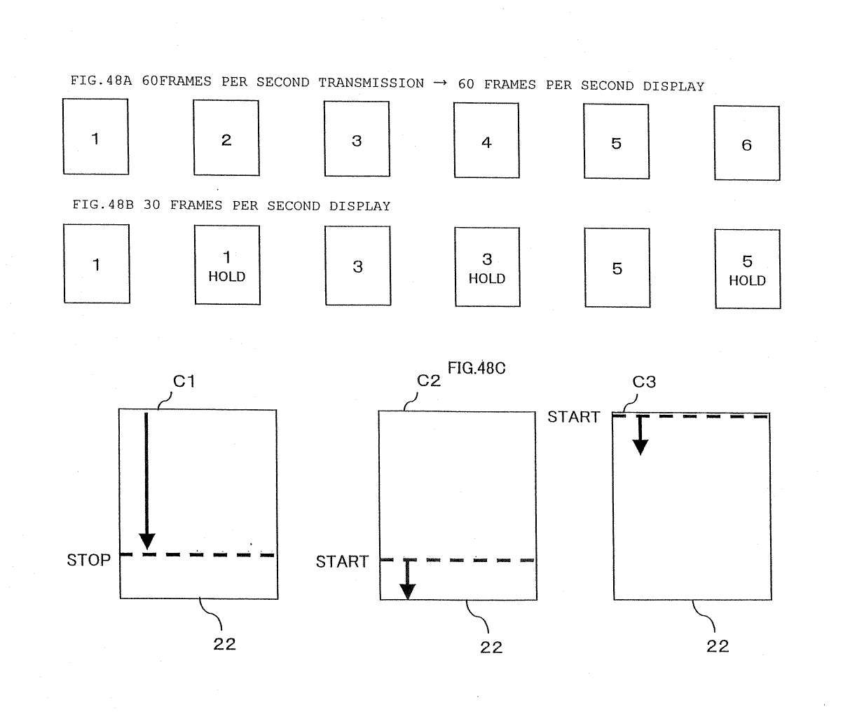

FIGS. 48A, 48B and 48C are explanatory diagrams of the other embodiments of the present invention. FIGS. 48A, 48B and 48C describe the methods of writing an image to the display screen 22. To be more specific, they center on the operation of the gate driver circuit 12a and the gate signal line 17a. FIG. 48A shows a conventional method of writing an image. It displays (rewrites) the image transmitted at 60 frames per second (=60 frame rate) at 60 frames per second. The image is rewritten, such as an image 1, an image 2, an image 3, an image 4, an image 5, an image 6 and so on. The driving method of the present invention is applied to control of the gate driver circuit 12b and the gate signal line 17b and the like.

FIG. 48B shows an embodiment of the present invention. The image is transmitted at 30 frames per second. However, the operation frame rate is 60 frames per second. To be more specific, one screen is transmitted from a graphic controller (not shown) in the period of 1/60 second, and no image is transmitted from the graphic controller (not shown) in the following period of 1/60 second. To be more specific, it repeats image transmission, no image transmission, image transmission, no image transmission and so on.

In the case of the image transmission of FIG. 48B, the present invention rewrites the image 1 in the period of 1/60 second. In this case, the gate driver circuit 12a sequentially selects the gate signal lines 17a and sequentially writes the image 1 outputted from the source driver circuit 14 to the pixels. The image 1 is held in the following period of 1/60 second. In this case, the gate driver circuit 12a stops the operation. The driving method of the present invention is applied to control of the gate driver circuit 12b and the gate signal line 17b and the like.

The image writing by the gate driver circuit 12a can be rendered intermittent because the image data is held as an analog voltage by the capacitor 19 of the pixel 16 in the EL display device of the present invention. Although the gate driver circuit 12a intermittently performs the image writing, no flicker occurs because the gate driver circuit 12b is operating at the operation frame rate of 60 Hz or more. To be more specific, it is because the gate driver circuit 12a and the gate driver circuit 12b can be driven at different operation frame rates according to the driving method of the present invention. As above, the present invention exerts the characteristic effects by the driving method of FIG. 48B.

Hereunder, the image 3 is rewritten in the following period of 1/60 second. In this case, the gate driver circuit 12a sequentially selects the gate signal lines 17a and sequentially writes the image 3 outputted from the source driver circuit 14 to the pixels. The image 3 is held in the following period of 1/60 second. In this case, the gate driver circuit 12a stops the operation. Similarly, the image 5 is subsequently rewritten in the following period of 1/60 second. In this case, the gate driver circuit 12a sequentially selects the gate signal lines 17a and sequentially writes the image 5 outputted from the source driver circuit 14 to the pixels. The image 5 is held in the following period of 1/60 second. In this case, the gate driver circuit 12a stops the operation. The operating time of the graphic controller can be rendered intermittent by driving it as above. Thus, lower power consumption of the EL display device can be expected.

In the embodiment of FIG. 48B, the driving method of the present invention is applied to the control of the gate driver circuit 12b, the gate signal lines 17b and the like. The operation frame rate of the gate driver circuit 12a is also different from the operation frame rate of the gate driver circuit 12b in FIG. 48B. Therefore, FIG. 48B shows implementation of the driving method of the present invention.

FIG. 48C shows the method of stopping the writing of the image halfway through the image. It is irrespective of a transmission frame rate of the image. In c1 of FIG. 48C, the image transmitted from the graphic controller (not shown) is written to the dashed line. The gate driver circuit 12a operates in the writing of the image. The gate driver circuit 12a sequentially selects the gate signal lines 17a and sequentially writes the image outputted from the source driver circuit 14 to the pixels. When the image is written to the dashed line, the writing of the image is stopped once. Whether or not to stop it at the dashed line is a matter of the description, and the point is not in stopping it at the dashed line position. The driving method of the present invention is applied to the control of the gate driver circuit 12b, the gate signal lines 17b and the like.

Next, in c2 of FIG. 48C, the writing of the image transmitted from the graphic controller (not shown) is started again from the start position (=stop position of c1 of FIG. 48C) of the dashed line. The gate driver circuit 12a operates in the writing of the image. The gate driver circuit 12a sequentially selects the gate signal lines 17a and sequentially writes the image outputted from the source driver circuit 14 to the pixels. When the images are written to the bottom side of the display screen 22, the image transmission from the graphic controller is stopped and the writing of the images is stopped.

Next, in c3 of FIG. 48C, the writing of the image transmitted from the graphic controller (not shown) is started again from the top side position of the screen of the dashed line. The gate driver circuit 12a operates in the writing of the image. The gate driver circuit 12a sequentially selects the gate signal lines 17a and sequentially writes the image outputted from the source driver circuit 14 to the pixels. The operating time of the graphic controller can be rendered intermittent by driving it as above. Thus, lower power consumption can be expected.

The operation frame rate of the gate driver circuit 12a is also different from the operation frame rate of the gate driver circuit 12b in FIG. 48C. Therefore, it is implementation of the driving method of the present invention.

Although the gate driver circuit 12a intermittently writes the images, no flicker occurs because the gate driver circuit 12b is operating at the operation frame rate of operation speed at which no flicker is visible. To be more specific, it is because the driving method of the present invention allows the gate driver circuit 12a and the gate driver circuit 12b to be driven at different operation frame rates. As above, the present invention also exerts the characteristic effects by the driving method of FIG. 48C.

It goes without saying that the matters described in FIGS. 48A, 48B and 48C are applicable to the embodiments in FIGS. 8 to 19, FIG. 42, FIG. 55, FIG. 66, FIG. 67, FIG. 68 and FIG. 69 and are also combinable therewith to constitute embodiments. For instance, the examples to be shown are introduction of the AND circuit 81, introduction of the shift register circuit 111a and the shift register circuit 111b, introduction of the voltage level shift circuit 112, setting of the on-voltages (VGL1, VGL2), differentiation between the operation frame rates of the gate driver circuit 12a and the gate driver circuit 12b, and the like.

It goes without saying that the matters relating to the correction method of the correction amount of FIGS. 26 to 40 are applicable to the present invention in FIGS. 48A, 48B and 48C and are also combinable therewith to configure an embodiment. It goes without saying that the configuration and method of the temperature correction of FIG. 41 are also applicable to and combinable with the present invention in FIGS. 48A, 48B and 48C.

The embodiments of FIGS. 48A, 48B and 48C are also applicable to and easily combinable with the driving method of FIGS. 44 to 47A, FIG. 47B and FIGS. 49 to 62, FIG. 66, FIG. 67, FIG. 68 and FIG. 69. Any of the pixel configurations of FIG. 1 and FIGS. 20 to 25 and the like are applicable to the embodiments of FIGS. 48A, 48B and 48C. Furthermore, it goes without saying that the above embodiments are also applicable to the display device of the present invention shown in FIGS. 63 to 65.

One of the main points of the driving method of the present invention is that the cycle in which the gate driver circuit 12a writes the video signal to the display screen 22 is different from the cycle in which the gate driver circuit 12b controls the lighting of the EL element 15. The above is realizable independently from the embodiments of FIGS. 8 to 15, FIG. 42, FIG. 48A, FIG. 48B, FIG. 48C, FIG. 55, FIG. 66, FIG. 67, FIG. 68 and FIG. 69. The embodiment will be described below.

Hereunder, a modified example of the present invention will be described. The following modified example principally involves the operation of the gate driver circuit 12b. A higher image quality is realizable by combining the following modified example with the previously described embodiment of the present invention.

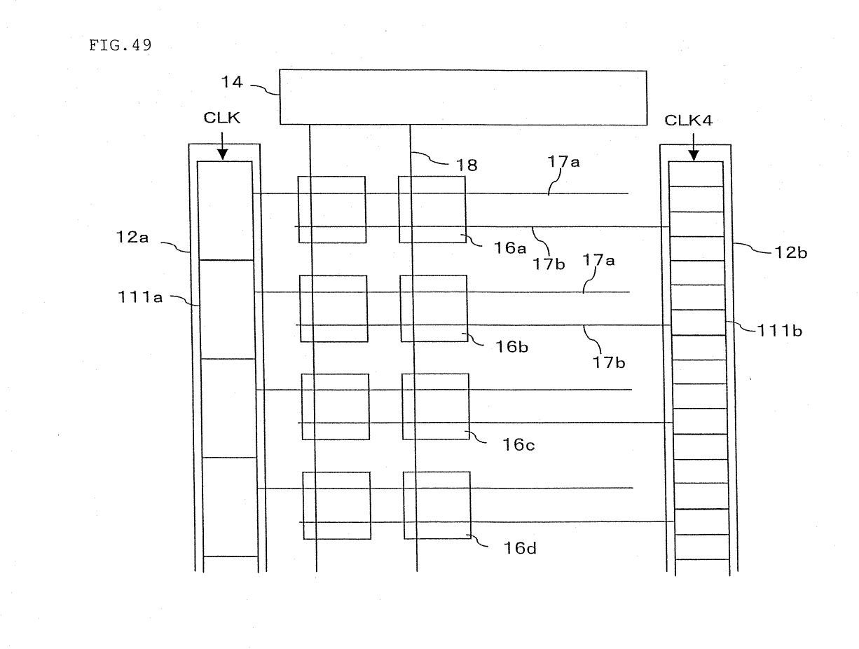

The embodiment of FIG. 49 is an embodiment which can exert lighting and non-lighting control in one horizontal scanning period. The shift register circuit 111a of the gate driver circuit 12a shifts the data position in synchronization with a horizontal scanning period signal (horizontal synchronizing signal).

The shift register circuit 111b of the gate driver circuit 12b for selecting the gate signal line 17b has four times as many stages as the shift register circuit 111a of the gate driver circuit 12a. The shift register circuit 111b of the gate driver circuit 12b shifts the data at a clock frequency (CLK4) four times that of the shift register circuit 111a. To be more specific, the shift register circuit 111b shifts four pieces of data in the period when the shift register circuit 111a shifts one piece of data. The above configuration allows the gate driver circuit 12b to exert lighting and non-lighting control of the pixel lines by ¼ of one horizontal scanning period.

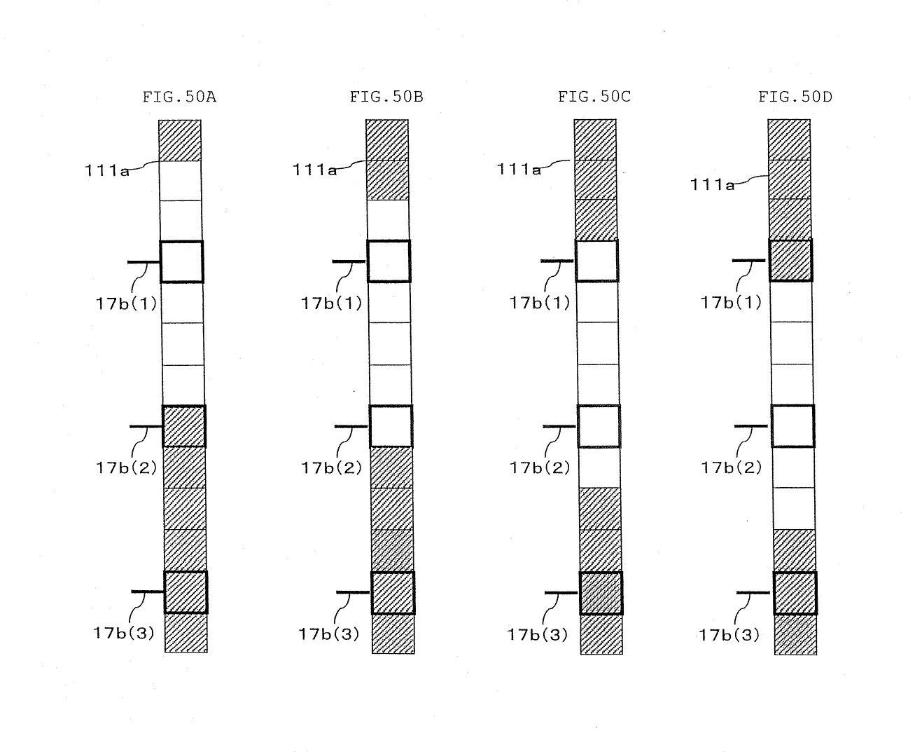

FIG. 50A, FIG. 50B, FIG. 50C and FIG. 50D indicate the number of stages of the shift register circuit 111b and the positions at which the gate signal lines 17b are connected. The output of the shift register circuit 111b is outputted as a logic output of the gate signal line 17b at every fourth stage.

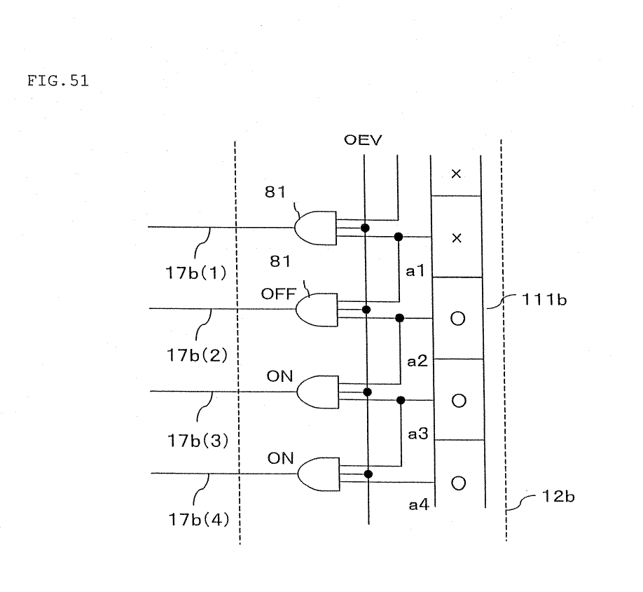

To reduce the number of stages of the adjacent shift register circuit 111b and alleviate the change in the data of the stages, it is desirable to have a configuration such as FIG. 51.

In FIG. 51, × indicates the data for rendering the gate signal lines 17 non-selected (outputting the off-voltage) and ◯ indicates the data for rendering the gate signal lines 17 selected (outputting the on-voltage). Although a level shift circuit is configured for the output of the AND circuit 81, it is omitted in order to facilitate the description.

Data output of each of the adjacent stages of the shift register circuit 111b is ANDed by the AND circuit 81. Selection of the gate signal line 17b is forcibly rendered non-selected by a vertical output enable (OEV) terminal.

Because of the above configuration, the selection voltage (VGL) is outputted from the gate signal line 17b when the two adjacent stages of the shift register circuit 111b are selected “◯.”

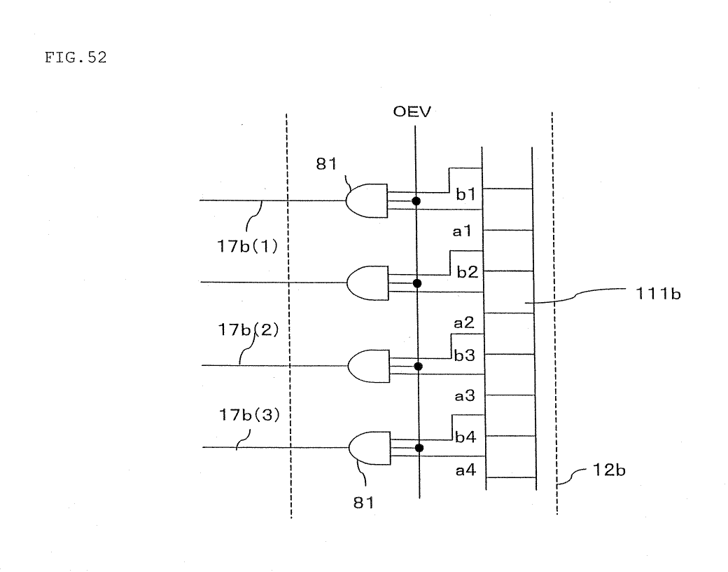

FIG. 52 shows an embodiment configured so that the logic control can be separately exerted over the two stages when the data of the two adjacent stages of the shift register circuit 111b are selected. When the two adjacent stages are selected “◯,” the selection voltage (VGL) is outputted from the gate signal line 17b.

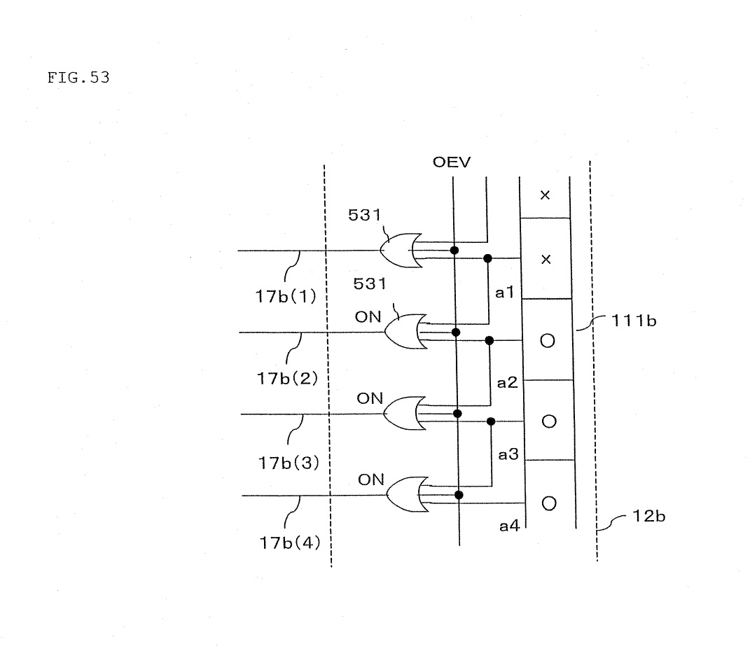

The above embodiment is an embodiment in which the AND circuit 81 is formed for the output of the shift register circuit 111b. However, the present invention is not limited thereto. An OR circuit 531 may also be formed as shown in FIG. 53.

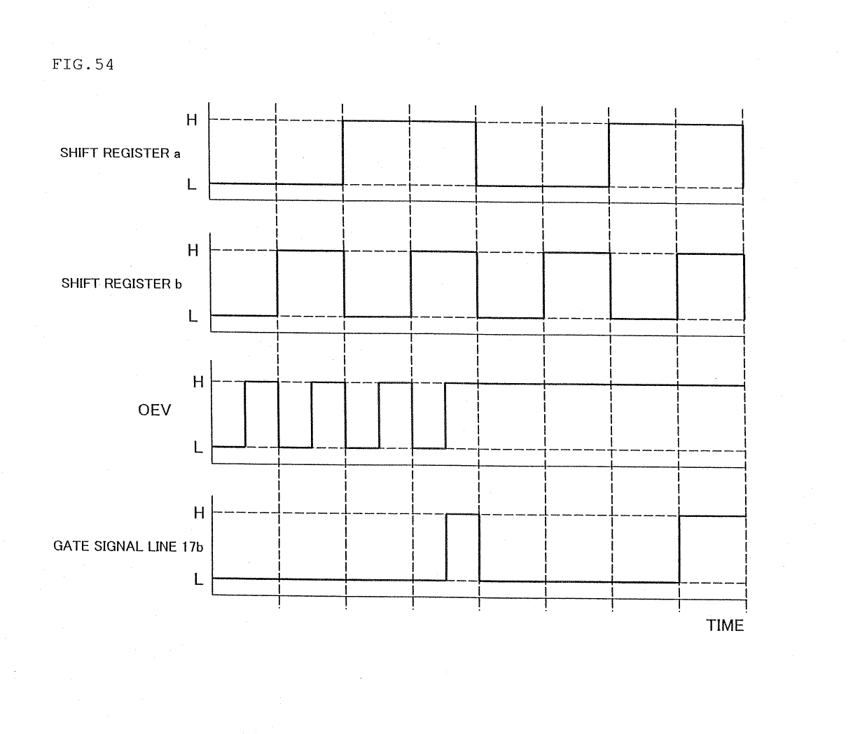

It is also possible to configure the shift register circuit in two stages with the shift register circuit 111a and the shift register circuit 111b, further form the OEV terminal and AND the logic of the shift register circuit 111a, the shift register circuit 111b and the OEV terminal so as to flexibly perform the selection and non-selection of the gate signal lines 17b. FIG. 54 shows an example of a combination of these logic signals.

As described above, the configuration of the present invention such as FIG. 49 is a configuration or a method wherein the number of stages of the shift register circuit 111b of the gate driver circuit 12b is m times (m is an integer of 2 or more) the number of stages of the shift register circuit 111a of the gate driver circuit 12a, and the clock frequency of the shift register circuit 111b of the gate driver circuit 12b is m times (m is an integer of 2 or more) the clock frequency of the shift register circuit 111a of the gate driver circuit 12a to be able to exert lighting control for one horizontal scanning period or less. This configuration allows luminance to be smoothly controlled with no flicker.

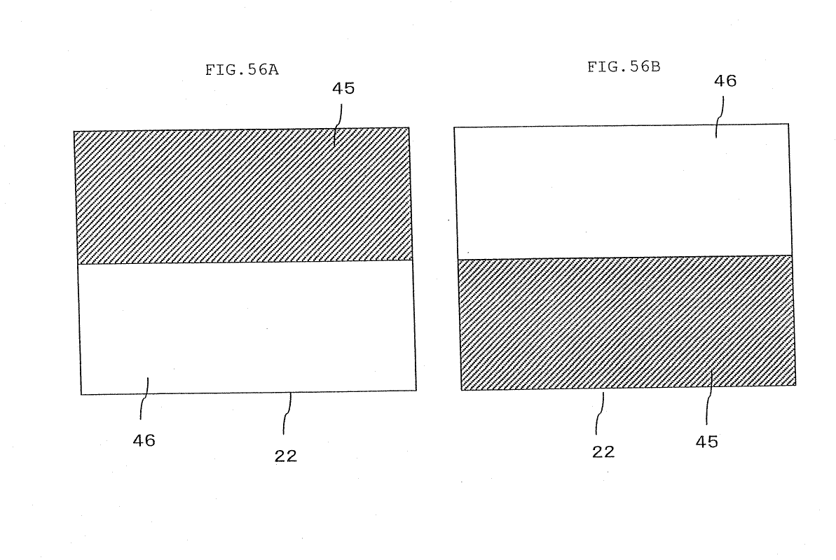

As described in FIG. 4 and the like, the present invention is the method of primarily rendering the display area 46 or the nondisplay area 45 belt-like and vertically or inversely moving the display screen 22. However, the present invention is not limited thereto. The image display may be performed by vertically dividing the display screen 22 as shown in FIGS. 56A, 56B.

FIG. 56A shows a display state of the first half (½) of one frame. FIG. 56B shows a display state of the second half (½) of one frame. In the first half of one frame, an upper half of the display screen 22 is the nondisplay area 45 (no selection voltage (VGL) is applied to the gate signal line 17b of the pertinent area). In the upper half area, the selection voltage is sequentially applied to the gate signal line 17a by the gate driver circuit 12a.

FIG. 56B shows the display state of the second half (½) of one frame. In the second half of one frame, a lower half of the display screen 22 is the nondisplay area 45 (no selection voltage (VGL) is applied to the gate signal line 17b of the pertinent area). In the lower half area, the selection voltage is sequentially applied to the gate signal line 17a by the gate driver circuit 12a.

To facilitate understanding, a description will be given by listing concrete values. There are 240 pixel lines. Therefore, the first pixel line to 120^{th} pixel line falls under the upper half area. The 121^{st} pixel line to the 24^{th} pixel line falls under the lower half area. The gate driver circuit 12a sequentially selects the gate signal lines 17a, sequentially selects the first pixel line to 240^{th} pixel line in one frame period and applies the program current (voltage) of the source driver circuit 14 to the pixel 16.

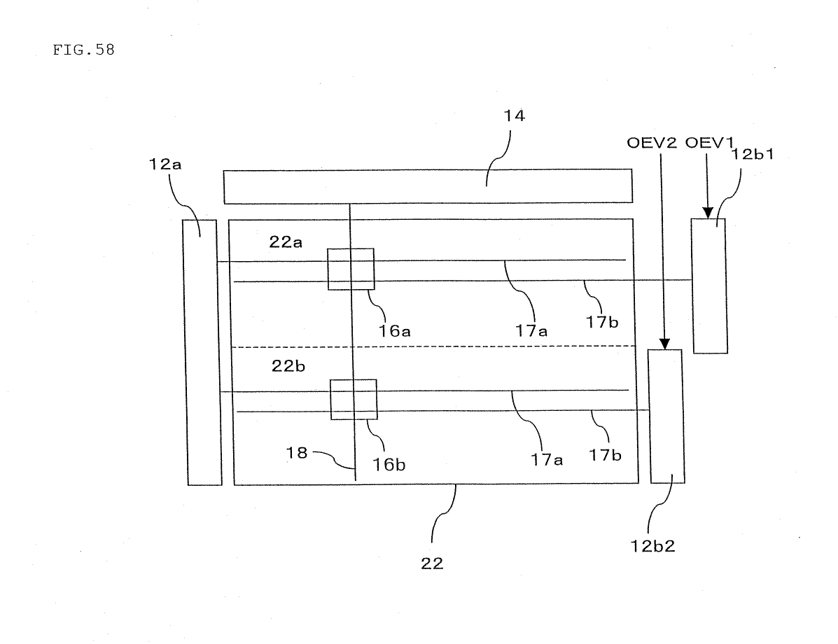

As shown in FIG. 58, the gate driver circuit 12b has the gate driver circuit 12b1 for driving the upper half of the display screen 22 and the gate driver circuit 12b2 for driving the lower half of the display screen 22 configured therein. Each of the gate driver circuit 12b1 and gate driver circuit 12b2 has a shift register circuit 31 therein so that the on-voltage or the off-voltage of an arbitrary gate signal line 17b can be applied by shifting the data. However, the OEV terminal is controlled in the embodiment of FIGS. 56A, 56B.

An OEV1 terminal has the logic level L inputted thereto so that the off-voltage is outputted to all the gate signal lines 17b of the gate driver circuit 12b1. Therefore, the upper half of the display screen 22 becomes the nondisplay area 45. The OEV1 terminal has the logic level H inputted thereto so that the on-voltage is outputted to all the gate signal lines 17b of the gate driver circuit 12b1. Therefore, the upper half of the display screen 22 becomes the display area 46.

An OEV2 terminal has the logic level L inputted thereto so that the off-voltage is outputted to all the gate signal lines 17b of the gate driver circuit 12b2. Therefore, the lower half of the display screen 22 becomes the nondisplay area 45 (FIG. 56B). The OEV2 terminal has the logic level H inputted thereto so that the on-voltage is outputted to all the gate signal lines 17b of the gate driver circuit 12b2. Therefore, the lower half of the display screen 22 becomes the display area 46 (FIG. 56A).

In the period in which the gate driver circuit 12a is rewriting the first pixel line to 120^{th} pixel line of the display screen 22, it is controlled in the state of FIG. 56A. To be more specific, an L logic signal is applied to the OEV1 terminal, and the off-voltage is applied to the gate signal lines 17b subject to the gate driver circuit 12b1. An H logic signal is applied to the OEV2 terminal, and the on-voltage is applied to the gate signal lines 17b subject to the gate driver circuit 12b2.

In the period in which the gate driver circuit 12a is rewriting the 121^{st} pixel line to 24^{th} pixel line of the display screen 22, it is controlled in the state of FIG. 56B. To be more specific, an H logic signal is applied to the OEV1 terminal, and the on-voltage is applied to the gate signal lines 17b subject to the gate driver circuit 12b1. An L logic signal is applied to the OEV2 terminal, and the off-voltage is applied to the gate signal lines 17b subject to the gate driver circuit 12b2.

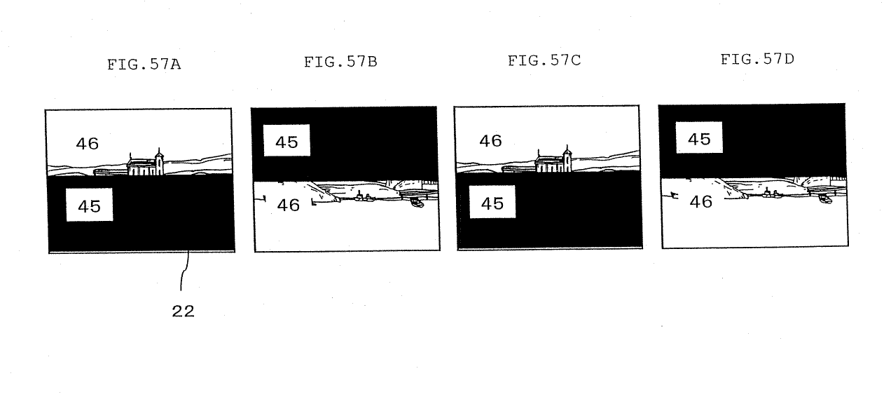

FIG. 57A, FIG. 57B, FIG. 57C and FIG. 57D show an image display state of two frame periods. The upper half and the lower half of the display screen 22 are alternately displayed. The moving image visibility is significantly improved by controlling the display as above. As it is not necessary to form the shift register circuit 31 in the gate driver circuit 12b, the circuit configuration can be simplified. It is also possible to narrow the frame of the display panel.

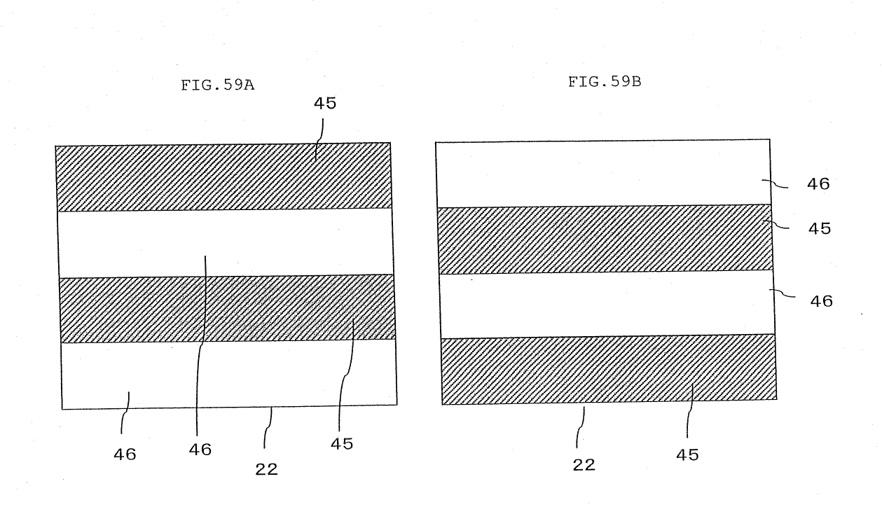

The above embodiment had the configuration for vertically dividing the display screen 22 into two. However, the present invention is not limited thereto. For instance, the screen may be divided in quarters as shown in FIGS. 59A, 59B. In the case of this embodiment, the gate driver circuits 12b should be composed of the gate driver circuit 12b1, gate driver circuit 12b2, gate driver circuit 12b3 and gate driver circuit 12b4. And the OEV terminals (OEV1, OEV2, OEV3 and OEV4) should be placed in each of the gate driver circuits 12b. The operation of the gate driver circuit 12a is sequentially scanning the screen from the top toward the bottom thereof as in FIG. 58.

As described above, the present invention divides one frame period into multiple time periods and also divides the display area into a plurality so as to control the display area 46 and the nondisplay area 45.

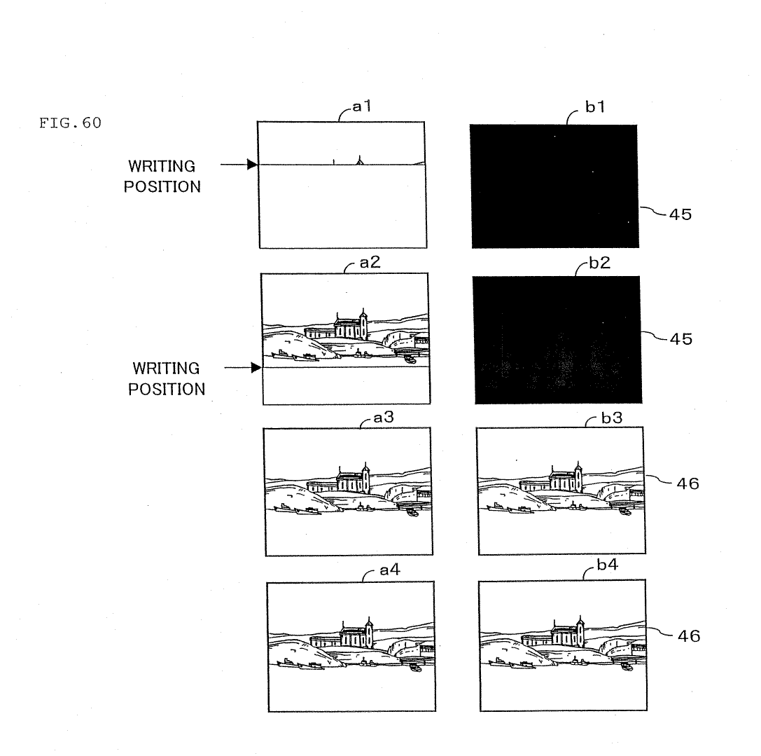

The present invention is not limited to the method of dividing the display screen 22 such as FIGS. 56A, 56B. For instance, it may be implemented as shown in FIG. 60. FIG. 60 is an explanatory diagram of the driving method of one frame period.

In FIG. 60, parts a1, a2, a3 and a4 therein show image writing positions (indicated by an arrow) by the gate driver circuit 12a. As in FIGS. 56A, 56B and the like, the gate driver circuit 12a selects the gate signal lines 17a for the first pixel line to 240^{th} pixel line of the screen and writes the video signals from the source driver circuit 14 to the pixel lines.

Parts b1, b2, b3 and b4 of FIG. 60 show control states of the display area 46 and the nondisplay area 45 by the gate driver circuit 12b. The gate driver circuit 12b controls the entire display screen 22 in the lighted or non-lighted state by control of the OEV terminals.

The image writing of the gate driver circuit 12a is completed in a (½) frame period. To be more specific, it performs double-speed writing. In that period, the L logic is applied to the OEV terminals of the gate driver circuit 12b, and the off-voltage (non-selection voltage) is applied to all the gate signal lines 17b. Writing operation of the gate driver circuit 12a stops in the second ½ frame period of one frame. In this period, the H logic signal is applied to the OEV terminals of the gate driver circuit 12b, and the on-voltage is applied to all the gate signal lines 17b. Therefore, the display screen 22 is in the non-lighted state (nondisplay) in the (½) frame period of one frame, and is in the lighted state (display) in the second (½) frame period. The display period and nondisplay period of the images are not limited to a (½) frame, but are freely settable or adjustable by control of a write clock of the gate driver circuit 12a and the OEV terminals of the gate driver circuit 12b.

The embodiment of FIGS. 56A, 56B is an embodiment dividing the display screen 22 into two. The embodiment of FIGS. 59A, 59B is an embodiment for dividing the screen into four and rendering multiple areas thereof as the display areas 46. The embodiment of FIGS. 59A, 59B is an embodiment for rewriting the image on the display screen 22 and then putting the display screen 22 in the display state. The present invention is not limited the above embodiments but a number of deformed examples are thinkable.

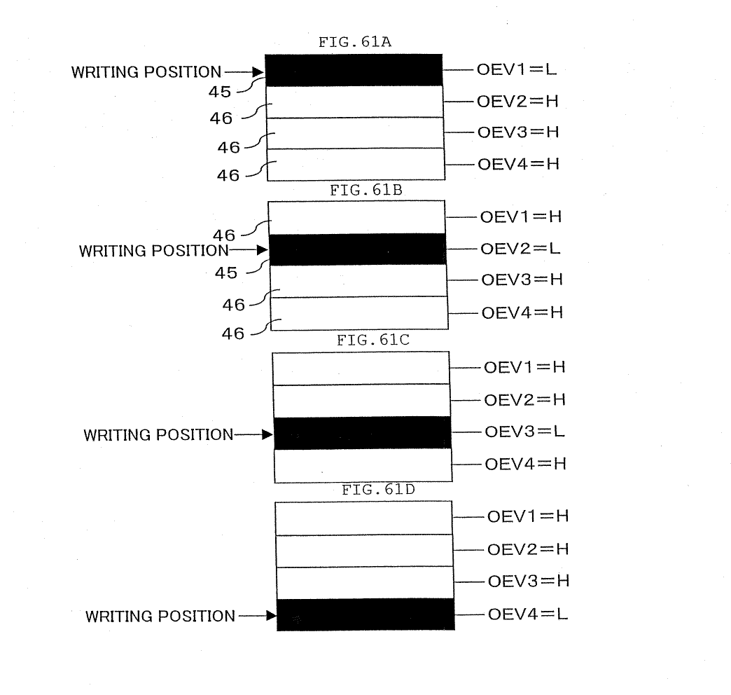

FIG. 61A, FIG. 61B, FIG. 61C and FIG. 61D show an embodiment for dividing the display screen 22 into a plurality, i.e. three or more (four in the embodiment). It also renders only the area of which image is being rewritten as the nondisplay area 45.

In FIG. 61A, FIG. 61B, FIG. 61C and FIG. 61D, the area including the pixel line (shown as a writing position) of which image is being rewritten is rendered as the nondisplay area 45. The other areas are controlled as the display areas 46 (areas in the image display state). The writing position is sequentially rewritten from the top toward the bottom of the display screen 22. The area including the writing position is controlled by the nondisplay areas 45 according to the movement of the writing position.

Switching between the nondisplay areas 45 and the display areas 46 may be performed by control of a start pulse (ST signal) inputted to the gate driver circuit 12b. It may also be performed by control exerted by the OEV terminals as shown in FIG. 61A, FIG. 61B, FIG. 61C and FIG. 61D. The areas are rendered as the nondisplay areas 45 by inputting the L logic to the OEV terminals of the gate driver circuit 12b. The areas are rendered as the display areas 46 by inputting the H logic signal to the OEV terminals.

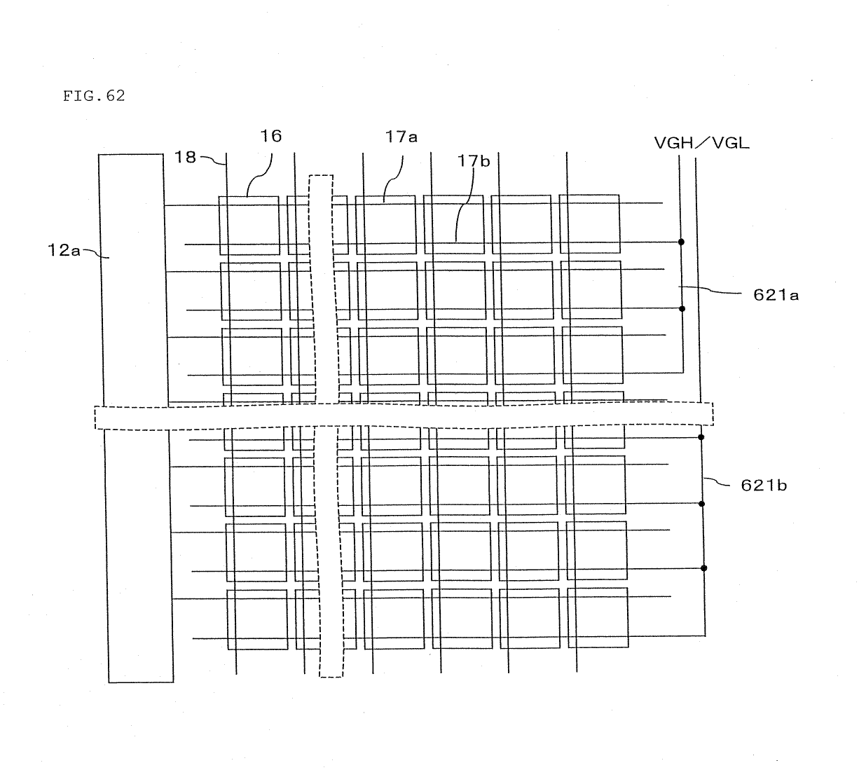

As shown in FIG. 62, a method of directly controlling the gate signal line 17b for on/off-controlling the current to be passed to the EL element 15 is exemplified. In FIG. 62, the display screen 22 is divided into multiple blocks, where the gate signal line 17b of each block is rendered common by a selection signal line 621. The gate driver circuit 12a is common among the blocks (divided display screen 22). To be more specific, one pixel line or multiple adjacent pixel lines are sequentially selected as the gate signal line 17a.

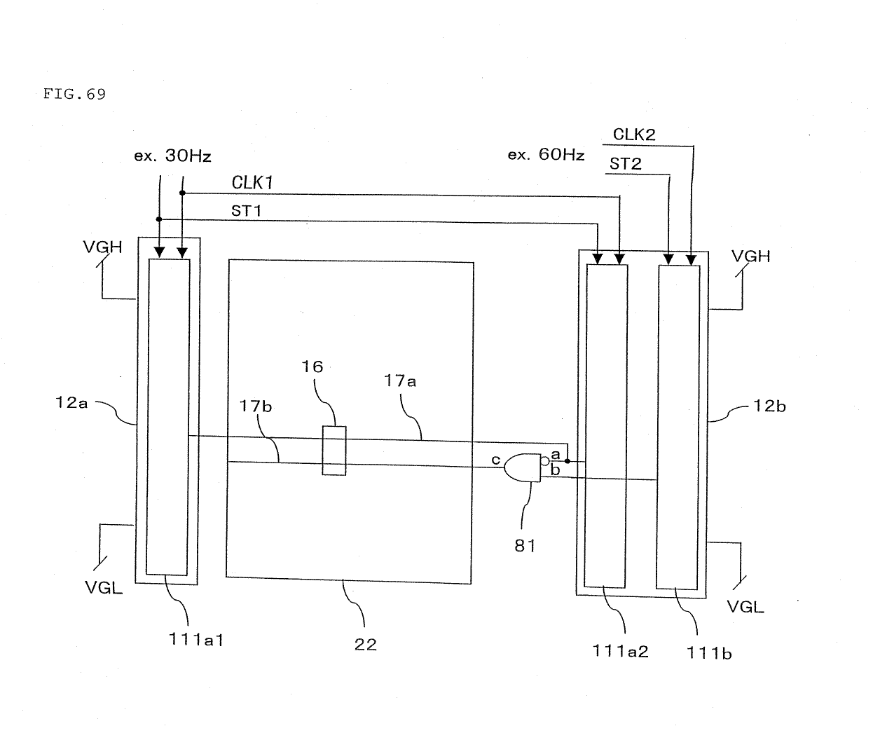

The selection signal line 621a is connected to the gate signal line 17b of the first block. The selection signal line 621b is connected to the gate signal line 17b of the first block. The first block is rendered as the nondisplay area 45 by applying the off-voltage VGH to the selection signal line 621a. The first block is rendered as the display area 46 by applying the on-voltage VGL to the selection signal line 621a. The first block is rendered as the nondisplay area 45 by applying the off-voltage VGH to the selection signal line 621b. The first block is rendered as the display area 46 by applying the on-voltage VGL to the selection signal line 621b. As above, display and nondisplay control is easily realizable block by block on the display screen 22 by applying the on-voltage or the off-voltage to the selection signal lines 621 as in FIG. 57A, FIG. 57B, FIG. 57C and FIG. 57D, FIG. 59A, FIG. 69B, FIG. 60, FIG. 61A, FIG. 61B, FIG. 61C and FIG. 61D.

According to the above embodiment, the adjacent gate signal lines 17b in the block are rendered electrically common by the selection signal lines 621. However, the present invention is not limited thereto. For instance, the gate signal lines 17b of adjacent pixel lines may be electrically connected to different selection signal lines 621. The moving image visibility is improved by controlling the display of the display screen 22 as above so that the image display equivalent to a CRT can be realized.

It goes without saying that the above embodiment is combinable with the other embodiments of this specification. It also goes without saying that the embodiment is applicable to the device and the like of the present invention.

For instance, it is possible, as shown in FIG. 55, to differentiate the operating frequency or selection frequency between the gate driver circuit 12a and the gate driver circuit 12b. The embodiment of FIG. 55 is an embodiment in which the gate driver circuit 12a is operated in a 60-Hz cycle and the gate driver circuit 12b is operated in a 75-Hz cycle, i.e. 1.5 times.

FIG. 55 has the configuration in which the gate driver circuit 12a and the gate driver circuit 12b are placed on the right and left of the display screen 22. FIG. 11 has the configuration in which the gate driver circuits 12 are placed on the right of the display screen 22.

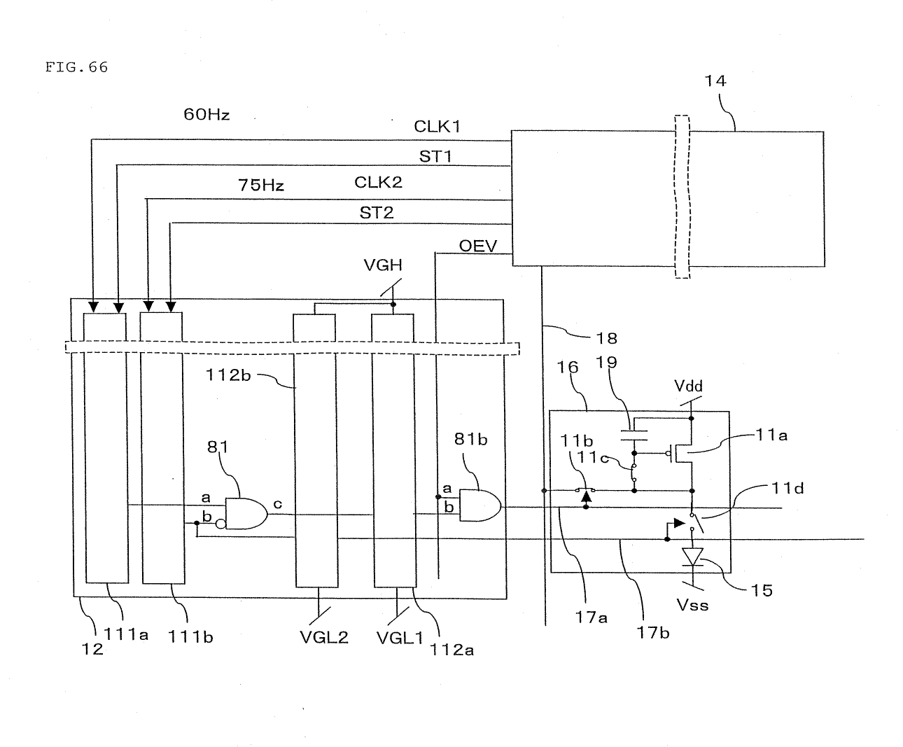

FIG. 66 has the configuration in which the gate driver circuits 12 are placed on the left of the display screen 22. The voltage level shift circuits 112a and 112b have a common VGH voltage. The on-voltage (VGL1) of the voltage level shift circuits 112a is adapted to the on-voltage of the gate signal line 17a. The on-voltage (VGL2) of the voltage level shift circuit 112b is adapted to the on-voltage of the gate signal line 17b.

The output of the shift register circuit 111b becomes the input of the AND circuit 81 and also becomes the input of the voltage level shift circuit 112b. The voltage level shift circuit 112b drives the gate signal line 17b and on/off-controls the switch transistor 11d.

The output of the shift register circuit 111a and the output of the shift register circuit 111b become the inputs of the AND circuit 81. When both the shift register circuit 111a and shift register circuit 111b are selected (when selecting the same pixel line), the AND circuit 81 and the voltage level shift circuit 112a output the off-voltage (VGH) to the gate signal line 17a. On application of the off-voltage (VGH), the gate signal line 17a turns off the switch transistors 11b, 11c so that the pixel line is put in the non-selected state. The rest of the configuration is the same as or similar to FIG. 55, and so a description thereof will be omitted.

It goes without saying that the above embodiment may have any pixel configuration, such as FIG. 1 or FIGS. 20 to 25. The above matters are also the same in the other embodiments of the present invention.

The above embodiment had the configuration in which the gate driver circuits 12 include the shift register circuits 111. However, the present invention only requires a portion for selecting a pixel line for writing the video signal and a portion for selecting (specifying) the pixel line for lighting the EL element. Therefore, the gate driver circuits 12 are not always necessary components. It is possible to select (specify) the pixel line even if the gate driver circuits 12 include no shift register circuit 111.

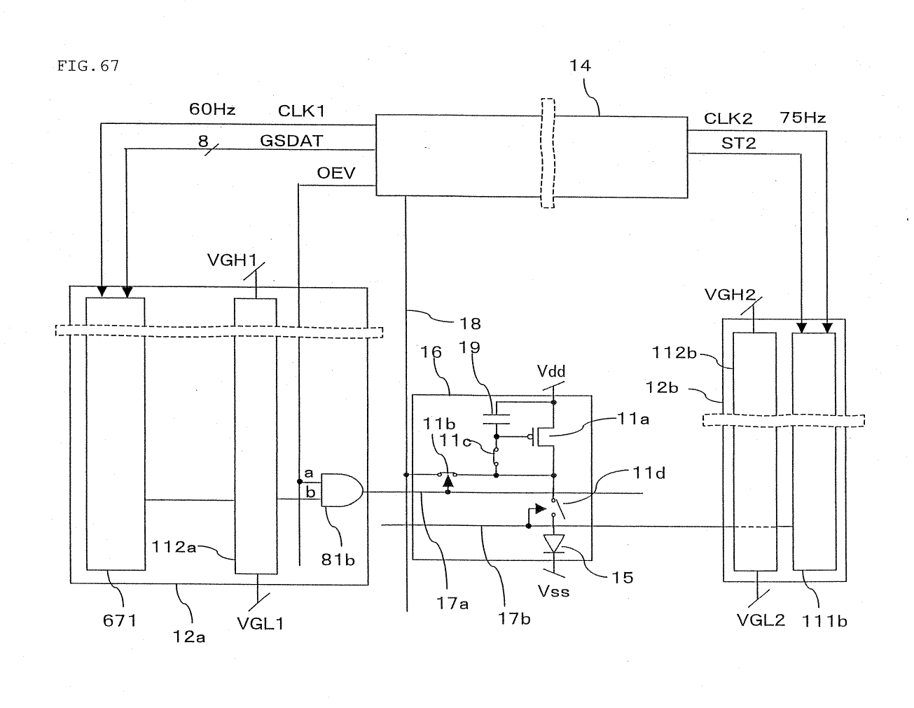

FIG. 67 has the configuration in which the gate driver circuit 12 includes a decoder circuit 671 therein. The input signal of the decoder circuit 671 is GSDAT. GSDAT is 8 bits and capable of specifying 240 gate signal lines 17a. When GSDAT is 1, it specifies (selects) the first gate signal line 17a. When GSDAT is 1, it specifies (selects) the second gate signal line 17a. Similarly, when GSDAT is 2, it specifies (selects) the third gate signal line 17a. And when GSDAT is 239, it specifies (selects) the 240th gate signal line 17a. The voltage of the gate signal line 17a is level-shifted by the voltage level shift circuit 112a. It is described that there are 240 gate signal lines 17a. When GSDAT is 0, the nonselected state is applied (the off-voltage (VGH) is applied) to all the gate signal lines 17a. To render all the gate signal lines 17a nonselected, the OEV signals may constantly be L-level.

The configuration of FIG. 67 is a configuration in which the shift register circuit 111a, shift register circuit 111b2 and AND circuit 81 of FIG. 55 are replaced by the decoder circuit 671. As for the configuration of FIG. 55, it is necessary to determine whether or not the selected pixel lines coincide from the outputs of the shift register circuit 111a and the shift register circuit 111b2.

The source driver circuit 14 generates the start pulse signal (ST2). The source driver circuit 14 has a grasp of the position (pixel line position) of the gate signal line 17b to be selected. It also has a grasp of the data position of the shift register circuit 111b. The source driver circuit 14 also has a grasp of the pixel line position to be selected by the gate driver circuit 12a. The pixel line position to be selected is indicated by the data GSDAT to be decoded. Therefore, when the gate signal line 17a and gate signal lines 17b to be selected select the same pixel line, GSDAT is rendered as 0 and the pixel line is rendered nonselected. Or else, the OEV signal is rendered L-level so as to exert control to select no gate signal lines 17a. It is possible, by having the above configuration, to put a specific pixel line in the nonselected state and exert control not to write the video signal to the pixel line (exert control not to write the video signal to the pixel line where the on-voltage is applied to the gate signal line 17b and a current is passed to the EL element 15) even without the shift register circuit 111a, shift register circuit 111b2 and AND circuit 81. The other matters are the same as or similar to FIGS. 55, 66 and so on, and so a description thereof will be omitted.

It goes without saying that the shift register circuit 111b is also replaceable by the decoder circuit in FIG. 67.

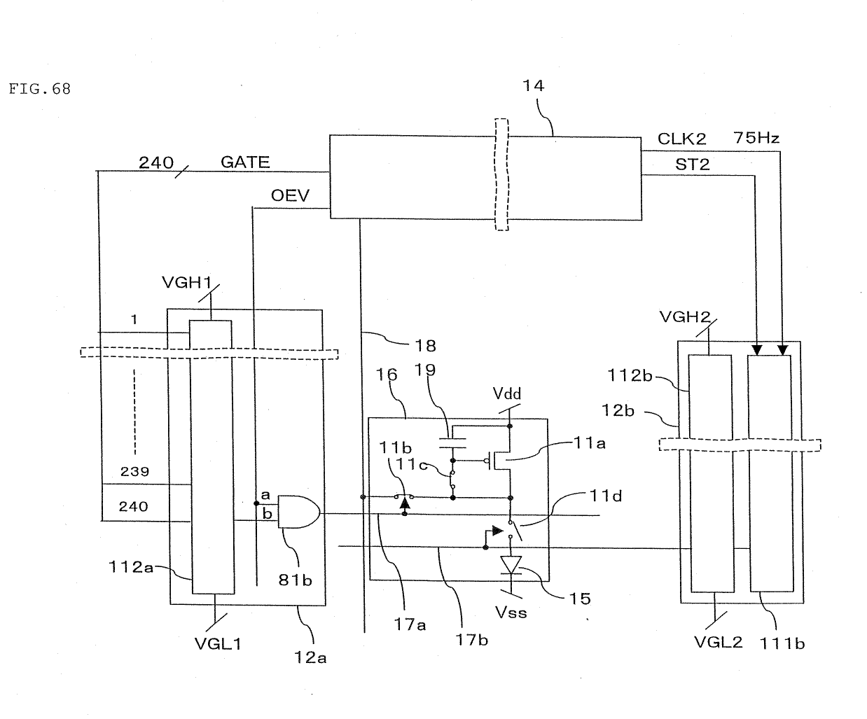

FIG. 67 is the method of selecting the gate signal line 17a or the gate signal line 17b with the decoder circuit 671. FIG. 68 has the configuration in which necessary gate signal lines 17 are wired from the source driver circuit 14.

In FIG. 68, 240 gate signal lines 17a are outputted from the source driver circuit 14. Each of the gate signal lines 17a has a potential level shift circuit 112a directly formed on the substrate by the polysilicon technology. As for 1 to 240 of the gate signal lines 17a outputted from the source driver circuit 14, the on-voltage (VGL) or a ‘selection’ logic signal is applied to one gate signal line 17a thereof. The off-voltage (VGH) or a ‘non-selection’ logic signal is applied to the other gate signal lines 17a.

When the gate signal line 17a and the gate signal line 17b select the same pixel line, the off-voltage (VGH) is applied to all the gate signal lines 17a so as to render the pixel line non-selected. Or else, the OEV signal is rendered L-level so as to exert control to select no gate signal lines 17a.

The source driver circuit 14 generates the start pulse signal (ST2). The source driver circuit 14 has a grasp of the position (pixel line position) of the gate signal line 17b to be selected. It also has a grasp of the data position of the shift register circuit 111b. The source driver circuit 14 also has a grasp of the pixel line position to be selected. The pixel line position to be selected is specified by applying the on-voltage (VGL) or the logic signal to the gate signal line 17 to be ‘selected.’

It is possible, by having the above configuration, to put a specific pixel line in the nonselected state and exert control not to write the video signal to the pixel line (exert control not to write the video signal to the pixel line where the on-voltage is applied to the gate signal line 17b and a current is supplied to the EL element) even without the shift register circuit 111a, shift register circuit 111b2 and AND circuit 81. The other matters are the same as or similar to FIGS. 55, 66, 67 and the like, and so a description thereof will be omitted.

In FIG. 68, the gate signal line 17b may be outputted from the source driver circuit 14. Both the gate signal line 17a and gate signal line 17b may be outputted from the source driver circuit 14.

According to the above embodiment, the gate driver circuit 12a selected the gate signal line 17a, and the gate driver circuit 12b selected the gate signal line 17b. However, the present invention is not limited thereto. As shown in FIG. 69, it may also be configured so that the output of the gate driver circuit 12b is applied to the gate signal line 17a and the output of the gate driver circuit 12a is simultaneously applied to the gate signal line 17a. The gate signal line 17a is selected by the two gate driver circuits 12 (12a, 12b) placed on the right and left of the display screen 22. The pixel line position selected by the two gate driver circuits 12 (12a, 12b) is the same. In the configuration of FIG. 69, potential inclination of the gate signal line 17a is not on the right and left of the display screen 22, and so good writing of the video signal is realizable. As shown in FIG. 69, the gate signal line 17b may also be connected to the outputs of the gate driver circuits 12 on the right and left of the display screen 22.

The other matters are the same as or similar to FIGS. 11, 12, 55, 66, 67 and the like, and so a description thereof will be omitted. It goes without saying that the configurations of FIG. 11, FIG. 12, FIGS. 44 to 46, FIGS. 49 to 53, FIG. 55, FIG. 66 to 69 are mutually combinable. It goes without saying that the matters relating to the OEV signals and the like described in FIG. 37 and FIGS. 40 to 62 or the matters relating to the driving method described in the above drawings and the like are applicable to the embodiments of FIGS. 8 to 19, FIG. 42, FIG. 55, FIG. 66, FIG. 67, FIG. 68 and FIG. 69. It goes without saying that they are combinable with the embodiments of FIGS. 8 to 19, FIG. 42, FIG. 55, FIG. 66, FIG. 67, FIG. 68 and FIG. 69. It goes without saying that the above embodiment or the present invention is also applicable to and combinable with the matters relating to the correction method of a correction amount of FIGS. 26 to 40. It goes without saying that it is also applicable to and combinable with the temperature correction of FIG. 41. It goes without saying that it is also applicable to and combinable with the driving method of FIGS. 44 to 47A, FIG. 47B. Furthermore, it goes without saying that the above embodiment, invention or combined inventions are also applicable to the display device of the present invention shown in FIGS. 63 to 65.

The present invention interrupts a current pathway for flowing from the driving transistor 11a to the EL element 15 in the pixel line for writing the video signal. Or an exclusion (disabling a set logic signal of one of the gate signal lines 17) process is performed so as not to write the video signal to the pixel line in which the current pathway for flowing from the driving transistor 11a to the EL element 15 is generated. It may be any configuration capable of satisfying this operation. Therefore, the present invention is not limited by existence or nonexistence of the gate driver circuit 12a and the gate driver circuit 12b. For instance, the configuration of FIG. 62 does not require the gate driver circuit 12b. However, the gate signal line 17b can have the on/off voltages applied or set thereto by the selection signal line 621.

The driving method of the present invention is not limited to the driving method and driving circuits of an organic EL display panel. It goes without saying that it is also applicable to other displays, such as a field emission display (FED) and an inorganic EL display.

The present invention is applicable to any display which can hold a set voltage on the capacitor 19 of the pixel 15 and the like. Or else, as in FIGS. 1, 20 and 23, the present invention is applicable to any display which has the pixel including the switch transistor 11c for writing the video signal to the pixel and the switch transistor 11d or 11e capable of on/off-controlling the current pathway for flowing to the EL element 15.

Next, a description will be given as to display equipment of the present invention which uses the EL display device for implementing the driving method of the present invention as a display.

FIG. 63 is a plan view of a cell-phone as an example of an information terminal device. An antenna 631 and the like are mounted on a housing 633. Reference character 632a denotes a switching key for changing the duty ratio, 632b denotes a power on/off key, and 632c denotes a key for switching the operation frame rate of the gate driver circuit 12b. The operation frame rate can be easily changed or set by the driving method described in FIGS. 8 to 19, FIG. 47A, FIG. 47B, FIG. 48A, FIG. 48B, FIG. 48C, FIG. 55, FIG. 66, FIG. 67, FIG. 68 and FIG. 69 and the like. Reference character 635 denotes a photosensor. The photosensor 635 automatically adjusts the luminance of the display screen 22 by changing the duty ratio and the like according to intensity of outside light. As the duty ratio has been described in FIG. 4A, FIG. 4B, FIG. 27, FIG. 31 and the like, a description thereof will be omitted.

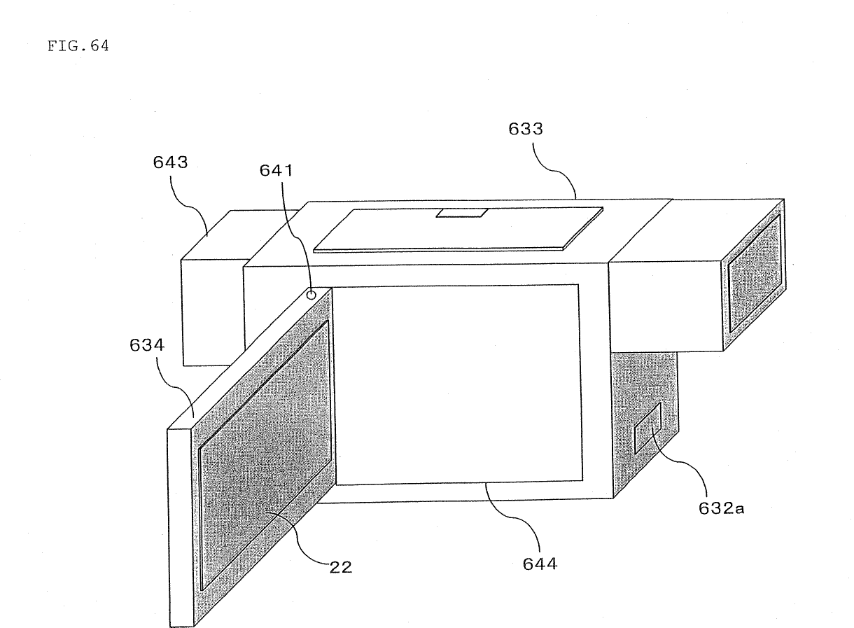

FIG. 64 is a perspective view of a video camera. The video camera is provided with a photographing (imaging) lens portion 643 and a video camera body 633. The EL display device of the present invention is also used as a display monitor 634. The display screen 22 can have its angle freely adjusted by a supporting point 641. When the display screen 22 is not in use, it is housed in a housing portion 643.

In the case of the display equipment of the present invention of FIGS. 63, 64 and the like, the duty ratio can be switched by operation of the key 632a. As for the operation of the key 632a, it should be readily switchable by a user. In a setting mode, it can be switched whether or not to allow an automatic change. It is configured so that, in the case of automatic, brightness of the outside light is detected to automatically set the display luminance at 50%, 60% and 80%.

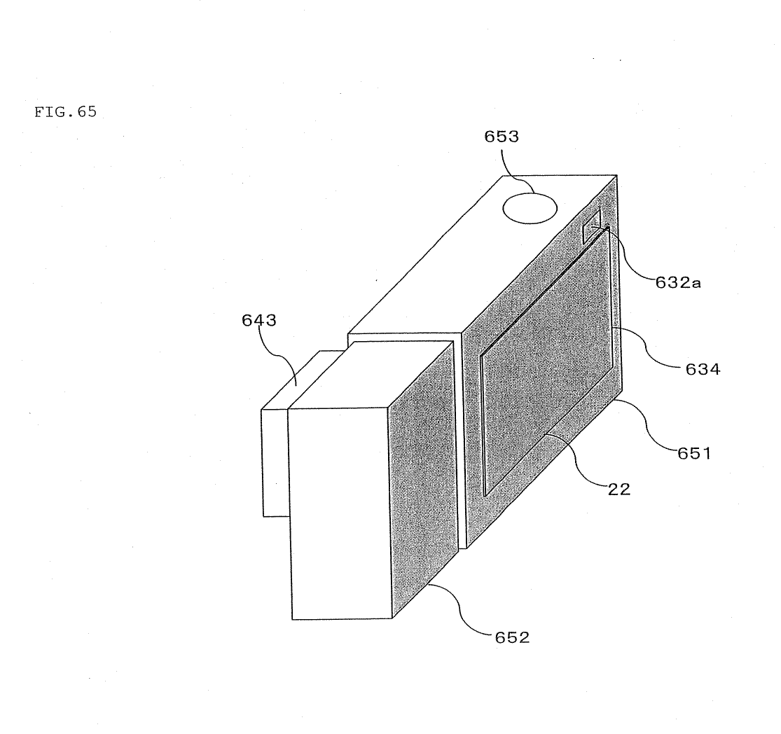

The EL display device of this embodiment is not only applicable to the video camera but is also applicable to an electronic camera as shown in FIG. 65. The EL display device of the present invention is used as a monitor 22 attached to a camera body 651. The camera body 651 has the switches 632a, 632c mounted thereon in addition to a shutter 653.

The EL display device and the driving method of the EL display device according to the present invention have the effect of being able to easily convert the operation frame rate or generating no flicker. Therefore, it is useful for a self-luminous display panel (display device) such as an EL display panel (display device) using an organic or inorganic electroluminescent (EL) element and the like, a driving method and a driving device thereof and display devices using the display panels.

1. A driving method of an electroluminescent (EL) display device for driving the EL display device having EL elements placed in a matrix state thereon, comprising:
when a pixel line selected to write a video signal matches with a pixel line selected to supply a current to said EL elements,
deselecting at least one of the pixel line selected to write said video signal and the pixel line selected to supply a current to said EL elements.

2. A driving method of an electroluminescent (EL) display device for driving the EL display device having EL elements placed in a matrix state thereon, comprising:
stopping a supply of a current to the EL elements of a pixel line selected to write a video signal in a matching period when said pixel line selected to write a video signal matches with a pixel line selected to supply a current to the EL elements; and
correcting luminance reduced by said stopping the supply of current by applying correction data to EL elements of a pixel line in a frame in which said stopping occurs or a frame before said frame in which said stopping occurs or a frame after said frame in which said stopping occurs.

3. A driving method of an electroluminescent (EL) display device for driving the EL display device having EL elements placed in a matrix state thereon, comprising:
executing a first operation frame rate for selecting a pixel line for writing a video signal;
executing a second operation frame rate for selecting a pixel line for supplying a current to said EL elements, wherein
said first operation frame rate is different from said second operation frame rate.

4. The driving method of an EL display device according to claim 1, wherein:
controlling a writing of said video signal in a first gate driver circuit;
controlling a supplying of a current to said EL elements is exerted in a second gate driver circuit; and
operating said first gate driver circuit at a first operation frame rate faster than a second operation frame rate of said second gate driver circuit.

5. The driving method of an EL display device according to claim 2, wherein:
controlling a writing of said video signal in a first gate driver circuit; and
controlling a supplying of a current to said EL elements in a second gate driver circuit, wherein
operating said first gate driver circuit at a first operation frame rate faster than a second operation frame rate of said second gate driver circuit.

6. The driving method of an EL display device according to claim 3, wherein:
controlling a writing of said video signal in a first gate driver circuit;
controlling a supplying of a current to said EL elements is exerted in a second gate driver circuit;
operating said first gate driver circuit at a first operation frame rate faster than a second operation frame rate of said second gate driver circuit.

7. An electroluminescent (EL) display device having EL elements placed in a matrix, comprising:
a first selection portion configured to select a pixel line for writing a video signal;
a second selection portion configured to select a pixel line for lighting EL elements; and
a selection control portion configured to render the pixel line selected by at least one of said first selection portion and said second selection portion deselected when the pixel line selected by said first selection portion matches with the pixel line selected by said second selection portion.

8. An electroluminescent (EL) display device having EL elements placed in a matrix state thereon, comprising:
a first gate driver circuit configured to select a pixel line for writing a video signal;
a second gate driver circuit configured to select a pixel line for lighting EL elements; and
a selection control circuit having inputs including a first gate signal line connected to said first gate driver circuits and a second gate signal line connected to said second gate driver circuit.

9. The EL display device according to claim 8, wherein:
said first gate driver circuit having an operation frame rate different from an operation frame rate of said second gate driver circuit; and
said selection control circuit is configured to render the pixel line selected by at least one of said first gate driver circuit and said second gate driver circuit deselected when the pixel line selected by said first gate driver circuit matches with the pixel line selected by said second gate driver circuit.

10. An electroluminescent (EL) display device having EL elements placed in a matrix state thereon, comprising:
a first gate driver circuit configured to select a pixel line for writing a video signal; and
a second gate driver circuit configured to select a pixel line for lighting EL elements,
said first gate driver circuit having an operation frame rate different from an operation frame rate of said second gate driver circuit.

11. The EL display device according to claim 7,
said second selection portion or said second gate driver circuit having an operation frame rate faster than an operation frame rate of said first selection portion or said first gate driver circuit.

12. The EL display device according to claim 8,
said second selection portion or said second gate driver circuit having an operation frame rate faster than an operation frame rate of said first selection portion or said first gate driver circuit.

13. The EL display device according to claim 9,
said second selection portion or said second gate driver circuit having an operation frame rate faster than an operation frame rate of said first selection portion or said first gate driver circuit.

14. The EL display device according to claim 10,
said second selection portion or said second gate driver circuit having an operation frame rate faster than an operation frame rate of said first selection portion or said first gate driver circuit.

15. The EL display device according to claim 7, wherein a duty ratio of a number of selected pixel lines to a total number of pixel lines of a display area is variable corresponding to a lighting rate.

16. The EL display device according to claim 8, wherein a duty ratio of a number of selected pixel lines to a total number of pixel lines of a display area is variable corresponding to a lighting rate.

17. The EL display device according to claim 9, wherein a duty ratio of a number of selected pixel lines to a total number of pixel lines of a display area is variable corresponding to a lighting rate.

18. The EL display device according to claim 10, wherein a duty ratio of a number of selected pixel lines to a total number of pixel lines of a display area is variable corresponding to a lighting rate.

19. The EL display device according to claim 9, wherein, of multiple input terminals of said selection control circuit, comprising:
multiple input terminals one of said multiple input terminals configured to be a gate signal line electrically connected to the first gate driver circuit or the second gate driver circuit.

20. An electroluminescent (EL) display device having EL elements placed in a matrix state thereon, comprising:
a first selection circuit configured to select a pixel line for writing a video signal; and
a second selection circuit configured to selected a pixel line for lighting EL elements.
